(19) United States
(12) Patent Application Publication
(10) Pub. No.: US 2011/0250485 A1
(43) Pub. Date: Oct. 13, 2011

(54) SECONDARY BATTERY

(76) Inventor: Yoshihiro TSUKUDA, Osaka (JP)

(21) Appl. No.: 13/085,705

(22) Filed: Apr. 13, 2011

(30) Foreign Application Priority Data
Apr. 13, 2010 (JP) 2010-092083
May 12, 2010 (JP) 2010-109853

(51) Int. Cl. H01M 4/24; H01M 10/02; H01M 2/02

(52) U.S. Cl. 429/153; 429/163

(57) ABSTRACT

Provided is a reliable secondary battery with improved life characteristics. The lithium-ion secondary battery (secondary battery) has: a positive electrode which includes a positive electrode active material layer; a negative electrode which includes a negative electrode active material layer and which is arranged to face the positive electrode; a housing container in which the positive and negative electrodes are housed; and a lid member which seals the opening of the housing container. The positive and negative electrodes have edge portions respectively, and are housed in the housing container with a pressing force applied to a region of the positive and negative electrode active material layers excluding at least part of the edge portions.

This nonprovisional application claims priority under 35 U.S.C. §119(a) on Patent Application No. 2010-092083 filed in Japan on Apr. 13, 2010 and Patent Application No. 2010-109853 filed in Japan on May 12, 2010, the entire contents of which are hereby incorporated by reference.

### BACKGROUND OF THE INVENTION

1. Field of the Invention

The present invention relates to a secondary battery.

2. Description of Related Art

In recent years, as consumer electronics, such as cellular phones, portable electronic appliances, personal digital assistants, are rapidly made compact, lightweight, and versatile, for use as their electric power sources there has been strong demand for the development of secondary batteries that are compact and lightweight, that offer high energy density, and that stand repeated charge-discharge cycles for a long period of time. As secondary batteries that meet those requirements, most promising are lithium-ion secondary batteries, which offer higher energy density than other secondary batteries, and a wide range of research is being conducted to develop lithium-ion secondary batteries with increasingly enhanced properties.

Moreover, in recent years, in view of environmental issues such as global warming, lithium-ion secondary batteries have been increasingly used for storage of electric power. Furthermore, as measures to reduce CO₂ emissions and cope with energy issues, there has been a high expectation for the spread of fuel-efficient, low-emission vehicles, such as hybrid electric vehicles (HEVs) and electric vehicles (EVs), and the development and commercialization of lithium-ion secondary batteries intended for use as vehicle-mounted batteries are underway.

Such lithium-ion secondary batteries are generally produced as follows: positive electrodes having a positive electrode active material layer formed thereon and negative electrodes having a negative electrode active material layer formed thereon are arranged so as to face each other across separators, and are housed inside a package member (housing container), into which a non-aqueous electrolyte liquid is then injected. Making lithium ions move between the positive and negative electrodes causes charging and discharging to take place. An example of such lithium-ion secondary batteries is disclosed, for example, in Japanese Registered Patent No. 3482604.

As discussed above, the application of lithium-ion secondary batteries is no longer limited to portable appliances such as cellular phones but is now widening into the driving of large motors as in electric vehicles. As the demand for lithium-ion secondary batteries increases, they have come to be expected to offer high capacities and long lives of 500 cycles or more.

Inconveniently, however, in such lithium-ion secondary batteries, expansion, contraction, or the like of an active material layer during charging and discharging may cause peeling or dropping of the active material off the active material layer, possibly resulting in internal short-circuiting. Disadvantageously, if internal short-circuiting occurs, it diminishes the battery life, leading to degraded life characteristics and lower reliability.

### SUMMARY OF THE INVENTION

The present invention has been devised to solve the problems mentioned above, and it is an object of the invention to provide a reliable secondary battery with improved life characteristics.

To achieve the above object, according to a first aspect of the invention, a secondary battery includes: a positive electrode which includes a positive electrode active material layer; a negative electrode which includes a negative electrode active material layer and which is arranged to face the positive electrode; a housing container in which the positive and negative electrodes are housed; and a lid member which seals the opening of the housing container. Here, the positive and negative electrodes have edge portions respectively, and are housed in the housing container with a pressing force applied to a region of the positive and negative electrode active material layers excluding at least part of the edge portions.

In this secondary battery according to the first aspect, by applying a pressing force to a region of the positive and negative electrode active material layers as described above, it is possible to hold the positive and negative electrodes closely together. This makes it possible to improve cycle characteristics, and thus to improve life characteristics. Moreover, by applying a pressing force to the positive and negative electrodes, it is possible to prevent displacement of the electrodes. This too helps improve cycle characteristics. Thus, with the structure described above, it is possible to improve life characteristics and reliability.

Moreover, according to the first aspect, by applying the pressing force to the positive and negative electrodes such that the pressing force is applied to a region of the positive and negative electrode active material layers excluding at least part of the edge portions of the positive and negative electrodes, it is possible to prevent the inconvenience of burrs and the like developing in the edge portions of the electrodes and causing electrical short-circuiting between the positive and negative electrodes. This makes it possible to prevent internal short-circuiting during assembly of the battery, and thus to improve yields. Moreover, by improving yields, it is possible to easily reduce product prices when producing large-capacity secondary batteries.

Furthermore, according to the first aspect, with the structure described above, it is possible to prevent the pressing force from being applied to at least part of the edge portions of the positive and negative electrodes. Thus, it is possible to prevent internal short-circuiting from occurring in the edge portions (end portions) of the electrodes as the active material layers expand and contract during charging and discharging of the battery. This too helps improve cycle characteristics. In addition, it is possible to improve reliability.

Preferably, the secondary battery according to the first aspect further includes a swelling resin that swells when soaked with an electrolyte liquid. In the secondary battery according to the first aspect, a swelling resin that swells when soaked with an electrolyte liquid may be dispersed. In a case where the secondary battery according to the first aspect includes a swelling resin that swells when soaked with an electrolyte liquid, preferably, the swelling resin is formed in the shape of a plate.

In the secondary battery according to the first aspect described above, preferably, the positive and negative electrodes have the pressing force applied to a region thereof excluding edge portions of the positive and negative electrode active material layers respectively. Here, in a case where the positive and negative electrode active material layers are formed by application, bulges (projections) may form at the application-starting and -ending ends. In that case, if the pressing force is applied to the bulges (projections), internal short-circuiting may occur. With the structure described above, however, it is possible to prevent the pressing force from being applied to the bulges (projections), and thus to prevent internal short-circuiting from occurring at the bulges (projections). This makes it possible to effectively prevent short-circuiting, and thus it is possible to easily improve yields.

In the secondary battery according to the first aspect described above, preferably, the positive and negative electrodes have the pressing force applied to a region of the positive and negative electrode active material layers by the housing container and the lid member. With this structure, it is possible to easily apply a pressing force to the positive and negative electrodes.

In the secondary battery according to the first aspect described above, preferably, there is further included a separator which is arranged between the positive and negative electrodes, and a stacked member is formed by sequentially stacking the positive electrode, the separator, and the negative electrode. Moreover, the stacked member has the pressing force applied thereto in a stack direction by the housing container and the lid member. With this structure, it is possible to obtain reliable stacked-type secondary batteries with excellent life characteristics at high yields.

In that case, it is preferable that the stacked member have a plurality of positive electrodes as the positive electrode and a plurality of negative electrodes as the negative electrode, and that the positive and negative electrodes be stacked alternately. With this structure, it is possible to easily increase the capacity of stacked-type secondary batteries.

In the secondary battery according to the first aspect described above, preferably, the region of the positive and negative electrodes to which the pressing force is applied is a region 1 mm or more inward of the edges of the positive electrode active material layer or 1 mm or more inward of the edges of the negative electrode active material layer. With this structure, it is possible to easily prevent internal short-circuiting.

In the secondary battery according to the first aspect described above, preferably, the positive electrode active material layer has a smaller planar area than the negative electrode active material layer, and the region of the positive and negative electrodes to which the pressing force is applied is a region 1 mm or more inward of edges of the positive electrode active material layer. With this structure, it is possible to more easily prevent internal short-circuiting.

In the secondary battery according to the first aspect described above, preferably, the pressing force is applied to a region of the positive and negative electrode active material layers 5 mm or more inward of the edges thereof. With this structure, it is possible to still more easily prevent internal short-circuiting.

In the secondary battery according to the first aspect described above, it is preferable that the area of the region of the positive and negative electrodes to which the pressing force is applied be 10% or more but 99% or less of the planar area of the positive electrode active material layer.

In the secondary battery according to the first aspect described above, it is further preferable that the area of the region of the positive and negative electrodes to which the pressing force is applied be 20% or more but 98% or less of a planar area of the positive electrode active material layer.

In the secondary battery according to the first aspect described above, the housing container and the lid member may each be formed of a metal material.

In the secondary battery according to the first aspect described above, preferably, the positive and negative electrodes are arranged to face the lid member, the lid member has a first protruding portion which protrudes toward the positive and negative electrodes, and the first protruding portion applies the pressing force to the positive and negative electrodes. With this structure, it is possible to easily apply a pressing force to a region of the positive and negative electrode active material layers excluding at least part of the edge portions of the positive and negative electrodes.

In that case, as the first protruding portion, a plurality of first protruding portions may be formed on the lid member.

In the above-described structure where the lid member has a first protruding portion, preferably, the first protruding portion is formed integrally with the lid member. With this structure, it is possible to easily form the first protruding portion on the lid member. In addition, even when the first protruding portion is formed on the lid plate 80, this can be done without increasing the number of components.

In the above-described structure where the lid member has a first protruding portion, preferably, the first protruding portion has a substantially flat pressing surface which applies the pressing force to the positive and negative electrodes. With this structure, it is possible to prevent the pressing force from concentrating at one point. It is thus possible to prevent the inconvenience of a crack developing in the active material layer as a result of the pressing force concentrating at one point. This makes it possible to prevent degradation of cycle characteristics resulting from development of a crack. Moreover, if, for example, the protruding portion has a sharp tip, inconveniently, internal short-circuiting is likely to occur; by contrast, by making the pressing surface substantially flat as described above, it is possible to avoid that inconvenience.

In the secondary battery according to the first aspect described above, preferably, the housing container has a bottom face portion which faces the positive and negative electrodes, the bottom face portion of the housing container has a second protruding portion which protrudes toward the positive and negative electrodes, and the second protruding portion applies the pressing force to the positive and negative electrodes. With this structure, it is possible to easily apply a pressing force to a region of the positive and negative electrode active material layers excluding at least part of the edge portions of the positive and negative electrodes.

In that case, as the second protruding portion, a plurality of second protruding portions may be formed on the bottom face portion of the housing container.

In the above-described structure where the bottom face portion of the housing container has a second protruding portion, preferably, the second protruding portion is formed integrally with the bottom face portion of the housing container. With this structure, it is possible to easily form the second protruding portion on the bottom face portion of the housing container. In addition, even when the second protruding portion is formed on the bottom face portion of the housing container, this can be done without increasing the number of components.

In the above-described structure where the bottom face portion of the housing container has a second protruding portion, preferably, the second protruding portion has a substantially flat pressing surface which applies the pressing force to the positive and negative electrodes. With this structure, it is possible to prevent the pressing force from concentrating at one point. In addition, it is possible to prevent internal short-circuiting.

In the above-described structure where the bottom face portion of the housing container has a second protruding portion, the positive and negative electrodes may be arranged to face the lid member, and the lid member may have a first protruding portion which protrudes toward the positive and negative electrodes. In that case, preferably, the second protruding portion is formed in a position corresponding to the first protruding portion.

In the secondary battery according to the first aspect described above, preferably, the positive and negative electrodes are arranged to face the lid member, the housing container has a bottom face portion which faces the positive and negative electrodes, and a pressing member which applies the pressing force to the positive and negative electrodes is arranged either or both between the positive and negative electrodes and the lid member or/and between the positive and negative electrodes and the bottom face portion of the housing container. With this structure, it is possible to easily apply a pressing force, via the pressing member, to a region of the positive and negative electrode active material layers excluding at least part of the edge portions of the positive and negative electrodes.

In that case, preferably, the pressing member is formed of an insulating material.

In the above-described structure where a pressing member is provided, the pressing member may be formed of a high-polymer material.

In the above-described structure where a pressing member is provided, as the pressing member, pressing members may be arranged respectively between the positive and negative electrodes and the lid member and between the positive and negative electrodes and the bottom face portion of the housing container.

In the secondary battery according to the first aspect described above, preferably, the positive and negative electrodes are arranged to face the lid member, and on the side of the lid member facing the inside of the battery, a first receding portion is formed to cover edge portions of the positive and negative electrode active material layers respectively as seen in a plan view. With this structure, the first receding portion prevents the pressing force from being applied to the edge portions of the positive and negative electrode active material layers.

In the secondary battery according to the first aspect described above, preferably, the housing container has a bottom face portion which faces the positive and negative electrodes, and on the side of the bottom face portion of the housing container facing the inside of the battery, a second receding portion is formed to cover edge portions of the positive and negative electrode active material layers respectively as seen in a plan view. With this structure, the second receding portion prevents the pressing force from being applied to the edge portions of the positive and negative electrode active material layers.

In the secondary battery according to the first aspect described above, at least one of the housing container and the lid member may have the surface thereof facing the inside of the battery coated with a high-polymer-laminated material. The coating with the high-polymer-laminated material may be applied to both of the sides facing the inside and outside of the battery.

In the secondary battery according to the first aspect described above, preferably, the housing container is formed in the shape of a box, the face thereof with the greatest area being the bottom face portion, and the positive and negative electrodes are housed in the housing container so as to face the bottom face portion. With this structure, it is possible to easily obtain large-capacity box-shaped secondary batteries. Moreover, with this structure, it is possible to house the positive and negative electrodes in the housing container with improved ease.

According to a second aspect of the invention, a secondary battery includes: a positive electrode which includes a positive electrode active material layer; a negative electrode which includes a negative electrode active material layer and which is arranged to face the positive electrode; a stacked member which has the positive and negative electrodes stacked alternately; a package container including a housing container in which the stacked member is housed and a lid member which seals the opening of the housing container; and a swelling resin that swells when soaked with an electrolyte liquid, the swelling resin being arranged in the package container. Here, the stacked member has a pressing force applied thereto in a stack direction by the swelling resin swelling when an electrolyte liquid is injected into the package container

In this secondary battery according to the second aspect, as described above, a swelling resin that swells when soaked with an electrolyte liquid is arranged in the package container so that, by injecting an electrolyte liquid into the package container, it is possible to make the swelling resin swell. It is thus possible, with the swelling resin that has swollen by injection of the electrolyte liquid, to apply a pressing force to the stacked member housed in the package container. This makes it possible to fix the stacked member inside the package container, and thereby to prevent displacement of the stacked member. Consequently, it is possible to prevent internal short-circuiting resulting from displacement of the stacked member that may occur, for example, as the active material layers expand and contract during charging and discharging of the battery. It is thus possible to improve cycle characteristics.

Moreover, according to the second aspect, since it is possible to apply a pressing force to the stacked member with the swelling resin that has swollen by injection of the electrolyte liquid into the package container, it is possible, with that pressing force, to hold the positive and negative electrodes closely together. This too helps improve cycle characteristics.

Thus, with the secondary battery according to the second aspect, owing to the structure described above, it is possible to improve life characteristics and reliability.

In the secondary battery according to the second aspect described above, preferably, the positive and negative electrodes have edge portions respectively, and have the pressing force applied to a region of the positive and negative electrode active material layers excluding at least part of the edge portions. With this structure, it is possible to prevent the inconvenience of burrs and the like developing in the edge portions of the electrodes and causing electrical short-circuiting between the positive and negative electrodes. This makes it possible to prevent internal short-circuiting during assembly of the battery, and thus to improve yields. Moreover, by improving yields, it is possible to easily reduce product prices when producing large-capacity secondary batteries. Moreover, with this structure, it is possible to effectively prevent internal short-circuiting from occurring in the edge portions (end portions) of the electrodes as the active material layers expand and contract during charging and discharging of the battery. This makes it possible to effectively improve cycle characteristics. In addition, it is possible to improve reliability.

In the secondary battery according to the second aspect described above, preferably, the positive and negative electrodes have the pressing force applied to a region thereof excluding edge portions of the positive and negative electrode active material layers respectively. Here, in a case where the positive and negative electrode active material layers are formed by application, bulges (projections) may form at the application-starting and -ending ends. In that case, if the pressing force is applied to the bulges (projections), internal short-circuiting may occur. With the structure described above, however, it is possible to prevent the pressing force from being applied to such bulges (projections), and thus to prevent internal short-circuiting from occurring at the bulges (projections). This makes it possible to effectively prevent short-circuiting, and thus it is possible to easily improve yields.

In the secondary battery according to the second aspect described above, preferably, at least one of the positive and negative electrode active material layers has the swelling resin dispersed therein. With this structure, it is possible, by injecting an electrolyte liquid into the package container, to make the active material layer having the swelling resin dispersed therein swell. It is thus possible, with the swelling resin that has swollen by injection of the electrolyte liquid, to apply a pressing force to the stacked member housed in the package container. This makes it possible to easily improve cycle characteristics.

In the secondary battery according to the second aspect described above, preferably, a plate-shaped member formed of the swelling resin is arranged either or both between the lid member and the stacked member or/and between the housing container and the stacked member. With this structure, it is possible, by injecting an electrolyte liquid into the package container, to make the plate-shaped member formed of the swelling resin swell, and thereby to easily apply a pressing force to the stacked member housed in the package container.

In that case, preferably, the plate-shaped member is formed in a size corresponding to the region of the positive and negative electrode active material layers excluding the edge portions thereof. With this structure, it is possible to easily apply a pressing force to a region of the positive and negative electrode active material layers excluding the edge portions thereof, and thus to effectively prevent internal short-circuiting. This makes it possible to improve cycle characteristics and in addition improve reliability and yields.

In the secondary battery according to the second aspect described above, there may be further included a separator which is arranged between the positive and negative electrodes, and the separator may be formed of the swelling resin. With this structure, by injecting an electrolyte liquid into the package container and thereby making the separator swell, it is possible to easily apply a pressing force to the stacked member housed in the package container. Such a separator may also be arranged other than between the positive and negative electrodes so that making this separator arranged other than between the positive and negative electrodes swell causes a pressing force to be applied to the stacked member housed in the package container.

In that case, preferably, the stacked member has a plurality of positive electrodes as the positive electrode, a plurality of separators as the separator, and a plurality of negative electrodes as the negative electrode, the stacked member is formed by sequentially stacking the positive electrodes, the separators, and the negative electrodes, and at least part of the separators have a different thickness than other separators. With this structure, it is easy to adjust the pressing force applied to the stacked member, and thus it is possible to apply the desired pressing force to the stacked member.

In the secondary battery according to the second aspect described above, preferably, the positive and negative electrodes in the stacked member have the pressing force applied thereto in the stack direction by the lid member and the housing container. With this structure, it is possible to more easily apply a pressing force to the stacked member (positive and negative electrodes).

In the secondary battery according to the second aspect described above, it is preferable that the swelling resin contain at least one substance selected from the group consisting of nitrile butadiene rubber, styrene butadiene rubber, carboxymethyl cellulose, polyvinylidene fluoride, polyvinyl alcohol, polyethylene oxide, propylene oxide, polystyrene, and polymethyl methacrylate.

In the secondary battery according to the second aspect described above, before injection of the electrolyte liquid, a gap may be left between the lid member and the stacked member or between the housing container and the stacked member. In that case, it is preferable that the gap be given an interval C in the range of 0 mm<C<5 mm.

In the secondary battery according to the second aspect described above, preferably, the region of the positive and negative electrodes to which the pressing force is applied is a region 1 mm or more inward of edges of the positive electrode active material layer or 1 mm or more inward of edges of the negative electrode active material layer. With this structure, it is possible to easily prevent internal short-circuiting.

In the secondary battery according to the second aspect described above, preferably, the positive electrode active material layer has a smaller planar area than the negative electrode active material layer, and the region of the positive and negative electrodes to which the pressing force is applied is a region 1 mm or more inward of edges of the positive electrode active material layer. With this structure, it is possible to more easily prevent internal short-circuiting.

In the secondary battery according to the second aspect described above, the pressing force is applied to a region of the positive and negative electrode active material layers 5 mm or more inward of edges thereof. With this structure, it is possible to still more easily prevent internal short-circuiting.

In the secondary battery according to the second aspect described above, the housing container and the lid member may each be formed of a metal material.

In the secondary battery according to the second aspect described above, the positive and negative electrodes are arranged to face the lid member, the housing container has a bottom face portion which faces the positive and negative electrodes, and a protruding portion which protrudes toward the positive and negative electrodes is formed on at least one of the lid member and the bottom face portion of the housing container. With this structure, it is possible to easily apply a pressing force to a region of the positive and negative electrode active material layers excluding at least part of the edge portions of the positive and negative electrodes.

In that case, preferably, the protruding portion has a substantially flat pressing surface corresponding to the region of the positive and negative electrode active material layers excluding the edge portions thereof. With this structure, it is possible to more easily apply a pressing force to a region of the positive and negative electrode active material layers excluding at least part of the edge portions of the positive and negative electrodes. By applying a pressing force to the stacked member with a substantially flat pressing surface, it is possible to prevent the pressing force from concentrating at one point, and it is thus possible to prevent the inconvenience of a crack developing in the active material layer as a result of the pressing force concentrating at one point. This makes it possible to prevent degradation of cycle characteristics resulting from development of a crack. Moreover, if, for example, the protruding portion has a sharp tip, inconveniently, internal short-circuiting is likely to occur; by contrast, by making the pressing surface substantially flat as described above, it is possible to avoid that inconvenience.

In the secondary battery according to the second aspect described above, preferably, the protruding portion is formed on the at least one of the lid member and the bottom face portion of the housing container integrally therewith. With this structure, it is possible to easily form the protruding portion on at least one of the lid member and the bottom face portion of the housing container. In addition, even when the protruding portion is formed, this can be done without increasing the number of components.

In the secondary battery according to the second aspect described above, at least one of the housing container and the lid member has the surface thereof facing the inside of the battery coated with a high-polymer-laminated material. The coating with the high-polymer-laminated material may be applied to both of the sides facing the inside and outside of the battery.

In the secondary battery according to the second aspect described above, preferably, the housing container is formed in the shape of a box, the face thereof with the greatest area being the bottom face portion, and the positive and negative electrodes are housed in the package container so as to face the bottom face portion. With this structure, it is possible to easily obtain large-capacity box-shaped secondary batteries. Moreover, with this structure, it is possible to house the positive and negative electrodes in the housing container with improved ease.

As described above, according to the invention, it is possible to easily obtain highly reliable secondary batteries with excellent life characteristics.

### BRIEF DESCRIPTION OF THE DRAWINGS

FIG. 1 is an exploded perspective view of a lithium-ion secondary battery according to Embodiment 1 of the invention;

FIG. 2 is an exploded perspective view of the lithium-ion secondary battery according to Embodiment 1 of the invention;

FIG. 3 is an overall perspective view of the lithium-ion secondary battery according to Embodiment 1 of the invention.

FIG. 4 is a plan view of the lithium-ion secondary battery according to Embodiment 1 of the invention;

FIG. 5 is a perspective view showing the structure of an electrode assembly in the lithium-ion secondary battery according to Embodiment 1 of the invention;

FIG. 6 is a perspective view showing the structure of a positive electrode in the lithium-ion secondary battery according to Embodiment 1 of the invention;

FIG. 7 is a plan view showing the structure of a positive electrode in the lithium-ion secondary battery according to Embodiment 1 of the invention;

FIG. 8 s a perspective view showing the structure of a negative electrode in the lithium-ion secondary battery according to Embodiment 1 of the invention;

FIG. 9 is a plan view showing the structure of a negative electrode in the lithium-ion secondary battery according to Embodiment 1 of the invention;

FIG. 10 is a perspective view showing the structure of a package can in the lithium-ion secondary battery according to Embodiment 1 of the invention;

FIG. 11 is a plan view showing the structure of the package can in lithium-ion secondary battery according to Embodiment 1 of the invention;

FIG. 12 is a sectional view schematically showing the lithium-ion secondary battery according to Embodiment 1 of the invention;

FIG. 13 is a plan view of a lid plate, as seen from the bottom-face side, in the lithium-ion secondary battery according to Embodiment 1 of the invention;

FIG. 14 is a sectional view schematically showing the lithium-ion secondary battery according to Embodiment 1 of the invention (a sectional view along line B1-B1 in FIG. 3);

FIG. 15 is a sectional view schematically showing the lithium-ion secondary battery according to Embodiment 1 of the invention;

FIG. 16 is a sectional view schematically showing the lithium-ion secondary battery according to Embodiment 1 of the invention (a sectional view along line A1-A1 in FIG. 3);

FIG. 17 is an exploded perspective view of a lithium-ion secondary battery according to Embodiment 2 of the invention;

FIG. 18 is a plan view of the lithium-ion secondary battery according to Embodiment 2 of the invention;

FIG. 19 is a sectional view schematically showing the lithium-ion secondary battery according to Embodiment 2 of the invention

FIG. 20 is a sectional view schematically showing the lithium-ion secondary battery according to Embodiment 2 of the invention (a sectional view along line B2-B2 in FIG. 18);

FIG. 21 is a sectional view schematically showing the lithium-ion secondary battery according to Embodiment 2 of the invention (a sectional view along line A2-A2 in FIG. 18);

FIG. 22 is a plan view of a package can in the lithium-ion secondary battery according to Embodiment 2 of the invention;

FIG. 23 is an exploded perspective view of a lithium-ion secondary battery according to Embodiment 3 of the invention;

FIG. 24 is an overall perspective view of the lithium-ion secondary battery according to Embodiment 3 of the invention;

FIG. 25 is a sectional view schematically showing the lithium-ion secondary battery according to Embodiment 3 of the invention (a sectional view along line A3-A3 in FIG. 24);

FIG. 26 is a sectional view schematically showing the lithium-ion secondary battery according to Embodiment 3 of the invention (a sectional view along line B3-B3 in FIG. 24);

FIG. 27 is a plan view of a lid plate, as seen from the bottom-face side, in the lithium-ion secondary battery according to Embodiment 3 of the invention;

FIG. 28 is a schematic diagram illustrating electrolyte liquid injection operation with the lithium-ion secondary battery according to Embodiment 3 of the invention;

FIG. 29 is an exploded perspective view of a lithium-ion secondary battery according to Embodiment 4 of the invention;

FIG. 30 is a plan view of the lithium-ion secondary battery according to Embodiment 4 of the invention;

FIG. 31 is a sectional view schematically showing the lithium-ion secondary battery according to Embodiment 4 of the invention (a sectional view along line A4-A4 in FIG. 30);

FIG. 32 is a sectional view schematically showing the lithium-ion secondary battery according to Embodiment 4 of the invention (a sectional view along line B4-B4 in FIG. 30);

FIG. 33 is an exploded perspective view of a lithium-ion secondary battery according to Embodiment 5 of the invention;

FIG. 34 is a plan view of the lithium-ion secondary battery according to Embodiment 5 of the invention;

FIG. 35 is a sectional view schematically showing the lithium-ion secondary battery according to Embodiment 5 of the invention (a sectional view along line A5-A5 in FIG. 34);

FIG. 36 is a sectional view schematically showing the lithium-ion secondary battery according to Embodiment 5 of the invention (a sectional view along line B5-B5 in FIG. 34);

FIG. 37 is an exploded perspective view of a lithium-ion secondary battery according to Embodiment 6 of the invention;

FIG. 38 is a plan view of the lithium-ion secondary battery according to Embodiment 6 of the invention;

FIG. 39 is a sectional view schematically showing the lithium-ion secondary battery according to Embodiment 6 of the invention (a sectional view along line A6-A6 in FIG. 38);

FIG. 40 is a sectional view schematically showing the lithium-ion secondary battery according to Embodiment 6 of the invention (a sectional view along line B6-B6 in FIG. 38);

FIG. 41 is a plan view of a package can in the lithium-ion secondary battery according to Embodiment 6 of the invention;

FIG. 42 is an exploded perspective view of a lithium-ion secondary battery according to Embodiment 7 of the invention;

FIG. 43 is an overall perspective view of the lithium-ion secondary battery according to Embodiment 7 of the invention;

FIG. 44 is a sectional view schematically showing the lithium-ion secondary battery according to Embodiment 7 of the invention (a sectional view along line A7-A7 in FIG. 43);

FIG. 45 is a sectional view schematically showing the lithium-ion secondary battery according to Embodiment 7 of the invention (a sectional view along line B7-B7 in FIG. 43);

FIG. 46 is an exploded perspective view of a lithium-ion secondary battery according to Embodiment 8 of the invention;

FIG. 47 is a sectional view of the lithium-ion secondary battery according to Embodiment 8 of the invention;

FIG. 48 is a sectional view of the lithium-ion secondary battery according to Embodiment 8 of the invention;

FIG. 49 is an exploded perspective view of a lithium-ion secondary battery according to Embodiment 9 of the invention;

FIG. 50 is an overall perspective view of the lithium-ion secondary battery according to Embodiment 9 of the invention;

FIG. 51 is a sectional view schematically showing the lithium-ion secondary battery according to Embodiment 9 of the invention (a sectional view along line A9-A9 in FIG. 50);

FIG. 52 is a sectional view schematically showing the lithium-ion secondary battery according to Embodiment 9 of the invention (a sectional view along line B9-B9 in FIG. 50);

FIG. 53 is an exploded perspective view of a lithium-ion secondary battery according to Embodiment 10 of the invention;

FIG. 54 is overall perspective view of the lithium-ion secondary battery according to Embodiment 10 of the invention;

FIG. 55 is a sectional view schematically showing the lithium-ion secondary battery according to Embodiment 10 of the invention (a sectional view along line A10-A10 in FIG. 54);

FIG. 56 is a sectional view schematically showing the lithium-ion secondary battery according to Embodiment 10 of the invention (a sectional view along line B10-B10 in FIG. 54);

FIG. 57 is a plan view schematically showing the lithium-ion secondary battery according to Embodiment 10 of the invention;

FIG. 58 is a sectional view schematically showing a lithium-ion secondary battery according to Embodiment 11 of the invention;

FIG. 59 is a sectional view schematically showing a lithium-ion secondary battery according to Embodiment 12 of the invention;

FIG. 60 is a sectional view schematically showing a lithium-ion secondary battery according to Embodiment 13 of the invention;

FIG. 61 is a partial sectional view showing a lithium-ion secondary battery according to Practical Example 1 in simplified form;

FIG. 62 is a partial sectional view showing a lithium-ion secondary battery according to Practical Example 2 in simplified form;

FIG. 63 is a partial sectional view showing a lithium-ion secondary battery according to Practical Example 3 in simplified form;

FIG. 64 is a partial sectional view showing a lithium-ion secondary battery according to Practical Example 4 in simplified form;

FIG. 65 is a partial sectional view showing a lithium-ion secondary battery according to Practical Example 5 in simplified form;

FIG. 66 is a partial sectional view showing a lithium-ion secondary battery according to Practical. Example 6 in simplified form;

FIG. 67 is a partial sectional view showing a lithium-ion secondary battery according to Practical Example 7 in simplified form;

FIG. 68 is a partial sectional view showing a lithium-ion secondary battery according to Practical Example 8 in simplified form;

FIG. 69 is a partial sectional view showing a lithium-ion secondary battery according to Practical Example 9 in simplified form;

FIG. 70 is a partial sectional view showing a lithium-ion secondary battery according to Practical Example 10 in simplified form;

FIG. 71 is a partial sectional view showing a lithium-ion secondary battery according to Practical Example 11 in simplified form;

FIG. 72 is a partial sectional view showing a lithium-ion secondary battery according to Practical Example 12 in simplified form;

FIG. 73 is a partial sectional view showing a lithium-ion secondary battery according to Practical Example 13 in simplified form;

FIG. 74 is a partial sectional view showing a lithium-ion secondary battery according to Comparative Example 1 in simplified form;

FIG. 75 is a partial sectional view showing a lithium-ion secondary battery according to Comparative Example 2 in simplified form;

FIG. 76 is a partial sectional view showing a lithium-ion secondary battery according to Comparative Example 3 in simplified form;

FIG. 77 is an exploded perspective view of a lithium-ion secondary battery according to Embodiment 14 of the invention;

FIG. 78 is an exploded perspective view of the lithium-ion secondary battery according to Embodiment 14 of the invention;

FIG. 79 is an overall perspective view of the lithium-ion secondary battery according to Embodiment 14 of the invention.

FIG. 80 is a plan view of the lithium-ion secondary battery according to Embodiment 14 of the invention;

FIG. 81 is a perspective view showing the structure of an electrode assembly in the lithium-ion secondary battery according to Embodiment 14 of the invention;

FIG. 82 is a perspective view showing the structure of a positive electrode in the lithium-ion secondary battery according to Embodiment 14 of the invention;

FIG. 83 is a plan view showing the structure of a positive electrode in the lithium-ion secondary battery according to Embodiment 14 of the invention;

FIG. 84 is a perspective view showing the structure of a negative electrode in the lithium-ion secondary battery according to Embodiment 14 of the invention;

FIG. 85 is a plan view showing the structure of a negative electrode in the lithium-ion secondary battery according to Embodiment 14 of the invention;

FIG. 86 is a perspective view showing the structure of a package can in the lithium-ion secondary battery according to Embodiment 14 of the invention;

FIG. 87 is a plan view showing the structure of the package can in lithium-ion secondary battery according to Embodiment 14 of the invention;

FIG. 88 is a plan view of a lid plate, as seen from the bottom-face side, in the lithium-ion secondary battery according to Embodiment 14 of the invention;

FIG. 89 is a sectional view schematically showing the lithium-ion secondary battery according to Embodiment 14 of the invention (a diagram showing it in a state before injection of non-aqueous electrolyte liquid);

FIG. 90 is a sectional view schematically showing the lithium-ion secondary battery according to Embodiment 14 of the invention (a sectional view along line B-B in FIG. 79);

FIG. 91 is a sectional view schematically showing the lithium-ion secondary battery according to Embodiment 14 of the invention (a sectional view along line A-A in FIG. 79);

FIG. 92 is an exploded perspective view of a lithium-ion secondary battery according to Embodiment 15 of the invention;

FIG. 93 is a sectional view schematically showing the lithium-ion secondary battery according to Embodiment 15 of the invention (a sectional view along line B-B in FIG. 79);

FIG. 94 is a sectional view schematically showing the lithium-ion secondary battery according to Embodiment 15 of the invention (a sectional view along line A-A in FIG. 79);

FIG. 95 is an exploded perspective view of a lithium-ion secondary battery according to Embodiment 16 of the invention;

FIG. 96 is a partial sectional view showing a lithium-ion secondary battery according to Practical Example 14 in simplified form (a diagram showing it in a state before injection of non-aqueous electrolyte liquid);

FIG. 97 is a partial sectional view showing a lithium-ion secondary battery according to Practical Example 14 in simplified form (a diagram showing it in a state after injection of non-aqueous electrolyte liquid);

FIG. 98 is a partial sectional view showing a lithium-ion secondary battery according to Practical Example 15 in simplified form (a diagram showing it in a state before injection of non-aqueous electrolyte liquid);

FIG. 99 is a partial sectional view showing a lithium-ion secondary battery according to Practical Example 15 in simplified form (a diagram showing it in a state after injection of non-aqueous electrolyte liquid);

FIG. 100 is a partial sectional view showing a lithium-ion secondary battery according to Practical Example 16 in simplified form (a diagram showing it in a state before injection of non-aqueous electrolyte liquid); and

FIG. 101 is a partial sectional view showing a lithium-ion secondary battery according to Practical Example 17 in simplified form (a diagram showing it in a state after injection of non-aqueous electrolyte liquid).

### DETAILED DESCRIPTION OF PREFERRED EMBODIMENTS

Hereinafter, embodiments of the present invention will be described in detail with reference to the accompanying drawings. The embodiments presented below deal with cases in which the invention is applied to a lithium-ion secondary battery of a stacked type as an example of a secondary battery.

### Embodiment 1

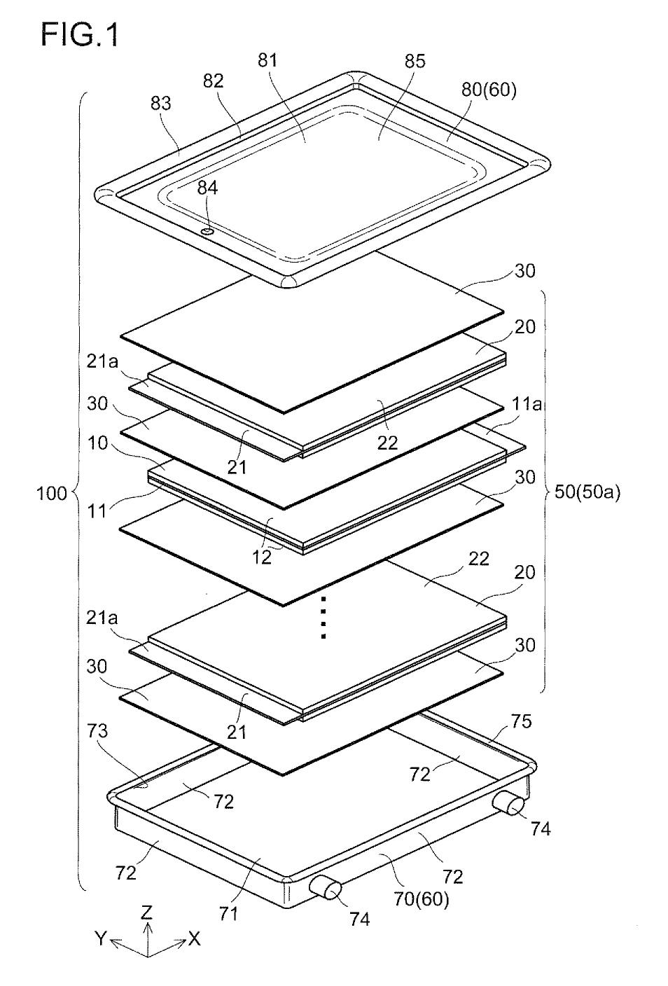

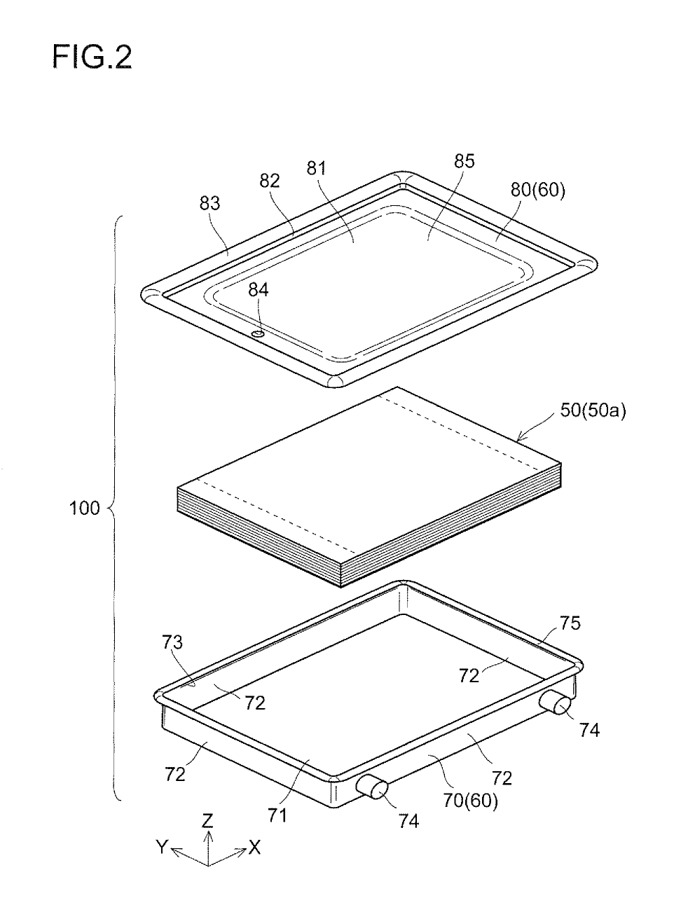

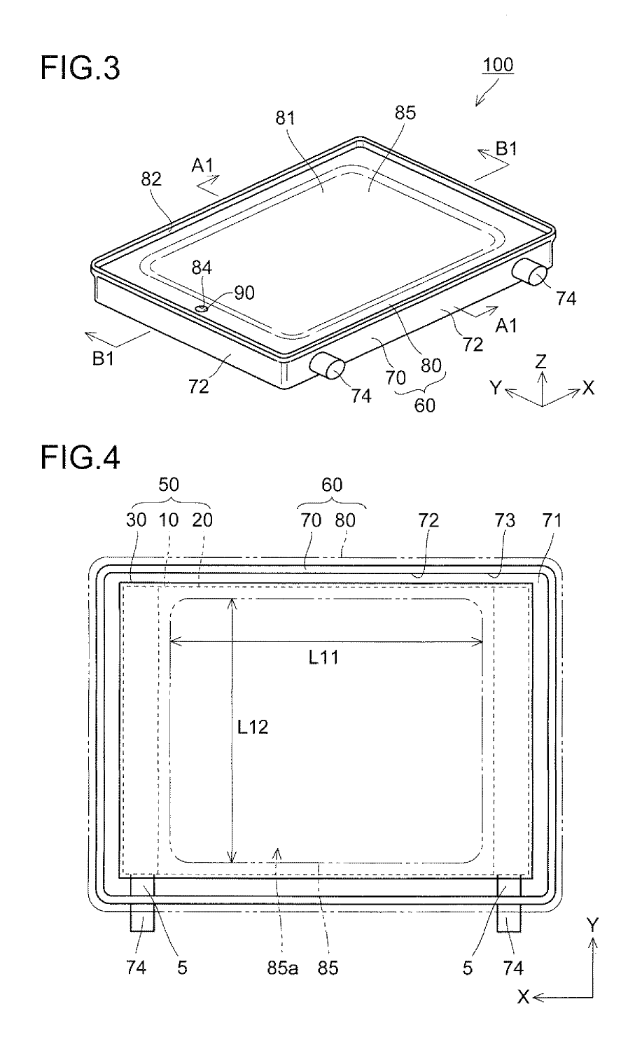

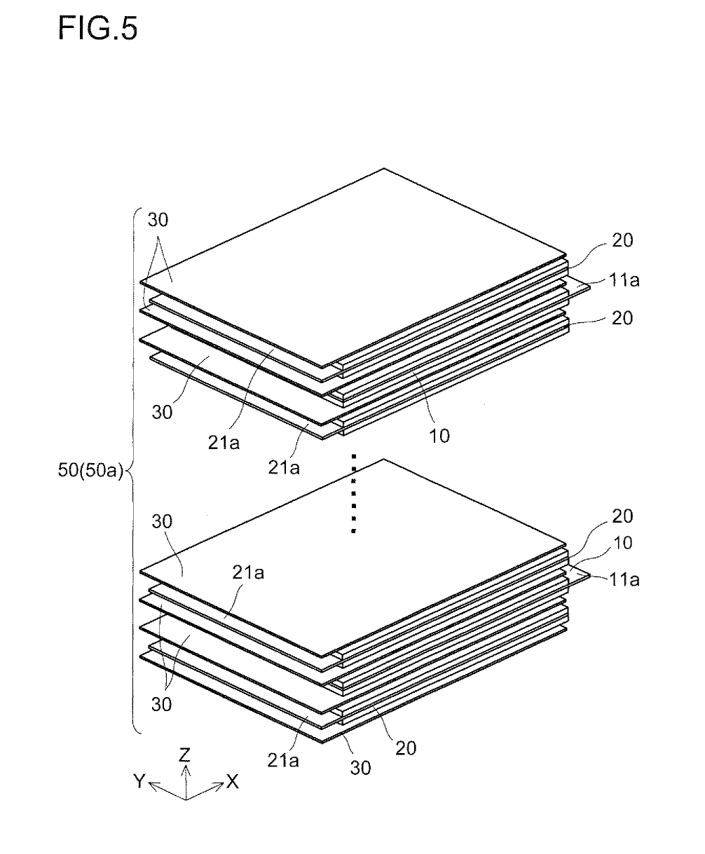

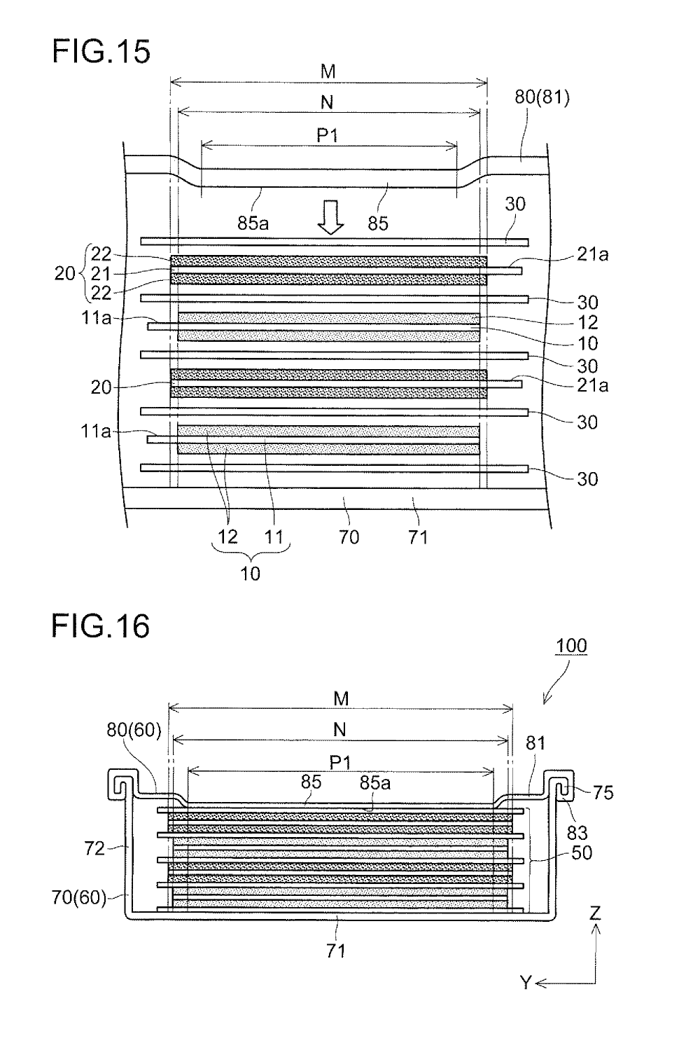

FIGS. 1 and 2 are exploded perspective views of a lithium-ion secondary battery according to a first embodiment (Embodiment 1) of the invention. FIG. 3 is an overall perspective view of the lithium-ion secondary battery according to Embodiment 1 of the invention. FIG. 4 is a plan view of the lithium-ion secondary battery according to Embodiment 1 of the invention. FIGS. 5 to 16 are diagrams in illustration of the lithium-ion secondary battery according to Embodiment 1 of the invention. It should be noted that FIG. 4 shows the lithium-ion secondary battery without the lid plate 80 which it ordinarily has, in order to show the inside of the battery. First, with reference to FIGS. 1 to 16, the lithium-ion secondary battery 100 according to Embodiment 1 will be described.

As shown in FIGS. 1 to 4, the lithium-ion secondary battery 100 according Embodiment 1 has a flat, rectangular shape (see FIG. 3), and includes an electrode assembly (electrode stack) 50 (see FIGS. 1 and 2), which in turn includes a positive (cathode) electrode 10 (see FIG. 1) and a negative (anode) electrode 20 (see FIG. 1), and a metal package container 60, in which the electrode assembly 50 is sealed along with a non-aqueous electrolyte liquid.

As shown in FIGS. 1 and 5, the electrode assembly 50 further includes a separator 30 for preventing short-circuiting between the positive and negative electrodes 10 and 20. The positive and negative electrodes 10 and 20 are arranged so as to face each other across the separator 30. In practice, the electrode assembly 50 usually includes a plurality of positive electrodes 10, a plurality of negative electrodes 20, and a plurality of separators 30. The positive electrodes 10, the separators 30, and the negative electrodes 20 are stacked sequentially to form a stacked structure (stacked member 50a). The positive and negative electrodes 10 and 20 are stacked alternately, one of each on one of the other. The electrode assembly 50 is so composed that, between every two adjacent negative electrodes 20, one positive electrode 10 is located. Moreover, the electrode assembly 50 has separators 30 arranged on the outermost sides thereof.

Specifically, the electrode assembly 50 is composed of, for example, twenty-four (24) positive electrodes 10, twenty-five (25) negative electrodes 20, and fifty (50) separators 30, with the positive and negative electrodes 10 and 20 stacked alternately with the separators 30 interposed between them.

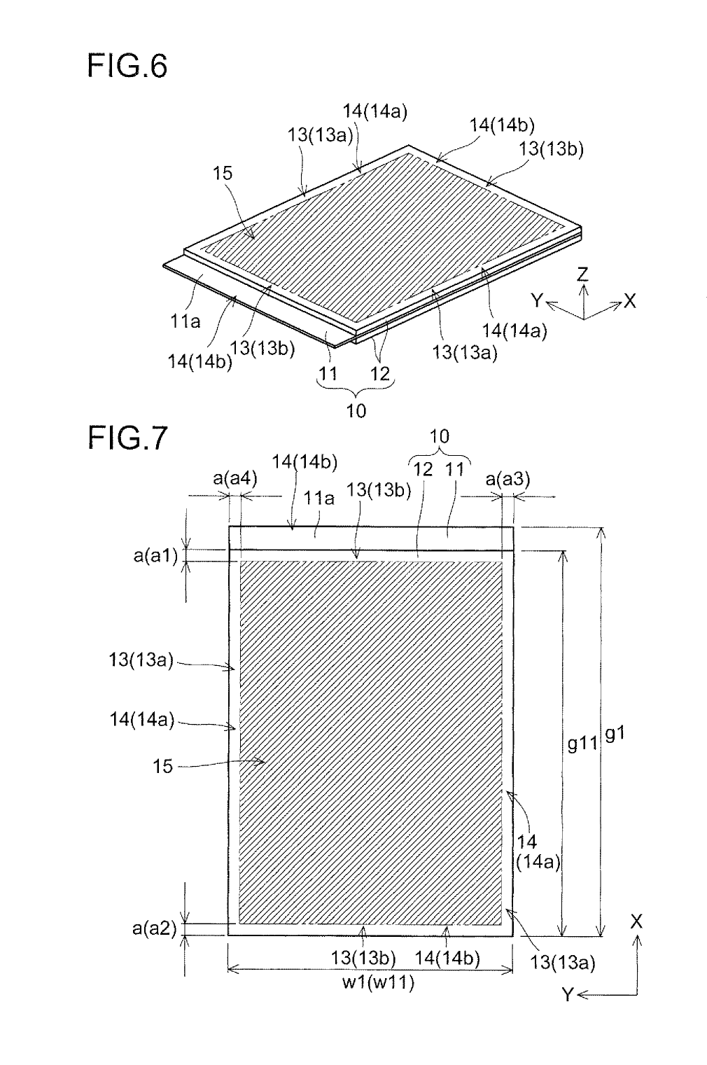

As shown in FIGS. 6 and 7, each positive electrode 10 in the electrode assembly 50 is composed of a positive electrode charge collector 11 having a positive electrode active material layer 12 laid on each face.

The positive electrode charge collector 11 serves to collect electric charge from the positive electrode active material layer 12. The positive electrode charge collector 11 is formed of, for example, a foil of metal such as aluminum, titanium, stainless steel, nickel, or iron, or a foil of an alloy of any of these metals, and has a thickness of about 1 μm to about 500 μm (for example, about 20 μm). Preferably, the positive electrode charge collector 11 is formed of a foil of aluminum or a foil of an alloy of aluminum, and is given a thickness of 20 μm or less.

The positive electrode charge collector 11 may be formed of, other than the materials mentioned above, metal such as aluminum or copper having its surface treated with carbon, nickel, titanium, silver, or the like for increased electrical conductivity and resistance to oxidation. These materials may have their surface oxidation-treated. Also usable are a copper-aluminum clad material, a stainless steel-aluminum clad material, or a plated material that is a combination of any of these metals. A charge collector may also be used that has foils of two or more metals bonded together. The positive electrode charge collector 11 may be other than foil-shaped; it may instead be film-shaped, sheet-shaped, or net-shaped; punched, or expanded; shaped like a lath member, a porous member, or a foamed member; or shaped like a member formed of clusters of fibers.

The positive electrode active material layer 12 is so formed as to contain a positive electrode active material that can occlude and release lithium ions. Examples of positive electrode active materials include oxides containing lithium; specifically, they include LiCoO₂, LiFeO₂, LiMnO₂, LiMn₂O₄, and any compound obtained by substituting part of the transition metal in any of these oxides with another metal element. Among these, preferable as the positive electrode active material are those which allow 80% or more of the lithium contained in the positive electrode to be used in the cell reaction under normal use. This makes it possible to enhance the safety of the secondary battery against accidents such as overcharging. Examples of such positive electrode active materials include compounds having a spinel structure, such as LiMn₂O₄; and compounds having an olivine structure represented by the formula LiMPO₄ (where M represents one or more elements selected from the group consisting of Co, Ni, Mn, and Fe). Among these, positive electrode active materials containing at least one of Mn and Fe are preferable from the viewpoint of cost. From the viewpoint of safety and charge voltage, it is preferable to use LiFePO₄. In LiFePO₄, all oxygen (O) atoms are bonded to phosphorus atoms by strong covalent bond, and thus oxygen is unlikely to be released on a rise in temperature; this makes LiFePO₄ excellent in safety.

Preferably, the positive electrode active material layer 12 is given a thickness of about 20 μm to about 2 mm, and further preferably from about 50 μm to about 1 mm.

The positive electrode active material layer 12 has at least to contain a positive electrode active material and there is no other particular restriction on its composition. For example, the positive electrode active material layer 12 may further include, in addition to a positive electrode active material, any other material such as a conductive agent (electrical conductivity enhancer), a thickening agent (viscosity modifier), and a binding agent (binder).

Any conductive agent may be used so long as it is an electron conducting material that does not adversely affect the performance of the positive electrode 10 in the battery. Examples include carbon materials such as carbon black, acetylene black, Ketjen black, graphite (natural and artificial), and carbon fiber; and conductive metal oxides. Among these, preferable as a conductive agent from the viewpoints of electron conduction and ease of application are carbon black and acetylene black.

Examples of thickening agents include polyethylene glycols, celluloses, polyacrylamides, poly-N-vinylamides, and poly-N-vinylpyrrolidones. Among these, preferable as a thickening agent are polyethylene glycols, and celluloses such as carboxymethyl cellulose (CMC), CMC being particularly preferable.

A binding agent serves to bind active material particles and conductive agent particles, and examples include fluorine polymers such as polyvinylidene fluoride (PVdF), polyvinyl pyridine, and polytetrafluoroethylene; polyolefin polymers such as polyethylene and polypropylene; and styrene-butadiene rubber.

Examples of solvents in which a positive electrode active material, a conductive agent, a binding agent, etc. are dispersed include organic solvents such as N-methyl-2-pyrrolidone, dimethylformamide, dimethylacetamide, methylethyl ketone, cyclohexanone, methyl acetate, methyl acrylate, diethyltriamine, N,N-dimethylaminopropylamine, ethylene oxide, and tetrahydrofuran.

The positive electrode 10 is formed, for example, in the following manner. A positive electrode active material, a conductive agent, a thickening agent, and a binding agent are blended, and an appropriate solvent is added to the blend to prepare a positive electrode composite agent in the form of paste; the paste is applied to the surface of the positive electrode charge collector 11 and is dried; as necessary, the product is compressed for increased electrode density.

As shown in FIG. 7, the positive electrode 10 has a rectangular shape as seen in a plan view, and has four edge portions 14 (two edge portions 14a in the X direction and two edge portions 14b in the Y direction). In Embodiment 1, the positive electrode 10 has a Y-direction width w1 of, for example, about 146 mm, and has an X-direction length g1 of, for example, about 208 mm. The region over which the positive electrode active material layer 12 is applied (the application region, or the formation region) has a Y-direction width w11 of, for example, about 146 mm, which is equal to the width w1 of the positive electrode 10, and has an X-direction length g11 of, for example, about 196 mm. Thus, the positive electrode active material layer 12 formed in the application region has a rectangular shape as seen in a plan view, and has four edge portions 13 (two edge portions 13a along the X direction and two edge portions 13b along the Y direction).

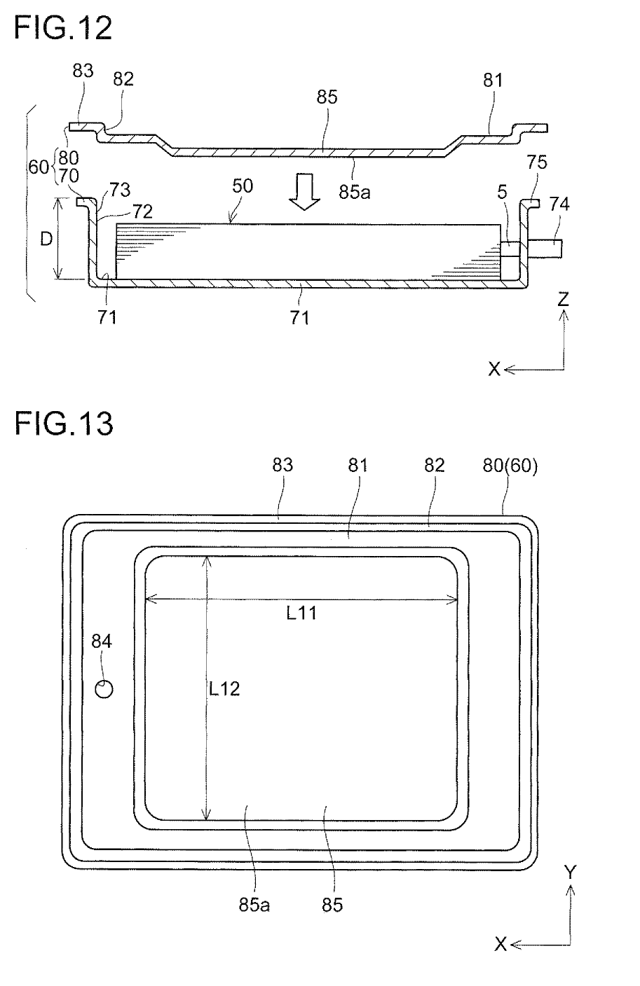

The positive electrode 10 has, at one end in the X direction, a charge collector-exposed portion 11a where the positive electrode active material layer 12 is not formed and the surface of the positive electrode charge collector 11 is exposed. To the charge collector-exposed portion 11a is electrically connected a charge collection lead 5 (see FIGS. 4 and 12), which will be described later, for extraction of electric current. The four edge portions 13 of the positive electrode active material layer 12 align with the edge portions 14 of the positive electrode 10 except one of the two edge portions 13b along the Y direction (the edge portion 13b at which the charge collector-exposed portion 11a is located).

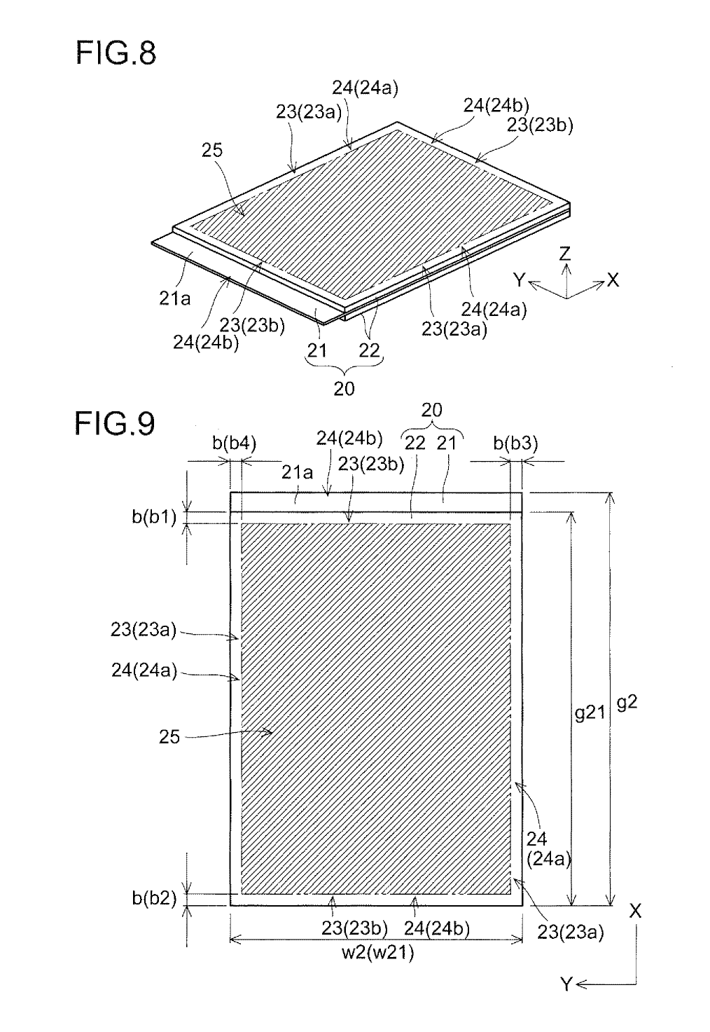

As shown in FIGS. 8 and 9, each negative electrode 20 in the electrode assembly 50 is composed of a negative electrode charge collector 21 having a negative electrode active material layer 22 laid on each face.

The negative electrode charge collector 21 serves to collect electric charge from the negative electrode active material layer 22. The negative electrode charge collector 21 is formed of, for example, a foil of metal such as copper, nickel, stainless steel, iron, or a plated nickel layer, or a foil of an alloy of any of these metals, and has a thickness of about 1 μm to about 100 μm (for example, about 16 μm). Preferably, the negative electrode charge collector 21 is formed of a foil of copper or stainless steel, and is given a thickness of 4 μm or more but 20 μm or less.

The negative electrode charge collector 21 may be other than foil-shaped; it may instead be film-shaped, sheet-shaped, or net-shaped; punched, or expanded; shaped like a lath member, a porous member, or a foamed member; or shaped like a member formed of clusters of fiber.

The negative electrode active material layer 22 is so formed as to contain a negative electrode active material that can occlude and release lithium ions. Examples of negative electrode active materials include substances containing lithium and substances that can occlude and release lithium. To build a high energy density battery, it is preferable to use a material of which the potentials at which lithium is occluded and released are close to the potentials at which metal lithium deposits and dissolves. Typical examples of such materials include natural and artificial graphite in the form of particles (that is, in the form of scales, lumps, fibers, whiskers, spheres, crushed particles, and the like). Also usable as a negative electrode active material is artificial graphite obtained by graphitizing mesocarbon microbeads, mesophase pitch powder, isotropic pitch powder, or the like. It is also possible to use graphite particles whose surface is coated with amorphous carbon. Also usable are lithium transition metal oxides, lithium transition metal nitrides, transition metal oxides, silicon oxides, and the like. Examples of lithium transition metal oxides include lithium titanates as exemplified by Li₄Ti₅O₁₂, whose use reduces degradation of the negative electrode 20 and thus helps prolong the life of the battery.

Preferably, the negative electrode active material layer 22 is given a thickness of about 20 μm to about 2 mm, and further preferably from about 50 μm to about 1 mm.

The negative electrode active material layer 22 has at least to contain a negative electrode active material and there is no other particular restriction on its composition. For example, the negative electrode active material layer 22 may further include, in addition to a negative electrode active material, any other material such as a conductive agent (electrical conductivity enhancer), a thickening agent (viscosity modifier), and a binding agent (binder). Usable as these other materials are the same as those for (usable in) the positive electrode active material layer 12.

The negative electrode 20 is formed, for example, in the following manner. A negative electrode active material, a conductive agent, a thickening agent, and a binding agent are blended, and an appropriate solvent is added to the blend to prepare a negative electrode composite agent in the form of paste; the paste is applied to the surface of the negative electrode charge collector 21 and is dried; as necessary, the product is compressed for increased electrode density.

As shown in FIG. 9, the negative electrode 20 has a rectangular shape as seen in a plan view, and has four edge portions 24 (two edge portions 24a in the X direction and two edge portions 24b in the Y direction). Moreover, the negative electrode 20 is formed to have a greater planar area than the positive electrode 10 (see FIGS. 7 and 8). In Embodiment 1, the negative electrode 20 has a Y-direction width w2 of, for example, about 150 mm, which is greater than the width w1 (see FIG. 7) of the positive electrode 10, and has an X-direction length g2 of, for example, about 210 mm, which is greater than the length g1 (see FIG. 7) of the positive electrode 10. The region over which the negative electrode active material layer 22 is applied (the application region, or the formation region) has a Y-direction width w21 of, for example, about 150 mm, which is equal to the width w2 of the negative electrode 20, and has an X-direction length g21 of, for example, about 200 mm. Thus, the negative electrode active material layer 22 formed in the application region has a rectangular shape as seen in a plan view, and has four edge portions 23 (two edge portions 23a along the X direction and two edge portions 23b along the Y direction).

Like the positive electrode 10, the negative electrode 20 has, at one end in the X direction, a charge collector-exposed portion 21a where the negative electrode active material layer 22 is not formed and the surface of the negative electrode charge collector 21 is exposed. To the charge collector-exposed portion 21a is electrically connected a charge collection lead 5 (see FIGS. 4 and 12) for extraction of electric current. The four edge portions 23 of the negative electrode active material layer 22 align with the edge portions 24 of the negative electrode 20 except one of the two edge portions 23b along the Y direction (the edge portion 23b at which the charge collector-exposed portion 21a is located).

The separators 30 in the electrode assembly 50 are expected to provide sufficient mechanical strength and hold as much electrolyte liquid as possible. From this viewpoint, examples of preferable materials include microporous film and nonwoven fabric of materials such as polyethylene, polypropylene, and ethylene-propylene copolymer with a thickness of 10 μm to 50 μm and with a porosity (void percentage) of 30% to 70%.

Other examples of the material for the separators 30 include microporous film and the like formed of high polymers such as polyvinylidene fluoride, polyvinylidene chloride, polyacrylnitrile, polyacrylamide, polytetrafluoroethylene, polysulfone, polyethersulfone, polycarbonate, polyamide, polyimide, polyether (polyethylene oxide, polypropylene oxide, cellulose (carboxymethyl cellulose, hydroxypropyl cellulose), poly(meth)acrylic acid, and poly(meth)acrylic acid esters. A multilayer film may be used that has two or more such microporous films stacked together.

Preferably, each separator 30 is given a thickness of 5 μm to 100 μm, and further preferably 10 μm to 30 μm. Preferably, the separator 30 is given a porosity of 30% to 90%, and further preferably 40% to 80%. With the thickness of the separator 30 less than 5 μm, it has insufficient mechanical strength, causing internal short-circuiting of the battery. On the other hand, with the thickness of the separator 30 more than 100 μm, the distance between the positive and negative electrodes is so great that the battery has a high internal resistance. With a porosity less than 30%, the amount of non-aqueous electrolyte liquid contained is so small that the battery has a high internal resistance. On the other hand, with a porosity more than 90%, the positive and negative electrodes 10 and 20 make physical contact with each other, causing internal short-circuiting of the battery. Depending on their thickness and porosity, the separators 30 may be used in stacks of several sheets of them, with consideration given to mechanical strength, the content of non-aqueous electrolyte liquid, the internal resistance of the battery, the likelihood of internal short-circuiting of the battery, and other factors.

The separator 30 is so shaped as to be larger than the application region (formation region) of the positive electrode active material layer 12 and larger than the application region (formation region) of the negative electrode active material layer 22. Specifically, the separator 30 is formed to have a rectangular shape with a longitudinal (vertical) dimension (length in the direction corresponding to the X direction) of about 154 mm and a lateral (horizontal) dimension (length in the direction corresponding to the Y direction) of about 206 mm.

As shown in FIGS. 1 and 5, the positive and negative electrodes 10 and 20 are arranged so that the charge collector-exposed portion 11a of the positive electrodes 10 and the charge collector-exposed portion 21a of the negative electrodes 20 are located at opposite sides, and are stacked with the separators 30 interposed between the positive and negative electrodes.

There is no particular restriction on the non-aqueous electrolyte liquid sealed inside the package container 60 along with the electrode assembly 50. Examples of usable solvents include esters such as ethylene carbonate (EC), propylene carbonate, butylene carbonate, diethyl carbonate (DEC), dimethyl carbonate, methyl ethyl carbonate, and gamma-butyrolactone; ethers such as tetrahydrofuran, 2-methyltetrahydrofuran, dioxane, dioxolane, diethylether, dimethoxymethane, diethoxyethane, and methoxyethoxy ethane; and polar solvents such as dimethyl sulfoxide, sulfolane, methyl sulfolane, acetonitrile, methyl formate, and methyl acetate. Any of these solvents may be used singly or as a mixed solvent of two or more of them.

The non-aqueous electrolyte liquid may contain an electrolyte supporting salt. Examples of electrolyte supporting salts include lithium salts such as LiClO₄, LiBF₄ (lithium tetrafluoroborate), LiPF₆ (lithium hexafluorophosphate), LiCF₃SO₃ (lithium trifluoromethanesulfonate), LiF (lithium fluoride), LiCl (lithium chloride), LiBr (lithium bromide), LiI (lithium iodide), and LiAlCl₄ (lithium tetrachloroaluminate). Any of these may be used singly or as a mixture of two or more of them.

There is no particular restriction on the concentration of an electrolyte supporting salt, a preferable concentration being from 0.5 mol/L (mol per liter) to 2.5 mol/L, and further preferably from 1.0 mol/L to 2.2 mol/L. With the concentration of an electrolyte supporting salt less than 0.5 mol/L, the concentration of charge carriers in the non-aqueous electrolyte liquid may be so low that the non-aqueous electrolyte liquid has a high resistance. With the concentration of an electrolyte supporting salt more than 2.5 mol/L, the degree of dissociation of the salt itself may be so low that the concentration of carriers in the non-aqueous electrolyte liquid remains low.

The package container 60, in which the electrode assembly 50 is sealed, is a large, flat, rectangular container and, as shown in FIGS. 1 to 3, is composed of a package can 70 in which the electrode assembly 50 etc. are housed and a lid plate 80 which seals the opening of the package can 70. The package can 70 having the electrode assembly 50 housed in it is sealed with the lid plate 80 by a double seam. The package can 70 is an example of a “housing container” according to the invention, and the lid plate 80 is an example of a “lid member” according to the invention.

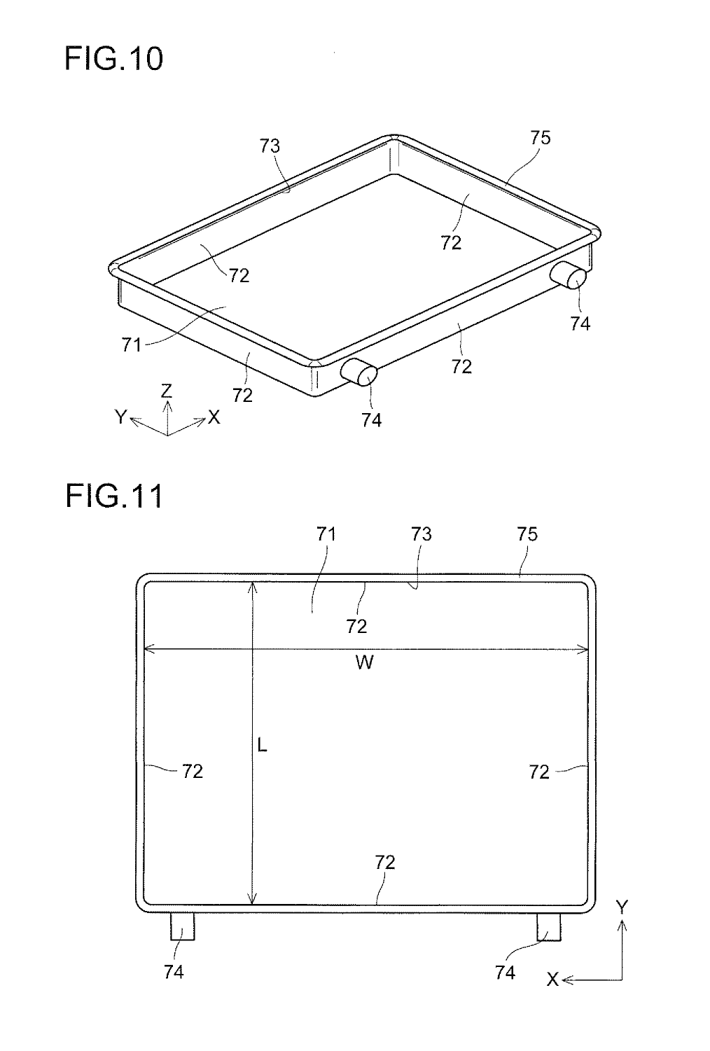

The package can 70 is formed, for example, by subjecting a metal plate to deep drawing, and has a bottom face portion 71 and a side wall portion 72. Moreover, as shown in FIGS. 10 to 12, the package can 70 has, at one end (on the side opposite from the bottom face portion 71), an opening 73 through which to house the electrode assembly 50 (see FIG. 12). The package can 70 is formed as a box-shaped can, its face with the greatest area being the bottom face portion 71.

The package can 70 has inside dimensions such that the electrode assembly 50 can be housed in it with the electrode surfaces facing the bottom face portion 71. Specifically, the package can 70 is formed to have, for example, a longitudinal dimension (length L in the Y direction in FIG. 11) of about 164 mm and a lateral dimension (length W in the X direction in FIG. 11) of about 206 mm. Moreover, as shown in FIG. 12, the package can 70 is given a depth D of, for example, about 20 mm.

Moreover, as shown in FIGS. 10 and 11, in the package can 70, on a side wall portion 72 at one side in the Y direction, there are formed electrode terminals 74. Furthermore, around the rim of the opening 73 of the package can 70, there is provided a container flange portion 75 for double-seam sealing.

The lid plate 80 is formed, for example, by pressing of a metal plate. As shown in FIGS. 12 and 13, the lid plate 80 has a panel portion 81, which is substantially flat-plate-shaped and stops the opening 73 of the package can 70, a chuck wall portion 82, which connects to the circumferential edge of the panel portion 81 and extends upward therefrom, and a flange portion 83, which connects to the circumferential edge of the chuck wall portion 82. Moreover, as shown in FIGS. 1 and 13, at one side in the X direction, there is formed a filling hole 84 through which to inject non-aqueous electrolyte liquid. The filling hole 84 is formed with a diameter of, for example, 2 mm.

The package can 70 and the lid plate 80 are formed of, for example, a metal plate of iron, stainless steel, aluminum, or the like, or a steel plate of nickel-plated iron, or a steel plate of aluminum-plated iron, or the like. Iron is inexpensive, and is preferable from the viewpoint of cost; however, to secure reliability for a long period of time, it is further preferable to use a metal plate of stainless steel, aluminum, or the like, or a steel plate of nickel-plated iron, or a steel plate of aluminum-plated iron, or the like. Other than these materials, also usable is a high-polymer-laminated material (laminated plate), that is, a metal plate having its surface laminated with a high-polymer material. In that case, it is preferable that at least the surface facing the inside of the battery be coated. The metal plate is given a thickness of, for example, about 0.4 mm to about 1.2 mm (for example, about 1.0 mm).

As shown in FIGS. 4 and 12, the electrode assembly 50 is housed inside the package can 70 with the positive electrodes 10 (see FIG. 1) and the negative electrodes 20 (see FIG. 1) facing the bottom face portion 71 of the package can 70. With the electrode assembly 50 so housed, the charge collector-exposed portion 11a (see FIG. 7) of the positive electrodes 10 and the charge collector-exposed portion 21a (see FIG. 9) of the negative electrode 20 are electrically connected, via charge collection leads 5 respectively, to the electrode terminals 74 on the package can 70. The charge collection leads 5 may be formed of the same material as, or a different material from, the charge collectors. The positive and negative electrodes 10 and 20 may be connected to charge collection electrodes (charge collecting members) respectively, so that, via these charge collection electrodes, the electrode assembly 50 is electrically connected to the electrode terminals 74.

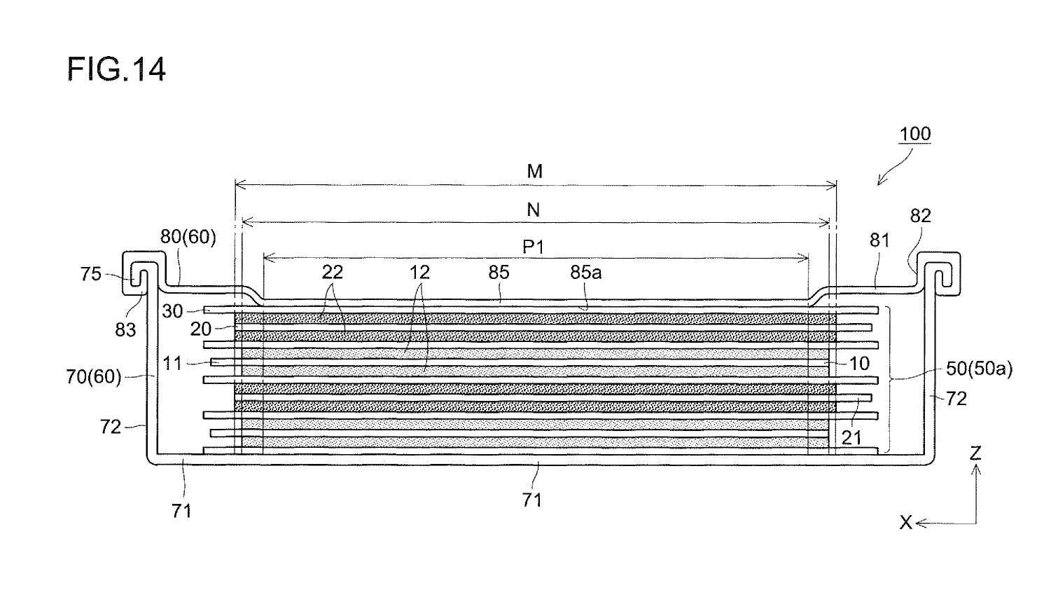

As shown in FIGS. 14 and 16, the opening 73 of the package can 70 is sealed with the lid plate 80 by a double seam. Specifically, the edge portion of the flange portion 83 of the lid plate 80 is crimped in such a way as to enfold the container flange portion 75 of the package can 70, and thereby the lid plate 80 is fitted to the package can 70.

The chuck wall portion 82 allows the panel portion 81 of the lid plate 80 to be located a predetermined distance below the rim of the opening 73 of the package can 70 (toward the bottom face portion 71). Thus, when the electrode assembly 50 (stacked member 50a) is housed in the package container 60, the package can 70 and the lid plate 80 apply a pressing force to the electrode assembly 50 in its stack direction (the direction of the depth of the package can 70, which is the Z direction), and this holds the positive and negative electrodes 10 and 20 closely together, with the separators 30 interposed between them.

After the opening 73 of the package can 70 is sealed with the lid plate 80, non-aqueous electrolyte liquid is injected through the filling hole 84, for example, under reduced pressure. Then, for example, a metal ball 90 (see FIG. 3) with approximately the same diameter as the filling hole 84 is placed in the filling hole 84, and the filling hole 84 is sealed by electric resistance welding, laser welding, or the like.

In the lithium-ion secondary battery 100 according to Embodiment 1, to prevent risks such as rupture (ignition) of the battery that may result from a rise in the internal pressure of the battery due to overcharging or high temperature, there is provided a safety valve (not shown) for liberating the internal pressure of the battery. And, to prevent the package container 60 from breaking open before activation of the safety valve, the lid plate 80 is fitted with such sealing strength that the pressure resistance at the sealed part is higher than the activation pressure of the safety valve.

Here, in Embodiment 1, the package can 70 and the lid plate 80 apply a pressing force to the region of the positive and negative electrode active material layers 12 and 22 excluding the edge portions (end portions) 14 and 24 of the positive and negative electrodes 10 and 20. That is, a pressing force is applied to, in the positive and negative electrode active material layers 12 and 22, the region (active material layer formation region) excluding the edge portions (end portions) 14 and 24 of the positive and negative electrode 10 and 20. Specifically, in Embodiment 1, a pressing force is applied within the region 15 (hatched in FIGS. 6 and 7) of the positive electrode active material layer 12 and the region 25 (hatched in FIGS. 8 and 9) of the negative electrode active material layer 22 excluding the four edge portions 13 of the positive electrode active material layer 12 and the four edge portions 23 of the negative electrode active material layer 22.

As shown in FIGS. 7 and 9, the region in which the pressing force is applied to the positive and negative electrodes 10 and 20 is within an inward region 15 of the positive electrode active material layer 12 a distance “a” (“a1” to “a4”) away from (inward of) the edges thereof, or within an inward region 25 of the negative electrode active material layer 22 a distance “b” (“b1” to “b4”) away from (inward of) the edges thereof. Preferably, the distance “a” from the edges of the positive electrode active material layer 12 in the positive electrode 10 and the distance “b” from the edges of the negative electrode active material layer 22 in the negative electrode 20 are each 1 mm or more, and further preferably 5 mm or more. In Embodiment 1, since the positive electrode 10 has a smaller planar area than the negative electrode 20, preferably, the region in which the pressing force is applied to the positive and negative electrodes 10 and 20 is within an inward region 15 of the positive electrode active material layer 12 a distance “a” of 5 mm or more away from the edges thereof. With this structure, also in the negative electrode 20, the pressing force is applied within an inward region 25 of the negative electrode active material layer 22 a distance “b” of 5 μm or more away from the edges thereof.

Moreover, in Embodiment 1, as shown in FIGS. 12, 14, and 16, so that the pressing force may be applied to the region of the positive and negative electrode active material layers 12 and 22 excluding the edge portions (end portions) 14 and 24 of the positive and negative electrodes 10 and 20, the lid plate 80 has a protruding portion 85 formed on it. The protruding portion 85 formed on the lid plate 80 is an example of a “first protruding portion” according to the invention.

Specifically, in the lithium-ion secondary battery 100 according to Embodiment 1, the lid plate 80 is so structured as to face the electrodes (positive and negative electrodes 10 and 20), and in the panel portion 81 of the lid plate 80, the protruding portion 85 is formed so as to protrude toward the electrode assembly 50 (positive and negative electrodes 10 and 20) (in the Z direction). The protruding portion 85 is formed integrally with the lid plate 80 by pressing, and has a substantially flat pressing surface 85a. The pressing surface 85a of the lid plate 80 presses the electrode assembly 50 in the stack direction (Z direction), and thereby a pressing force is applied within the region 15 of the positive electrode active material layer 12 and the region 25 of the negative electrode active material layer 22 excluding the four edge portions 13 of the positive electrode active material layer 12 and the four edge portions 23 of the negative electrode active material layer 22. Thus, in Embodiment 1, as shown in FIGS. 14 to 16, the region P1 in which the protruding portion 85 applies a pressing force is located inside (inward of) the formation region M of the negative electrode active material layer 22 and inside (inward of) the formation region N of the positive electrode active material layer 12.

As shown in FIG. 13, the pressing surface 85a of the protruding portion 85 has a substantially rectangular shape as seen in a plan view, and is formed to have a planar area smaller than that of the positive electrode active material layer 12 (see FIG. 7). The pressing surface 85a has an X-direction length L11 of, for example, about 194 mm, which is smaller than the X-direction length g11 (see FIG. 7) of the positive electrode active material layer 12. The pressing surface 85a has a Y-direction length L12 of, for example, about 144 mm, which is smaller than the Y-direction length w1 (see FIG. 7) of the positive electrode active material layer 12.

Moreover, in Embodiment 1, the protruding portion 85 applies a pressing force to almost all over the inward region 15 of the positive electrode active material layer 12 a distance “a” away from the edges thereof or the inward region 25 of the negative electrode active material layer 22 a distance “b” away from the edges thereof. Preferably, the area of the region in which the pressing force is applied to the positive and negative electrodes 10 and 20 is 10% or more but 99% or less of the planar area of the positive electrode active material layer 12, and further preferably 20% or more but 98% or less.

The pressing force applied to the electrode assembly 50 is controlled by controlling the amount of pressing-in (compression) effected by the lid plate 80, and the amount of protrusion of the protruding portion 85 is adjusted so that a predetermined pressing force is obtained. Preferably, the amount of protrusion of the protruding portion 85 is so set that the proportion of the amount of pressing-in (compression) with respect to the thickness of the electrode assembly 50 (the total thickness of the positive electrodes 10, the negative electrodes 20, and the separators 30) in the stack direction is about 5% to about 15% (for example 10%).

As described above, the lithium-ion secondary battery 100 according to Embodiment 1 is so structured that, when a pressing force is applied to the positive and negative electrodes 10 and 20, the pressing force is applied to the region of the positive and negative electrode active material layers 12 and 22 excluding the edge portions (end portions) 14 and 24 of the positive and negative electrodes 10 and 20. This makes it possible to prevent the pressing force from being applied to the edge portions 14 of the positive electrode 10 and the edge portions 24 of the negative electrode 20.

Here, the positive and negative electrodes 10 and 20 are both formed by use of a long, strip-shaped charge collector sheet: first the positive or negative electrode active material layer 12 or 22 is applied to the charge collector sheet by a predetermined method, and the sheet is then cut into the lengths of individual electrodes. The application of the active material layer to the charge collector sheet is achieved, for example, by a method involving so-called intermittent application (hereinafter referred to as an “intermittent application method”): first the active material layer is applied only for a length enough to form a single electrode; then a charge collector-exposed portion 11a or 21a where the active material layer is not applied is secured; then the active material layer is applied for the next electrode; and this sequence of operations is repeated. Another usable method is, for example, one involving continuous application (hereinafter referred to as a “continuous application method”): the active material layer is applied with the charge collector-exposed portions 11a and 21a located at one end of the direction perpendicular to the length direction.

In a case where a continuous application method as described above is adopted, when the long charge collector sheet is cut, the active material layer and the charge collector supporting it are cut simultaneously. As a result, burrs develop at the cut faces of the charge collector, and the impact during cutting makes the cut faces and parts around them of the active material layer unstable. This makes part of the active material layer prone to scale off at an edge.

On the other hand, in a case where an intermittent application method is adopted, cutting is performed in the charge collector-exposed portions 11a and 21a, and this makes the scaling-off of the active material layer less likely. With an intermittent application method, however, depending on the viscosity of the composite agent paste, bulges may form at the application-starting and -ending ends of the active material layer. That is, projections may form in the end portions (edge portions) of the active material layer. A step may also form at the boundary between the non-application portion (charge collector-exposed portion) of the charge collector and the active material layer.

Thus, in Embodiment 1, owing to the structure described above in which no pressing force is applied to the edge portions 14 (end portions) of the positive electrode 10 and the edge portions (end portions) 24 of the negative electrode 20 (no pressing force is applied to the cut faces of the electrodes), even when burrs form at the cut faces of the positive and negative electrodes 10 and 20 in the process of forming (cutting) these, it is possible to prevent the burrs from causing short-circuiting between the positive and negative electrodes 10 and 20. Moreover, even when the impact during cutting makes the cut faces and parts around them of the active material layer unstable and makes part of the active material layer prone to scale off, it is possible to prevent a pressing force from being applied to those parts, and thus to prevent scaling-off and the like of the active material. This makes it possible to prevent internal short-circuiting resulting from a scaled-off part of the active material penetrating the separator 30. Consequently, it is possible to prevent internal short-circuiting during the assembly and the like of the battery, and thus to obtain a large-capacity lithium-ion secondary battery 100 at high yields.

Producing lithium-ion secondary batteries with larger capacities involves use of huge amounts of positive electrode active material, electrolyte liquid, etc. which are expensive; thus, low yields lead to high product prices. On the other hand, recent years have been seeing increasingly high demand for low prices, arousing expectations for high yields. Thus, it is extremely important to improve the production yields of lithium-ion secondary batteries.

Moreover, in Embodiment 1, by applying a pressing force to a region of the positive and negative electrode active material layers 12 and 22, it is possible to hold the positive and negative electrodes 10 and 20 closely together, with the separator 30 interposed between them. This makes it possible to improve life characteristics such as cycle characteristics. Moreover, by applying the pressing force to the positive and negative electrodes 10 and 20, it is possible to prevent displacement of the electrodes, and this too helps improve cycle characteristics. Thus, with the structure described above, it is possible to improve life characteristics and reliability.

Moreover, in Embodiment 1, owing to the package can 70 and the lid plate 80 applying a pressing force within, respectively, the region 15 of the positive electrode active material layer 12 and the region 25 of the negative electrode active material layer 22 excluding the four edge portions 13 of the positive electrode active material layer 12 and the four edge portions 23 of the negative electrode active material layer 22, even when projections form at the application-starting and -ending ends of the active material layer, it is possible to prevent the pressing force from being applied to those projections. In addition, even when a step forms at the boundary between the charge collector-exposed portion and the active material layer, it is possible to prevent the pressing force from being applied to the step. Thus, it is possible to prevent the inconvenience of the separator 30 being damaged as a result of a pressing force being applied to a region where a projection, step, or the like has formed. This makes it possible to prevent contact between the positive and negative electrode active material layers 12 and 13 resulting from damage to the separator 30, and this too helps prevent internal short-circuiting.

Furthermore, in Embodiment 1, owing to the structure described above, it is possible to prevent a pressing force from being applied to the edge portions 14 of the positive electrode 10 and the edge portions 24 of the negative electrode 20, and thus it is possible to prevent internal short-circuiting from occurring in the edge portions (end portions) of the electrodes as the active material layers expand and contract during charging and discharging of the battery. This too helps improve cycle characteristics. In addition, it is possible to improve reliability.

As described above, with the lithium-ion secondary battery 100 according to Embodiment 1, it is possible to improve life characteristics and reliability, and in addition to improve yields. Thus, it is possible to provide large-capacity, long-life lithium-ion secondary batteries 100 at low prices.

Moreover, in Embodiment 1, by forming the protruding portion 85 protruding toward the positive and negative electrodes 10 and 20 on the lid plate 80 stopping the opening 73 of the package can 70, it is possible, with the protruding portion 85, to easily apply a pressing force to the region of the positive and negative electrode active material layers 12 and 22 excluding the edge portions (end portions) 14 and 24 of the positive and negative electrodes 10 and 20.

Moreover, in Embodiment 1, by forming the protruding portion 85 integrally with the lid plate 80, it is possible to easily form the protruding portion 85 on the lid plate 80. In addition, even when the protruding portion 85 is formed on the lid plate 80, this can be done without increasing the number of components.

Moreover, in Embodiment 1, by forming the protruding portion 85 such that it has a substantially flat pressing surface 85a, when a pressing force is applied with the protruding portion 85 (pressing surface 85a) of the lid plate 80, it is possible to prevent the pressing force from concentrating at one point on the active material layer. It is thus possible to prevent the inconvenience of a crack developing in the active material layer as a result of the pressing force concentrating at one point. This makes it possible to prevent degradation of cycle characteristics resulting from a crack developing in the active material layer. If the protruding portion has a sharp tip (for example, if it has a pointed tip), internal short-circuiting is likely to occur; by contrast, by giving the protruding portion 85 a substantially flat pressing surface 85a as described above, it is possible to prevent internal short-circuiting.

The lithium-ion secondary battery 100 according to Embodiment 1 structured as described above can be used suitably as a stationary electric power storage battery which is expected to have a long life. It can also be used suitably as a vehicle-mounted storage battery for hybrid electric vehicles (HEVs), electric vehicles (EVs), and the like. The lithium-ion secondary battery 100 according to Embodiment 1 is suitable as a storage battery with a per-cell capacity of 10 Ah or more, and is particularly suitable as a large-capacity storage battery with a per-cell capacity of 50 Ah or more.

### Embodiment 2

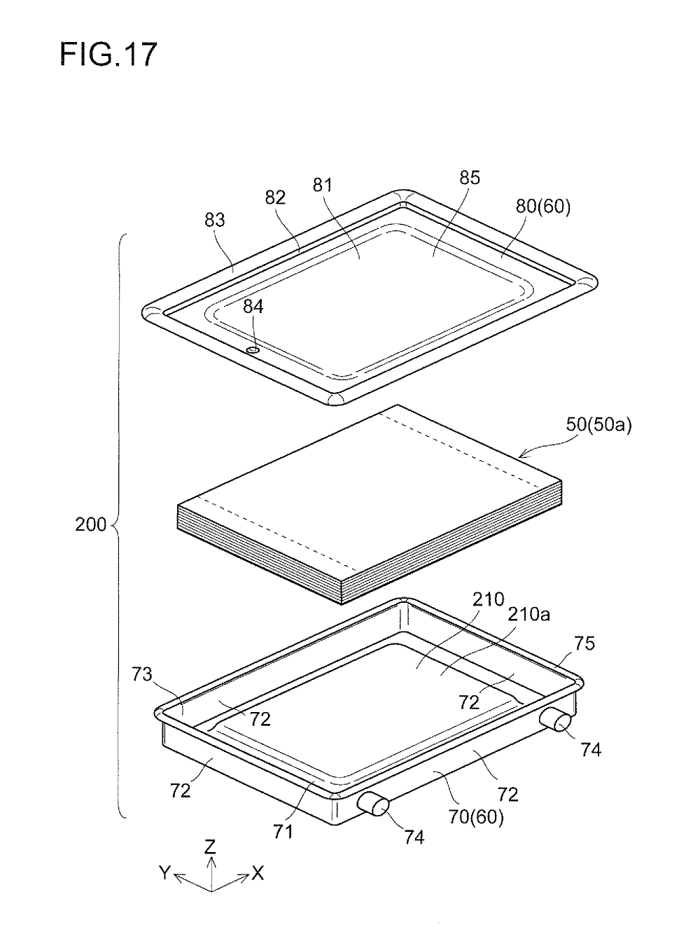

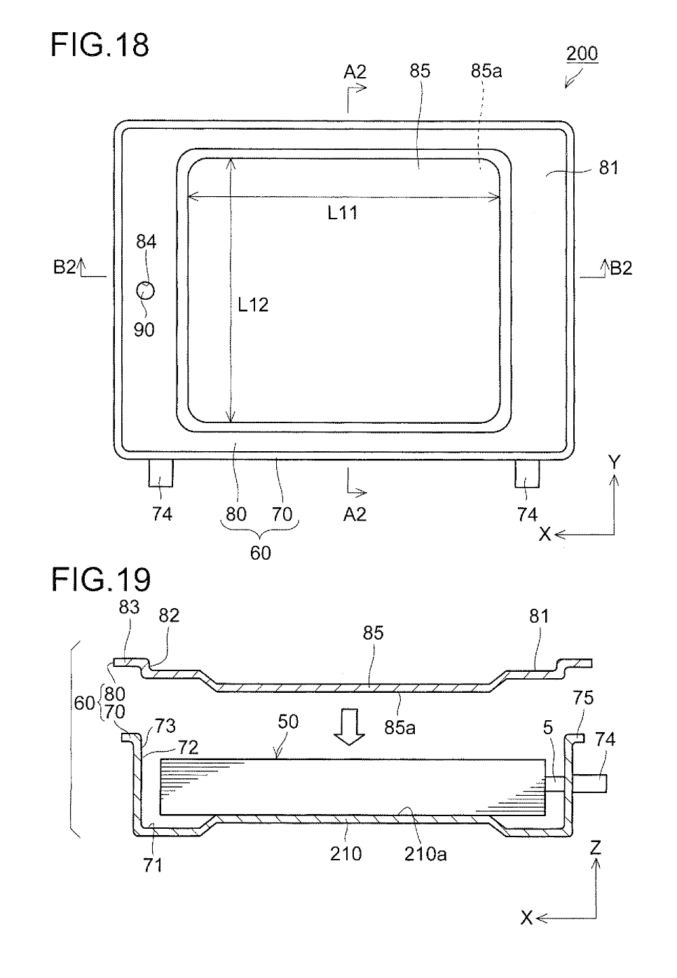

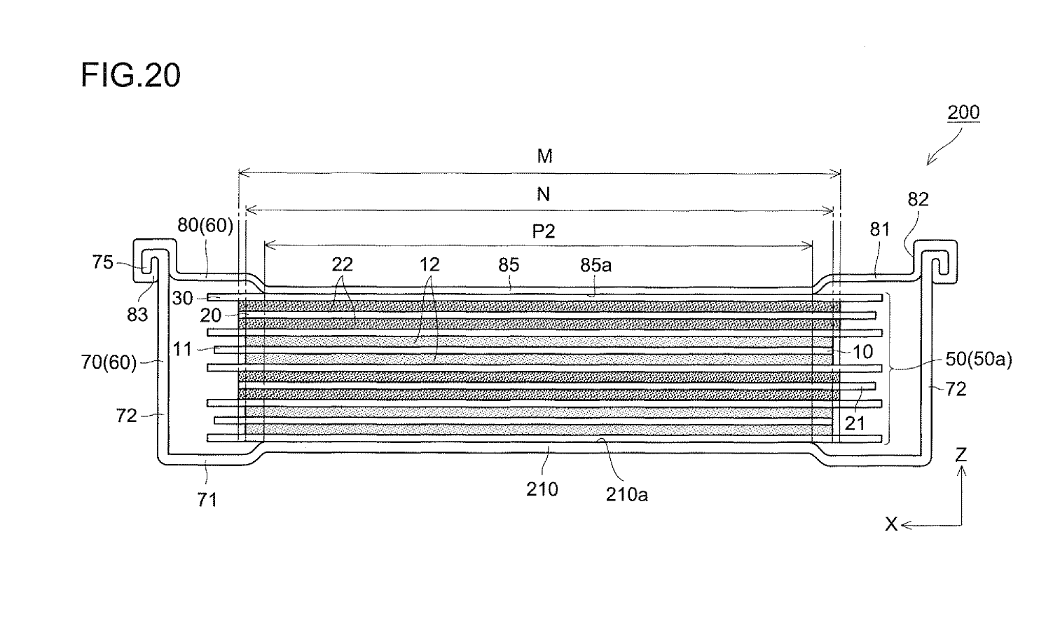

FIG. 17 is an exploded perspective view of a lithium-ion secondary battery according to a second embodiment (Embodiment 2) of the invention. FIG. 18 is a plan view of the lithium-ion secondary battery according to Embodiment 2 of the invention. FIG. 19 is a sectional view schematically showing the lithium-ion secondary battery according to Embodiment 2 of the invention. FIGS. 20 to 22 are diagrams in illustration of the lithium-ion secondary battery according to Embodiment 2 of the invention. Next, with reference to FIGS. 7, 9, and 17 to 22, the lithium-ion secondary battery 200 according to Embodiment 2 of the invention will be described. Among the different diagrams, the same components are identified by the same reference signs, and no overlapping description will be repeated unless necessary.

In the lithium-ion secondary battery 200 according to Embodiment 2, as shown in FIG. 17, on the basis of the structure of Embodiment 1 described previously, a protruding portion 210 is formed also on the bottom face portion 71 of the package can 70. That is, in Embodiment 2, protruding portions are formed on the package can 70 and on the lid plate 80 respectively. The protruding portion 210 formed on the package can 70 is an example of a “second protruding portion” according to the invention.

Moreover, as shown in FIGS. 19 to 21, the protruding portion 210 is formed integrally with the bottom face portion 71 of the package can 70 so as to protrude toward the electrode assembly 50 (in the Z direction). Moreover, as shown in FIG. 22, the protruding portion 210 on the package can 70 has a substantially flat pressing surface 210a. The pressing surface 210a of the protruding portion 210 is formed in a shape substantially identical with that of the pressing surface 85a of the protruding portion 85 formed on the lid plate 80. Specifically, as shown in FIG. 22, the pressing surface 210a of the protruding portion 210 is formed in a substantially rectangular shape as seen in a plan view. Moreover, the pressing surface 210a of the protruding portion 210 has an X-direction length L21 and a Y-direction length L22 that are substantially equal to the lengths L11 and L12, respectively, (see FIG. 18) of the pressing surface 85a of the protruding portion 85. Thus, the pressing surface 210a of the protruding portion 210 has a planer area smaller than that of the positive electrode active material layer 12 (see FIG. 7).

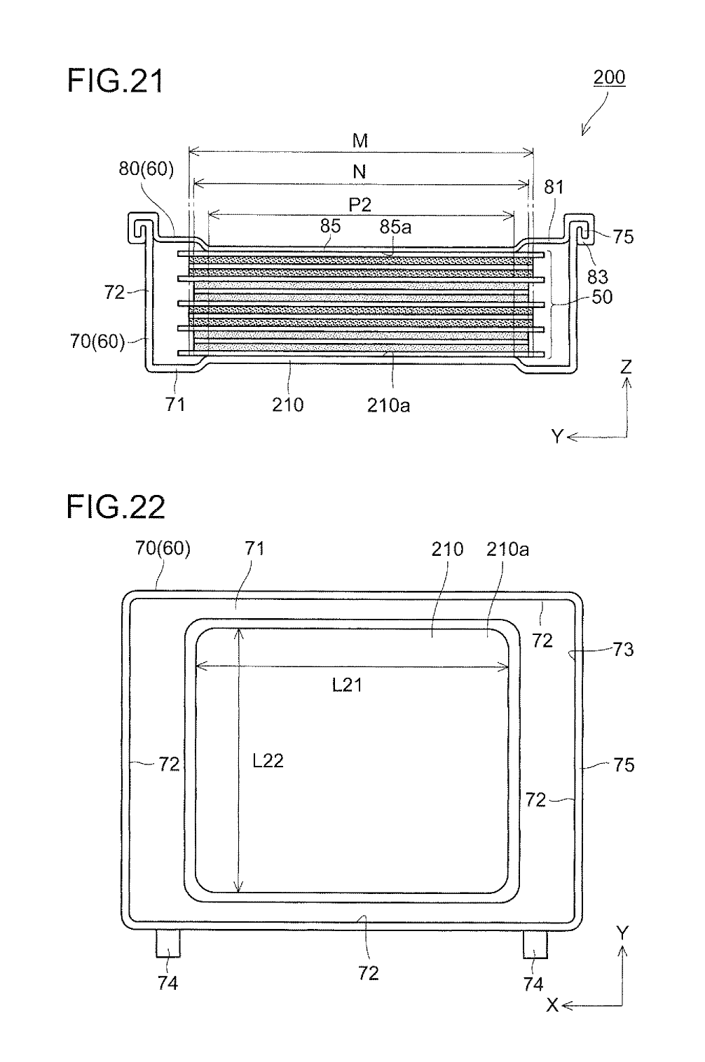

Moreover, as shown in FIGS. 20 and 21, the protruding portion 210 formed on the package can 70 is formed in a position corresponding to the protruding portion 85 formed on the lid plate 80. That is, the protruding portion 210 is so formed as to overlap the protruding portion 85 on the lid plate 80 as seen in a plan view.

The protruding portion 85 (pressing surface 85a) formed on the lid plate 80 and the protruding portion 210 (pressing surface 210a) formed on the package can 70 press the electrode assembly 50 in the stack direction (Z direction), so that a pressing force is applied within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 2, the region P2 in which the protruding portions 85 and 210 apply a pressing force is located inside the formation region M of the negative electrode active material layer 22 and inside the formation region N of the positive electrode active material layer 12.

In Embodiment 2, the amounts of protrusion of the protruding portions 85 and 219 are adjusted so that a predetermined pressing force is obtained. Thus, for example in a case where the same pressing force as in Embodiment 1 described previously is applied to the electrode assembly 50, the larger the amount of protrusion of the protruding portion 210, the smaller that of the protruding portion 85.

In other respects, the structure of Embodiment 2 is similar to that of Embodiment 1 described previously.

As described above, in Embodiment 2, by forming the protruding portion 85 on the panel portion 81 of the lid plate 80 and in addition forming the protruding portion 210 on the bottom face portion 71 of the package can 70, it is possible to more easily apply a pressing force to the region of the positive and negative electrode active material layers 12 and 22 excluding the edge portions (end portions) 14 and 24 of the positive and negative electrodes 10 and 20.

In other respects, the benefits of Embodiment 2 are similar to those of Embodiment 1 described previously.

### Embodiment 3

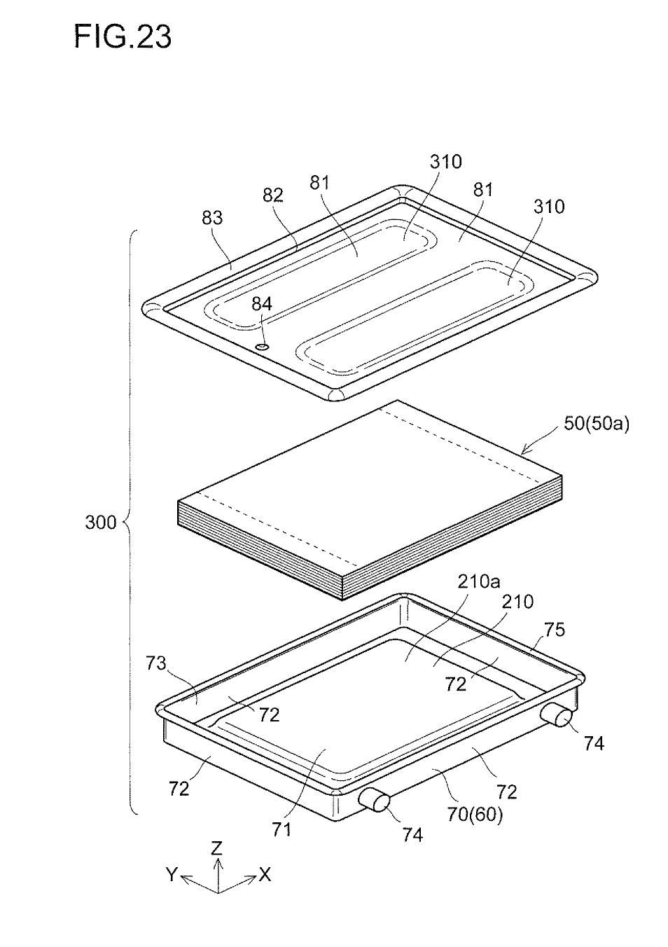

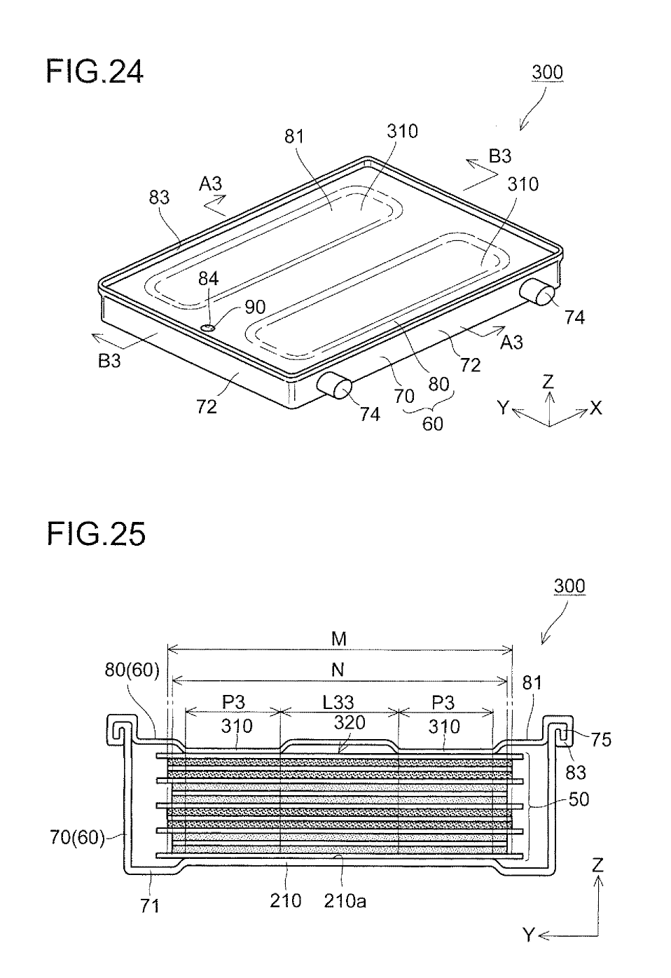

FIG. 23 is an exploded perspective view of a lithium-ion secondary battery according to a third embodiment (Embodiment 3) of the invention. FIG. 24 is an overall perspective view of the lithium-ion secondary battery according to Embodiment 3 of the invention. FIGS. 25 to 28 are diagrams in illustration of the lithium-ion secondary battery according to Embodiment 3 of the invention. Next, with reference to FIGS. 7, 9, and 23 to 28, the lithium-ion secondary battery 300 according to Embodiment 3 of the invention will be described. Among the different diagrams, the same components are identified by the same reference signs, and no overlapping description will be repeated unless necessary.

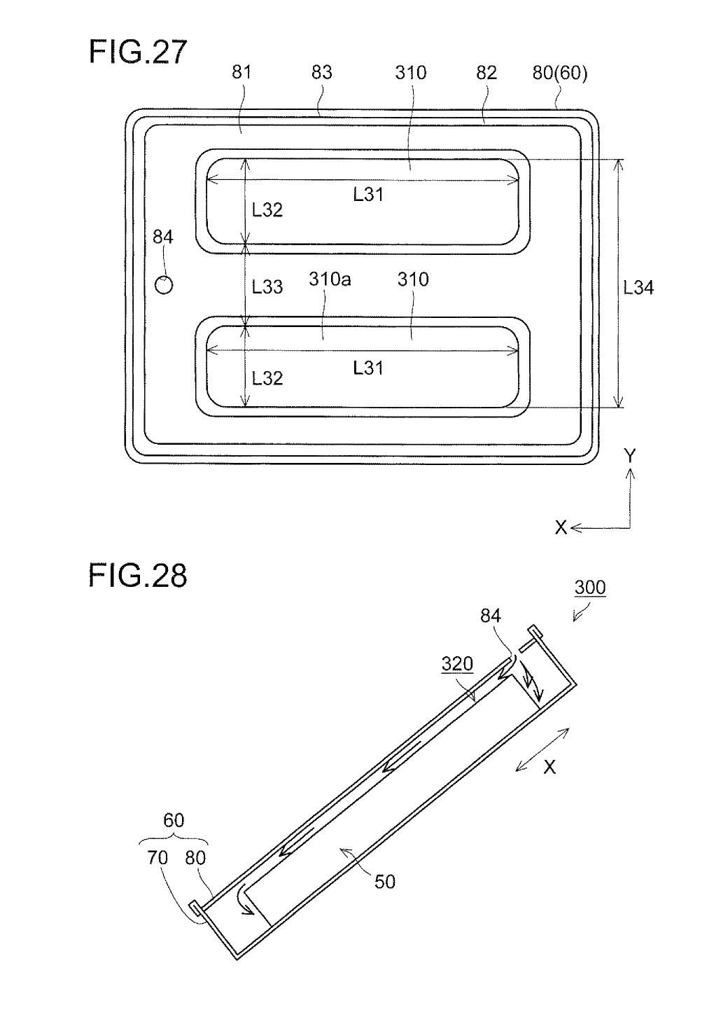

The lithium-ion secondary battery 300 according to Embodiment 3 differs from those of Embodiments 1 and 2 described previously in that, as shown in FIG. 23, a plurality of (two) protruding portions 310 are formed on the panel portion 81 of the lid plate 80. As shown in FIGS. 24 and 27, the protruding portions 310 are fainted to extend in the X direction parallel to each other. The protruding portions 310 formed on the lid plate 80 are an example of a “first protruding portion” according to the invention.

Moreover, as in Embodiments 1 and 2 described previously, the protruding portions 310 are formed integrally with the lid plate 80 so as to protrude toward the electrode assembly 50. Furthermore, the protruding portions 310 each have a substantially flat pressing surface 310a (see FIG. 27), and the pressing surfaces 310a of the protruding portions 310 are formed in a substantially rectangular shape as seen in a plan view. The total area of the two pressing surfaces 310a is made smaller than the planar area of the positive electrode active material layer 12 (see FIG. 7).

The protruding portions 310 (pressing surfaces 310a) have an X-direction length L31 equal to the length L11 (see FIG. 13) of the protruding portion 85. Moreover, the two protruding portions 310 are arranged at a predetermined distance L33 (for example, about 2 mm to about 80 mm) from each other. The protruding portions 310 (pressing surfaces 310a) have a Y-direction length L32 such that the total distance L34 of the Y-direction length L32 of the two pressing surfaces 310a and the distance L33 at which the two pressing surfaces 310a are apart from each other is equal to the X-direction length L12 (FIGS. 13 and 18) of the protruding portion 85 in Embodiments 1 and 2. The distance L34 may be made smaller than the Y-direction length L12 of the protruding portion 85.

Moreover, in Embodiment 3, as a result of the two protruding portions 310 being arranged at the distance L33 from each other, as shown in FIG. 25, across this distance (across the distance at which the protruding portions 310 are apart from each other), a cavity portion 320 is formed which extends from one side to the other in the X direction inside the battery. Thus, after sealing, when non-aqueous electrolyte liquid is injected through the filling hole 84, inclining the lithium-ion secondary battery 300 as shown in FIG. 28 permits the non-aqueous electrolyte liquid injected through the filling hole 84 to flow through the cavity portion 320 to the other side in the X direction (away from the filling hole 84). This allows the injected non-aqueous electrolyte liquid to seep into the electrode assembly 50 from opposite sides thereof, namely from the side at which the filling hole 84 is formed and from the opposite side. This helps achieve satisfactory seepage of the non-aqueous electrolyte liquid. Consequently, the production speed of the battery is improved, and thus it is possible to improve the production efficiency of the battery. In FIG. 28, arrows schematically indicate the flow of the non-aqueous electrolyte liquid.

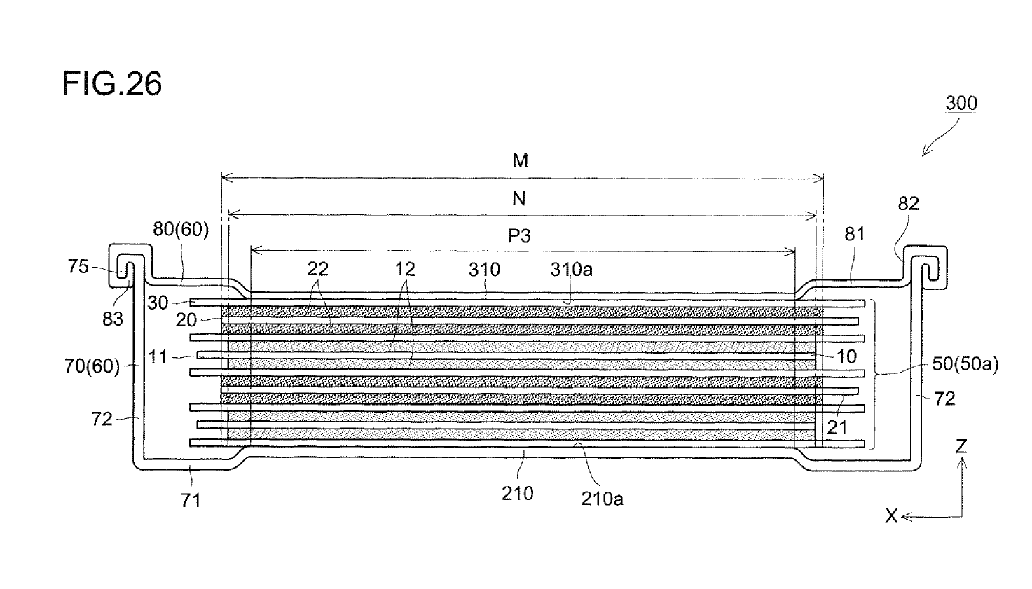

Furthermore, in Embodiment 3, as shown in FIG. 23, a protruding portion 210 like that in Embodiment 2 described previously is formed on the bottom face portion 71 of the package can 70. As shown in FIGS. 25 and 26, the protruding portions 310 (pressing surfaces 310a) formed on the lid plate 80 and the protruding portion 210 (pressing surface 210a) formed on the package can 70 press the electrode assembly 50 in the stack direction (Z direction), so that a pressing force is applied within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 3, the region P3 in which the protruding portions 310 and 210 apply a pressing force is located inside the formation region M of the negative electrode active material layer 22 and inside the formation region N of the positive electrode active material layer 12. In Embodiment 3, the region P3 in which the pressing force is applied is smaller than in Embodiments 1 and 2 described previously.

In other respects, the structure of Embodiment 3 is similar to those of Embodiments 1 and 2 described previously.

As described above, in Embodiment 3, by forming a plurality of protruding portions 310 on the lid plate 80, it is possible to improve the mechanical strength of the lid plate 80 against twisting and the like. That is, it is possible to improve the torsional rigidity and the like of the lid plate 80.

In other respects, the benefits of Embodiment 3 are similar to those of Embodiments 1 and 2 described previously.

### Embodiment 4

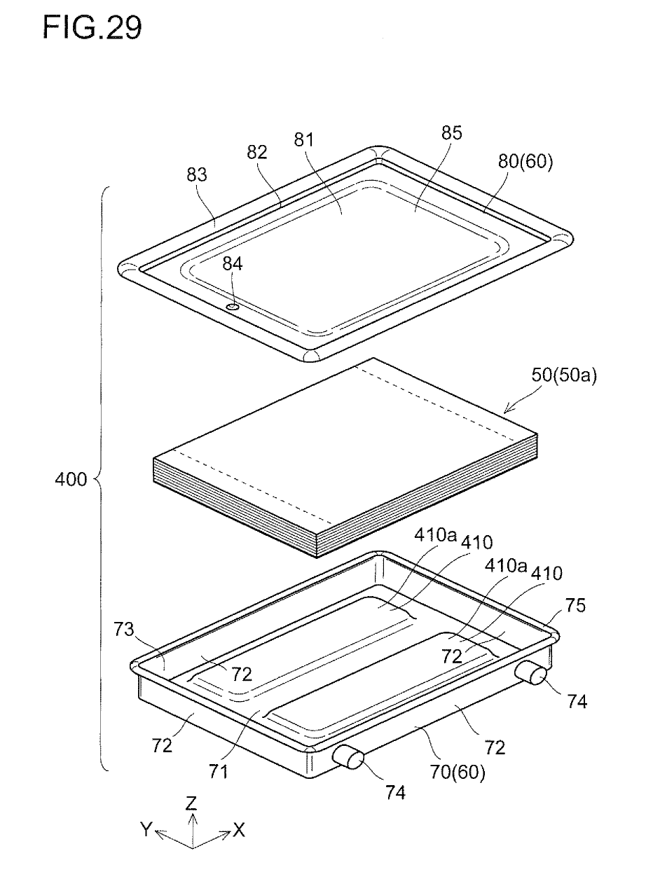

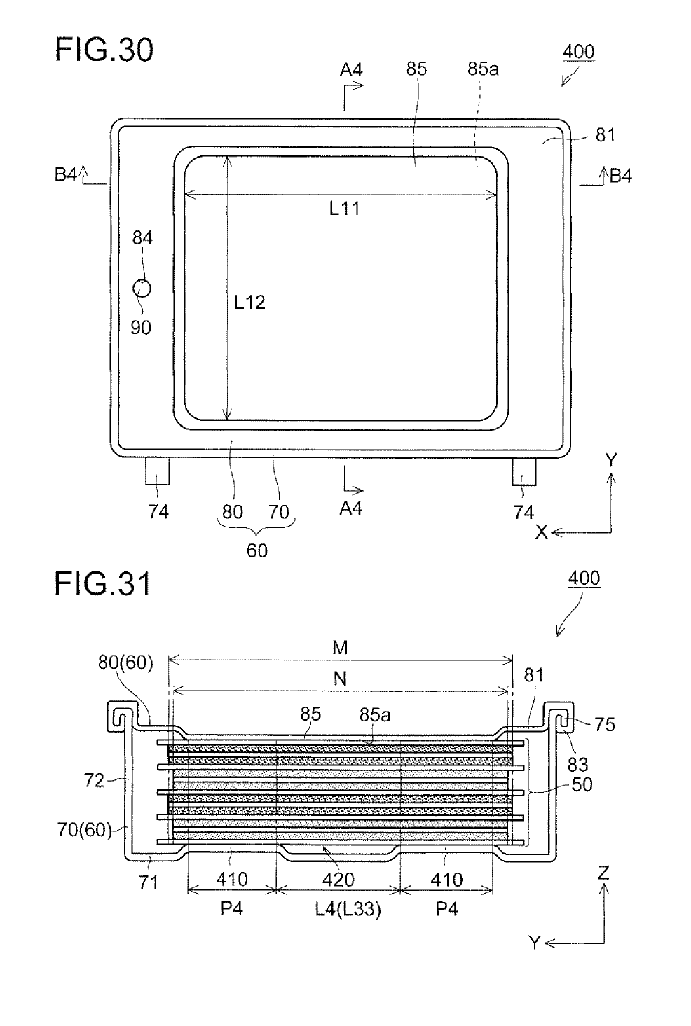

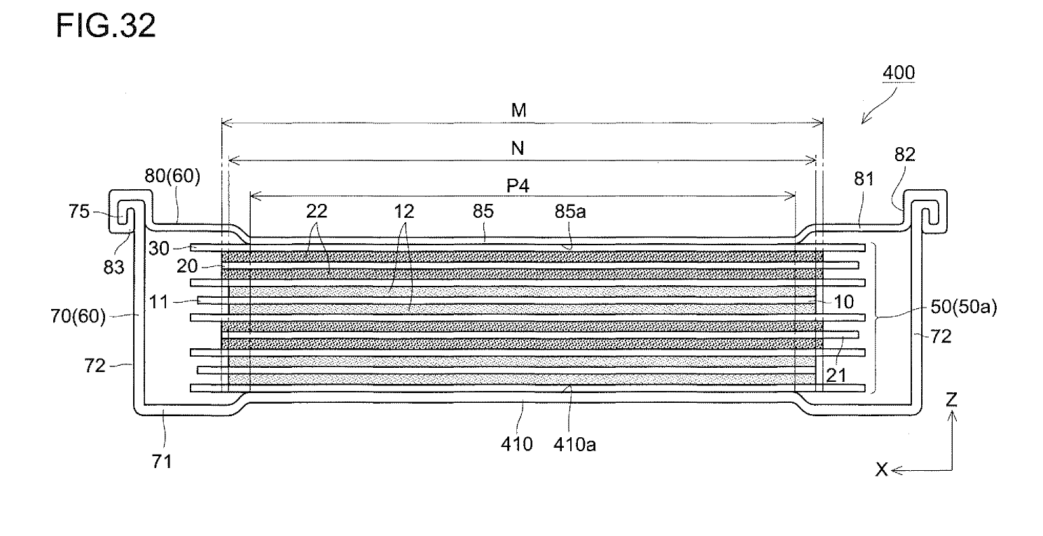

FIG. 29 is an exploded perspective view of a lithium-ion secondary battery according to a fourth embodiment (Embodiment 4) of the invention. FIG. 30 is a plan view of the lithium-ion secondary battery according to Embodiment 4 of the invention. FIGS. 31 and 32 are sectional views of the lithium-ion secondary battery according to Embodiment 4 of the invention. FIG. 31 shows a section cut along line A4-A4 in FIG. 30, and FIG. 32 shows a section along line B4-B4 in FIG. 30. Next, with reference to FIGS. 7, 9, 23, 27, and 29 to 32, the lithium-ion secondary battery 400 according to Embodiment 4 of the invention will be described. Among the different diagrams, the same components are identified by the same reference signs, and no overlapping description will be repeated unless necessary.

As shown in FIG. 29, the lithium-ion secondary battery 400 according to Embodiment 4 has a plurality of (two) protruding portions 410 formed on the bottom face portion 71 of the package can 70. As in Embodiments 2 and 3 described previously, the protruding portions 410 are formed so as to protrude toward the electrode assembly 50, and are formed in a shape similar to that of the protruding portions 310 (see FIGS. 23 and 27) on the lid plate 80 in Embodiment 3 described previously. Moreover, in Embodiment 4, as shown in FIGS. 29 and 30, as in Embodiments 1 and 2 described previously, a protruding portion 85 that protrudes toward the electrode assembly 50 is formed on the panel portion 81 of the lid plate 80. That is, in Embodiment 4, the arrangement of protruding portions for pressing the electrode assembly 50 is upside down (reversed) as compared to that in Embodiment 3 described previously.

Moreover, in Embodiment 4, as shown in FIGS. 29 and 31, the two protruding portions 410 on the bottom face portion 71 of the package can 70 are formed at a distance of L4 (for example, about 2 mm to about 80 mm) (see FIG. 31) from each other. Thus, across this distance (across the distance at which the protruding portions 410 are apart from each other), a cavity portion 420 is formed which extends from one side to the other in the X direction inside the battery. Thus, as in Embodiment 3, after sealing, when non-aqueous electrolyte liquid is injected through the filling hole 84, satisfactory seeping of the non-aqueous electrolyte liquid is achieved. This makes it possible to improve the production efficiency of the battery.

Moreover, in Embodiment 4, as in Embodiments 1 to 3 described previously, the protruding portion 85 (pressing surface 85a) formed on the lid plate 80 and the protruding portions 410 (pressing surfaces 410a) formed on the package can 70 press the electrode assembly 50 in the stack direction (Z direction). Thereby, as shown in FIGS. 31 and 32, a pressing force is applied within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 4, the region P4 in which the protruding portions 85 and 410 apply a pressing force is located inside the formation region M of the negative electrode active material layer 22 and inside the formation region N of the positive electrode active material layer 12.

In other respects, the structure of Embodiment 4 is similar to those of Embodiments 1 to 3 described previously.

As described above, in Embodiment 4, by forming a plurality of protruding portions 410 on the bottom face portion 71 of the package can 70, it is possible to improve the mechanical strength of the package can 70 against twisting and the like. That is, it is possible to improve the torsional rigidity and the like of the package can 70.

In other respects, the benefits of Embodiment 4 are similar to those of Embodiments 1 to 3 described previously.

### Embodiment 5

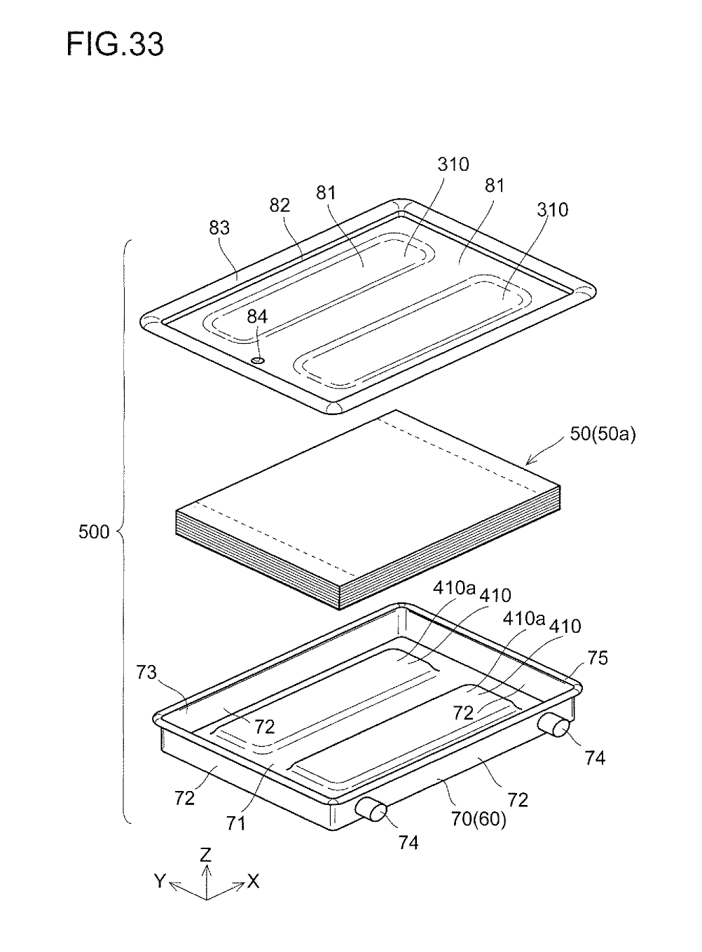

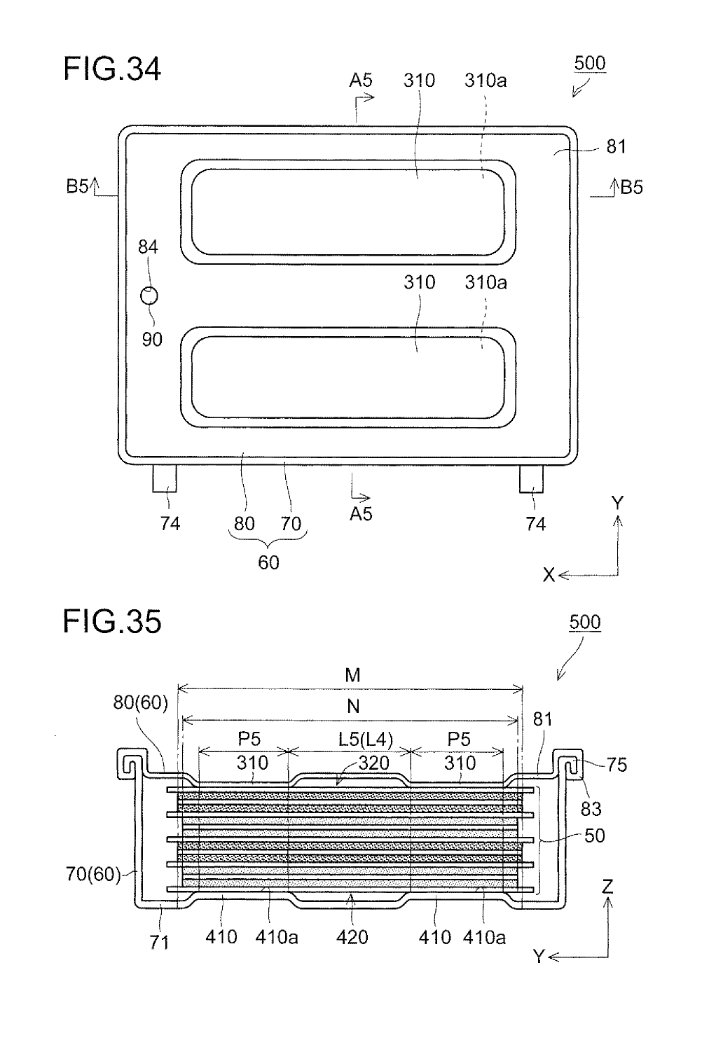

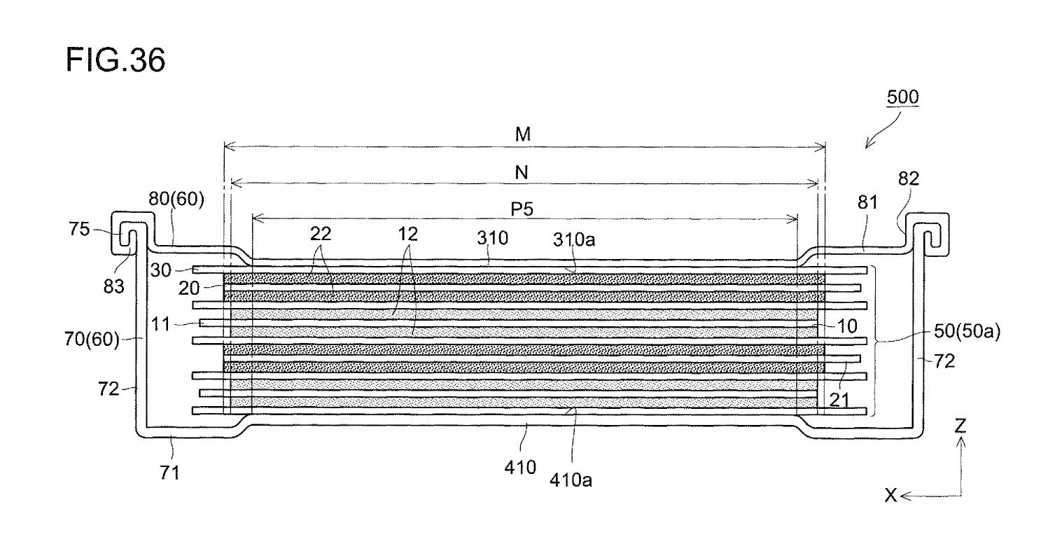

FIG. 33 is an exploded perspective view of a lithium-ion secondary battery according to a fifth embodiment (Embodiment 5) of the invention. FIG. 34 is a plan view of the lithium-ion secondary battery according to Embodiment 5 of the invention. FIGS. 35 and 36 are sectional views of the lithium-ion secondary battery according to Embodiment 5 of the invention. FIG. 35 shows a section cut along line A5-A5 in FIG. 34, and FIG. 36 shows a section cut along line B5-B5 in FIG. 34. Next, with reference to FIGS. 7, 9, and 33 to 36, the lithium-ion secondary battery 500 according to Embodiment 5 of the invention will be described. Among the different diagrams, the same components are identified by the same reference signs, and no overlapping description will be repeated unless necessary.

In the lithium-ion secondary battery 500 according to Embodiment 5, as shown in FIGS. 33 and 34, a plurality of (two) of protruding portions are formed on each of the panel portion 81 of the lid plate 80 and the bottom face portion 71 of the package can 70. Specifically, in Embodiment 5, as in Embodiment 3 described previously, two protruding portions 310 are formed on the panel portion 81 of the lid plate 80 integrally therewith and, as in Embodiment 4 described previously, two protruding portions 410 are formed on the bottom face portion 71 of the package can 70 integrally therewith.

Moreover, as shown in FIGS. 35 and 36, the protruding portions 310 formed on the lid plate 80 and the protruding portions 410 formed on the package can 70 are formed at mutually corresponding (facing) positions. That is, in the lithium-ion secondary battery 500 according to Embodiment 5, the protruding portions 310 and the protruding portions 410 are formed so as to overlap (coincide with) each other as seen in a plan view.

Moreover, in. Embodiment 5, as shown in FIGS. 33 and 35, the two protruding portions 310 on the lid plate 80 are arranged at a distance of L5 (L4) (see FIG. 35) from each other, and the protruding portions 410 on the bottom face portion 71 of the package can 70 are also arranged at a distance of L5 (L4) (see FIG. 35) from each other. Across those distances respectively, cavity portions 320 and 420 are formed which extend from one side to the other side in the X direction inside the battery. Thus, as in Embodiments 3 and 4 described previously, after sealing, when non-aqueous electrolyte liquid is injected through the filling hole 84, the non-aqueous electrolyte liquid injected through the filling hole 84 flows efficiently through the two cavity portions 320 and 420 to the other side in the X direction (away from the filling hole 84). This helps achieve satisfactory seeping of non-aqueous electrolyte liquid into the electrode assembly 50, and thus makes it possible to improve the production efficiency of the battery.

Furthermore, in Embodiment 5, as in Embodiments 1 to 4 described previously, the protruding portions 310 (pressing surfaces 310a) formed on the lid plate 80 and the protruding portions 410 (pressing surfaces 410a) formed on the package can 70 presses the electrode assembly 50 in the stack direction (Z direction). Thereby, as shown in FIGS. 35 and 36, a pressing force is applied within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 5, the region P5 in which the protruding portions 310 and 410 apply a pressing force is located inside the formation region M of the negative electrode active material layer 22 and inside the formation region N of the positive electrode active material layer 12.

In other respects, the structure of Embodiment 5 is similar to those of Embodiments 1 to 4 described previously.

In other respects, the benefits of Embodiment 5 are similar to those of Embodiments 1 to 4 described previously.

### Embodiment 6

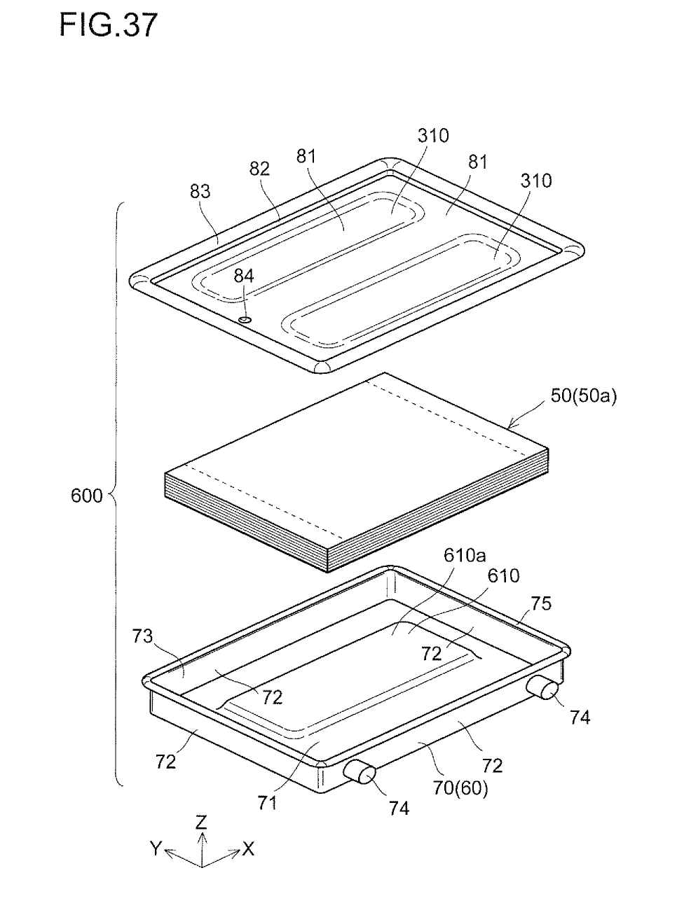

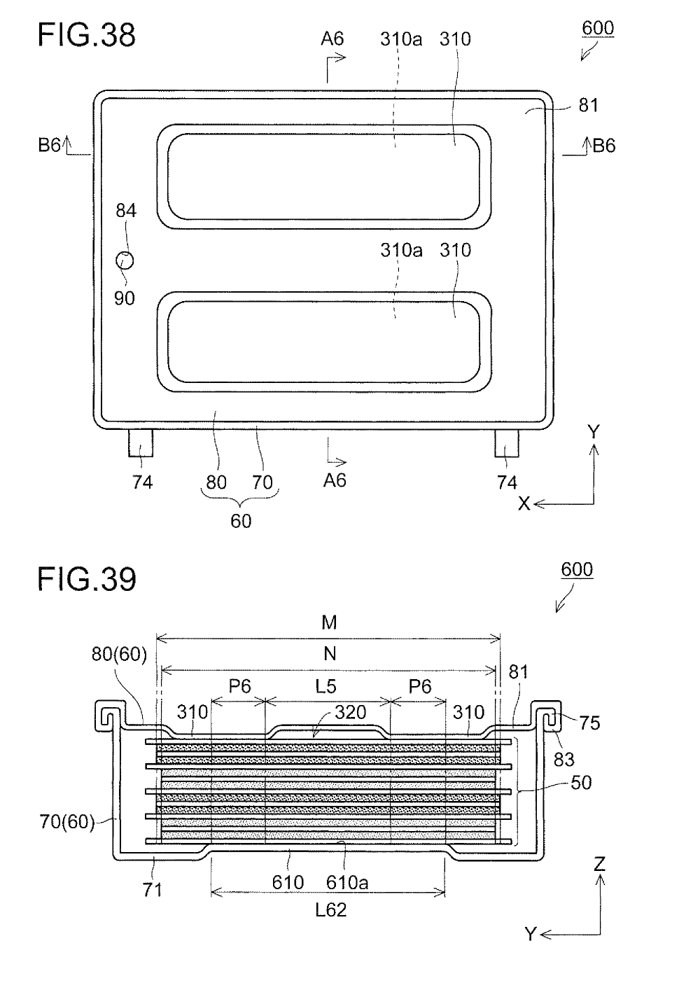

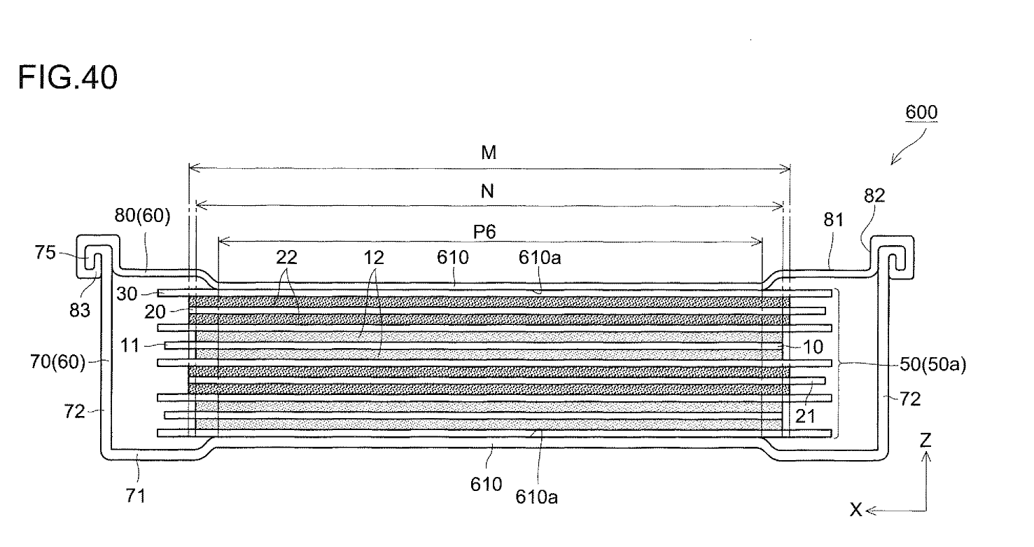

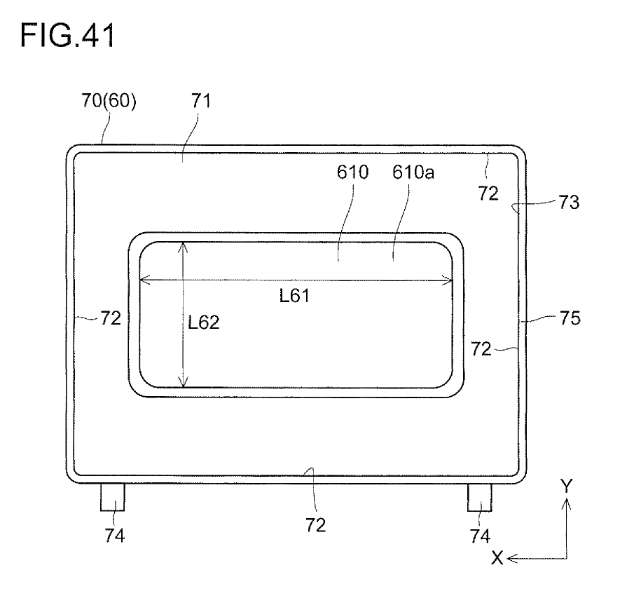

FIG. 37 is an exploded perspective view of a lithium-ion secondary battery according to a sixth embodiment (Embodiment 6) of the invention. FIG. 38 is a plan view of the lithium-ion secondary battery according to Embodiment 6 of the invention. FIGS. 39 to 41 are diagrams in illustration of the lithium-ion secondary battery according to Embodiment 6 of the invention. FIG. 39 shows a section cut along line A6-A6 in FIG. 38, and FIG. 40 shows a section cut along line B6-B6 in FIG. 38. FIG. 41 is a plan view of the package can 70 in the lithium-ion secondary battery according to Embodiment 6. Next, with reference to FIGS. 7, 9, and 37 to 41, the lithium-ion secondary battery 600 according to Embodiment 6 of the invention will be described. Among the different diagrams, the same components are identified by the same reference signs, and no overlapping description will be repeated unless necessary.

In the lithium-ion secondary battery 600 according to Embodiment 6, as shown in FIG. 37, on the basis of the structure of Embodiment 3 described previously, the protruding portions on the package can 70 are given a smaller Y-direction length.

Specifically, in Embodiment 6, as shown in FIGS. 37 and 38, as in Embodiment 3, two protruding portions 310 are formed on the panel portion 81 of the lid plate 80. On the other hand, one protruding portion 610 is formed on the bottom face portion 71 and package can 70 integrally therewith so as to protrude toward the electrode assembly 50. The protruding portion 610 formed on the package can 70 is an example of a “second protruding portion” according to the invention.

Moreover, the protruding portion 610 on the package can 70 has a substantially flat pressing surface 610a. As shown in FIG. 41, the pressing surface 610a is formed in a substantially rectangular shape as seen in a plan view, and has a Y-direction length L62 smaller than that in Embodiment 3 described previously. The protruding portion 610 on the package can 70 has an X-direction length L61 substantially equal to that of the protruding portions 310 formed on the lid plate 80.

Moreover, in Embodiment 6, as shown in FIG. 39, the protruding portion 610 is given a Y-direction length L62 greater than the distance L5 at which the two protruding portions 310 on the lid plate 80 are apart from each other. Thus, when the lid plate 80 is fitted to the package can 70, parts of the protruding portions 310 on the lid plate 80 face parts of the protruding portion 610 on the package can 70. That is, in the lithium-ion secondary battery 600 according to Embodiment 6, at least parts of the protruding portions 310 overlap (face) parts of the protruding portion 610 as seen in a plan view.

Furthermore, in Embodiment 6, as in Embodiments 1 to 5 described previously, the protruding portions 310 (pressing surfaces 310a) formed on the lid plate 80 and the protruding portion 610 (pressing surface 610a) formed on the package can 70 press the electrode assembly 50 in the stack direction (Z direction). Thereby, as shown in FIGS. 39 and 40, a pressing force is applied within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 6, the region P6 in which the protruding portions 310 and 410 apply a pressing force is located inside the formation region M of the negative electrode active material layer 22 and inside the formation region N of the positive electrode active material layer 12.

In other respects, the structure of Embodiment 6 is similar to those of Embodiments 1 to 5 described previously.

In other respects, the benefits of Embodiment 6 are similar to those of Embodiments 1 to 5 described previously.

### Embodiment 7

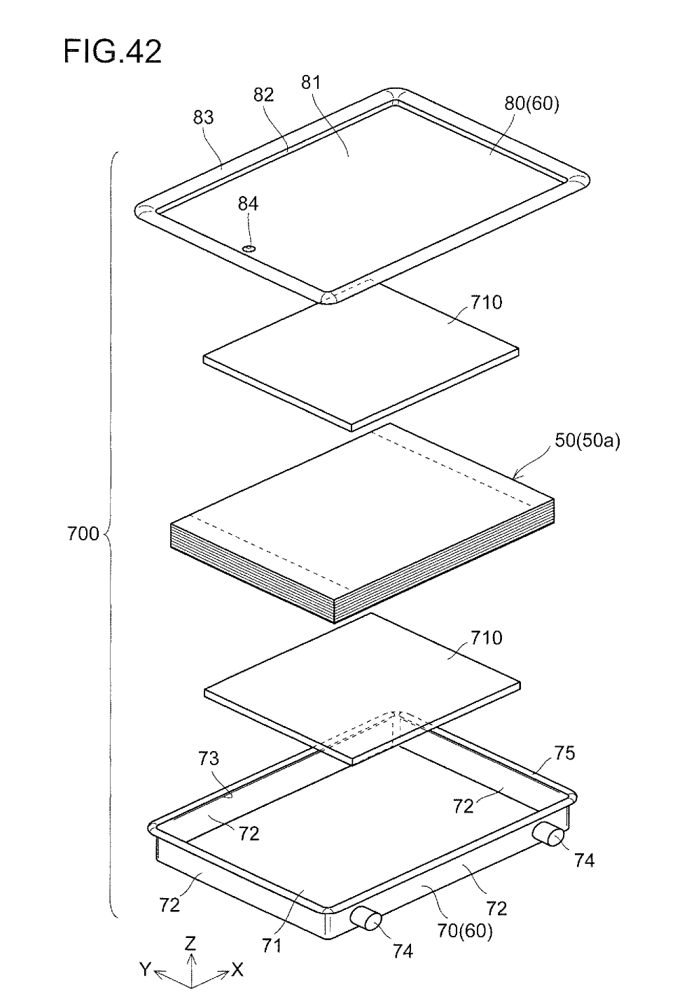

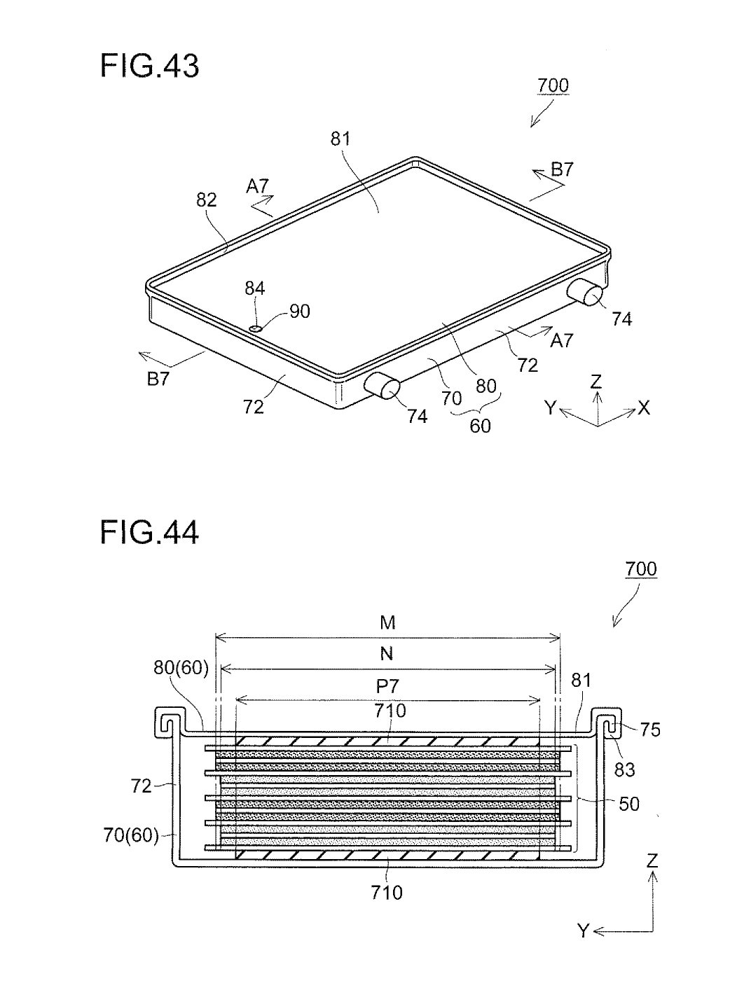

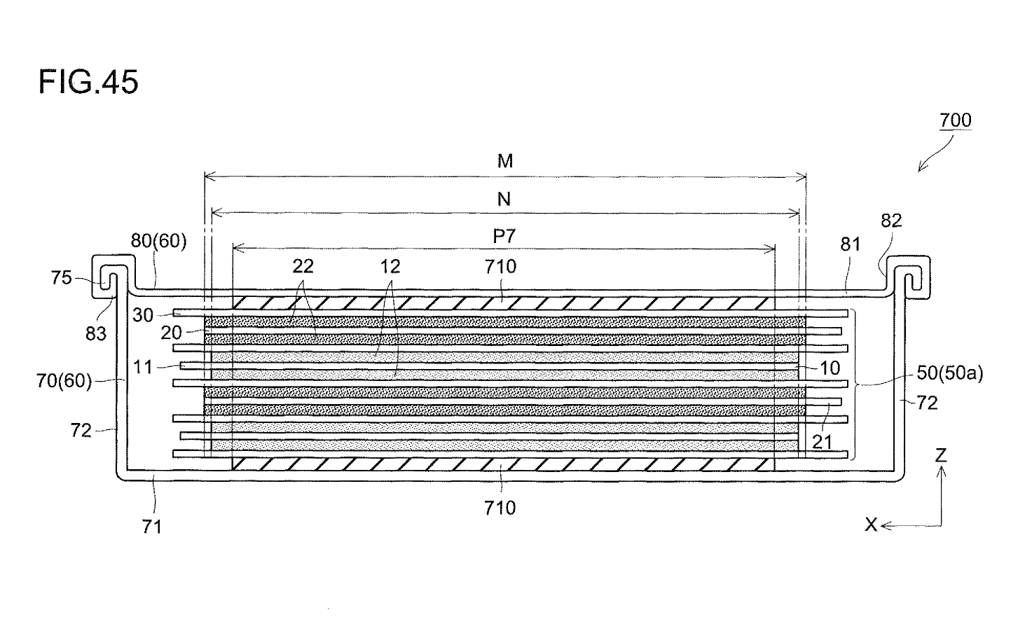

FIG. 42 is an exploded perspective view of a lithium-ion secondary battery according to a seventh embodiment (Embodiment 7) of the invention. FIG. 43 is an overall perspective view of the lithium-ion secondary battery according to Embodiment 7 of the invention. FIGS. 44 and 45 are sectional views of the lithium-ion secondary battery according to Embodiment 7 of the invention. FIG. 44 shows a section cut along line A7-A7 in FIG. 43, and FIG. 45 shows a section along line B7-B7 in FIG. 43. Next, with reference to FIGS. 7, 9, 13, and 42 to 45, the lithium-ion secondary battery 700 according to Embodiment 7 of the invention will be described. Among the different diagrams, the same components are identified by the same reference signs, and no overlapping description will be repeated unless necessary.

The lithium-ion secondary battery 700 according to Embodiment 7 differs from those of Embodiments 1 to 6 described previously in that, as shown in FIGS. 42 and 43, no protruding portion is formed on either the lid plate 80 or the package can 70.

Instead, in Embodiment 7, as shown in FIGS. 42, 44, and 45, plate-shaped or sheet-shaped pressing members 710 are arranged, respectively, between the electrode assembly 50 and the lid plate 80 and between the electrode assembly 50 and the bottom face portion 71 of the package can 70. The pressing members 710 has a substantially rectangular shape, and are formed so as to be smaller in size than the positive electrode active material layer 12. That is, in Embodiment 7, the pressing members 710 are formed in such a size as to fit within an inward region 15 of the positive electrode active material layer 12 a distance “a” away from (inward of) the edges thereof shown in FIG. 7 and within an inward region 25 of the negative electrode active material layer 22 a distance “b” away from (inward of) the edges thereof shown in FIG. 9. Specifically, the pressing members 710 are formed, for example, in a shape substantially identical with that of the pressing surface 85a (see FIG. 13) of the protruding portion 85 in Embodiment 1 described previously.

In the lithium-ion secondary battery 700 according to Embodiment 7 structured as described above, via the pressing members 710, the electrode assembly 50 is pressed in the stack direction (Z direction). Thus, the pressing members 710 apply a pressing force within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 7, the region P7 in which the pressing force is applied via the pressing members 710 is located inside the formation region M of the negative electrode active material layer 22 and inside the formation region N of the positive electrode active material layer 12.

In the Embodiment 7, the thickness of the pressing members 710 is adjusted so that a predetermined pressing force is applied to the electrode assembly 50. Specifically, the pressing members 710 are given a thickness of, for example, about 1 mm. The pressing members 710 may be formed of, for example, an insulating material such as a high-polymer material. Usable as such an insulating material are, for example, resin materials resistant to electrolyte liquids, such as polyethylene, polypropylene, polyphenylene sulfide.

As described above, in Embodiment 7, by arranging pressing members 710, respectively, between the electrode assembly 50 (positive and negative electrodes) and the lid plate 80 and between the electrode assembly 50 (positive and negative electrodes) and the bottom face portion 71 of the package can 70, it is possible to easily apply a pressing force via the pressing members 710 to the region 15 (see FIG. 7) of the positive electrode active material layer 12 and the region 25 (see FIG. 9) of the negative electrode active material layer 22 excluding the four edge portions 14 (see FIG. 7) of the positive electrode 10 and the four edge portions 24 (see FIG. 9) of the negative electrode 20.

Moreover, in Embodiment 7, by forming the pressing members 710 out of an insulating material, it is possible to prevent short-circuiting between the package container 60 and the electrode assembly 50.

The pressing members 710 may be previously fixed to the lid plate 80 and the bottom face portion 71 of the package can 70. Previously fixing the pressing members 710 to the lid plate 80 and the bottom face portion 71 of the package can 70 in this way helps prevent displacement of the pressing members 710. Thus, it is then possible to more easily apply a pressing force within the region 15 (see FIG. 7) of the positive electrode active material layer 12 and within the region 25 (see FIG. 9) of the negative electrode active material layer 22.

Moreover, the pressing members 710 may be formed of a resin material that swells when soaked (becomes imbued) with a non-aqueous electrolyte liquid. In that case, as the non-aqueous electrolyte liquid is injected, the pressing members 710 swells by being soaked with it. Thus, the increase in thickness resulting from the swelling needs to be taken into consideration when the thickness of the pressing members 710 is determined so that a predetermined pressing force is applied to the electrode assembly 50. Usable as a resin material that swells when soaked with a non-aqueous electrolyte liquid are, for example, nitrile butadiene rubber (NBR), styrene butadiene rubber (SBR), carboxymethyl cellulose (CMC), polyvinylidene fluoride (PVdF), polyvinyl alcohol (PVA), polyethylene oxide (PEO), and propylene oxide. Resin materials that contain one or more of these materials may also be used.

In other respects, the benefits of Embodiment 7 are similar to those of Embodiments 1 and 2 described previously.

### Embodiment 8

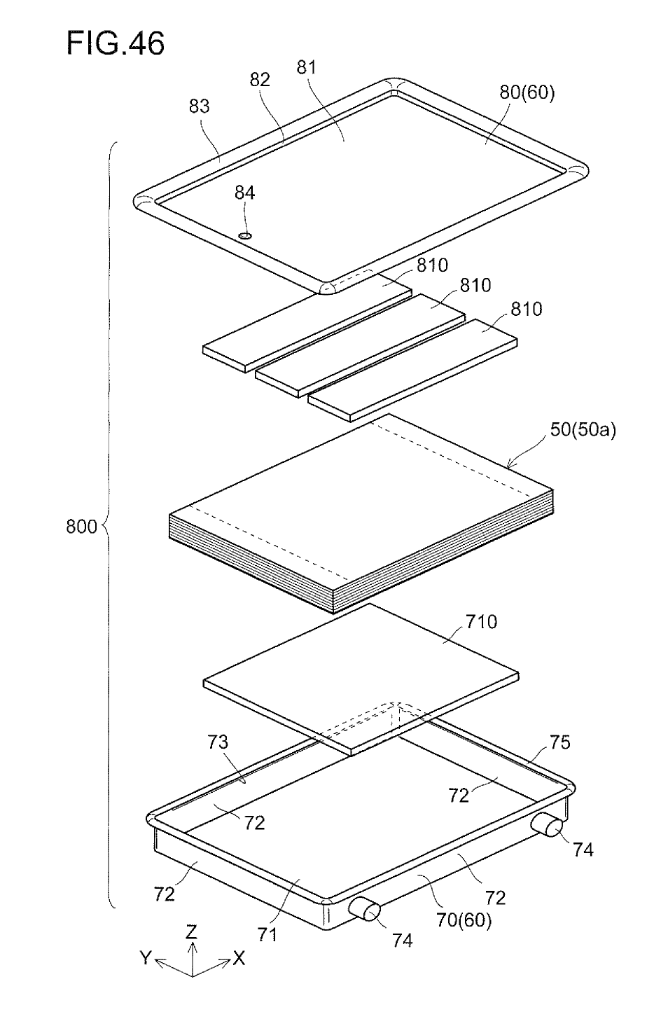

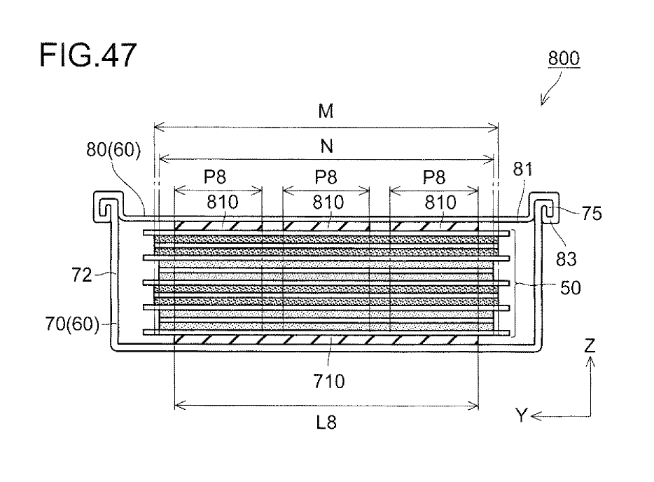

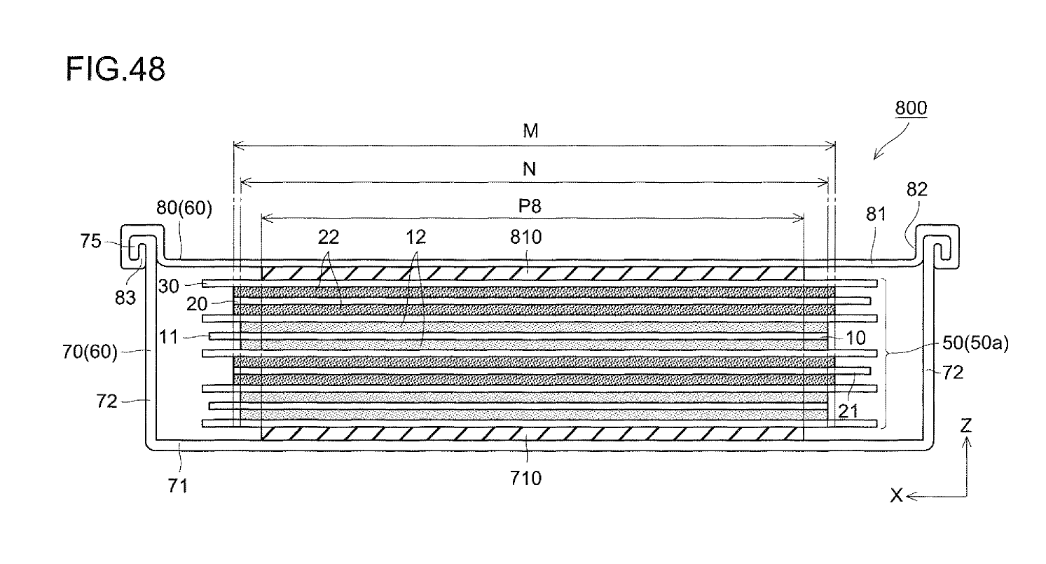

FIG. 46 is an exploded perspective view of a lithium-ion secondary battery according to an eighth embodiment (Embodiment 8) of the invention. FIGS. 47 and 48 are sectional views of the lithium-ion secondary battery according to Embodiment 8 of the invention. FIG. 47 shows a section corresponding to FIG. 44 in Embodiment 7 described previously, and FIG. 48 shows a section corresponding to FIG. 45 of Embodiment 7 described previously. Next, with reference to FIGS. 7, 9, and 46 to 48, the lithium-ion secondary battery 800 according to Embodiment 8 of the invention will be described. Among the different diagrams, the same components are identified by the same reference signs, and no overlapping description will be repeated unless necessary.

In the lithium-ion secondary battery 800 according to Embodiment 8, as shown in FIGS. 46 to 48, between the electrode assembly 50 and the lid plate 80, there are arranged a plurality of (three) pressing members 810 having a substantially rectangular shape. That is, in Embodiment 8, on the basis of the structure of Embodiment 7 described previously, the pressing member arranged between the electrode assembly 50 and the lid plate 80 are divided into a plurality of segments.

Moreover, the pressing members 810 arranged between the electrode assembly 50 and the lid plate 80 are formed to have an X-direction length substantially equal to that of the pressing members 710 arranged between the electrode assembly 50 and the bottom face portion 71 of the package can 70. Moreover, the three pressing members 810 arranged between the electrode assembly 50 and the lid plate 80 are arranged at predetermined intervals from one another in the Y direction. And, as shown in FIG. 47, the three pressing members 810 arranged at the predetermined intervals are given an Y-direction length L8 substantially equal to the Y-direction length of the pressing members 710.

In the lithium-ion secondary battery 800 according to Embodiment 8 structured as described above, as in Embodiment 7 described previously, via the pressing members 810 and 710, the electrode assembly 50 is pressed in the stack direction (Z direction), so that the pressing members 810 and 710 apply a pressing force within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, in Embodiment 8, as in Embodiment 7 described previously, the region P8 in which the pressing force is applied via the pressing members 810 is located inside the formation region M of the negative electrode active material layer 22 and inside the formation region N of the positive electrode active material layer 12.

In other respects, the structure of Embodiment 8 is similar to that of Embodiment 7 described previously.

In other respects, the benefits of Embodiment 8 are similar to those of Embodiment 7 described previously.

Also in Embodiment 8, as in Embodiment 7 described previously, the pressing members 710 and 810 may be formed of a resin material that swells when soaked with a non-aqueous electrolyte liquid.

### Embodiment 9

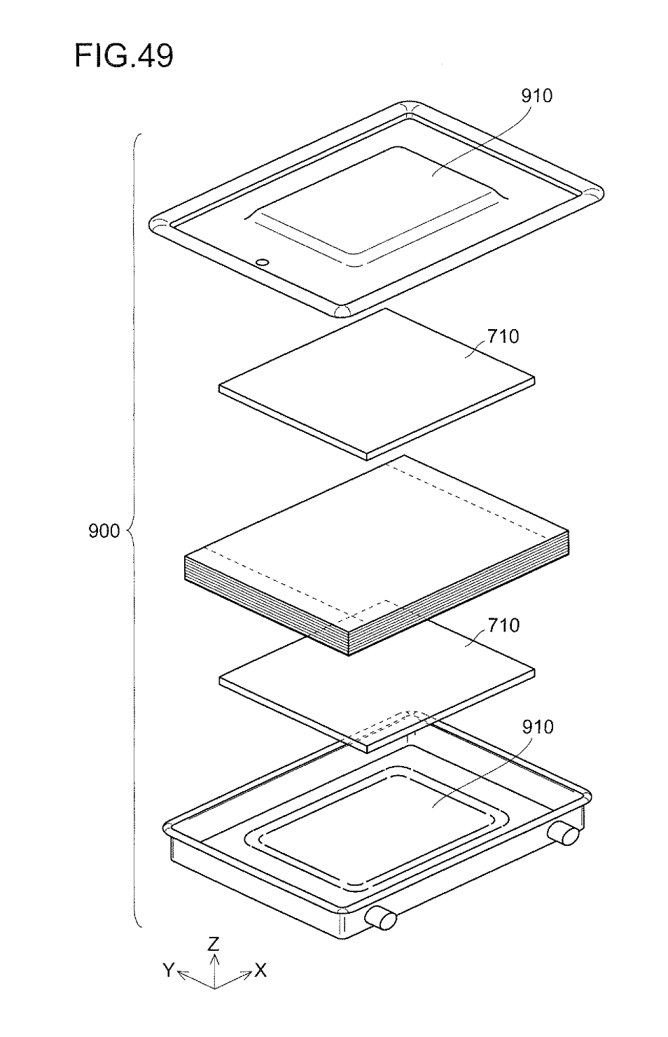

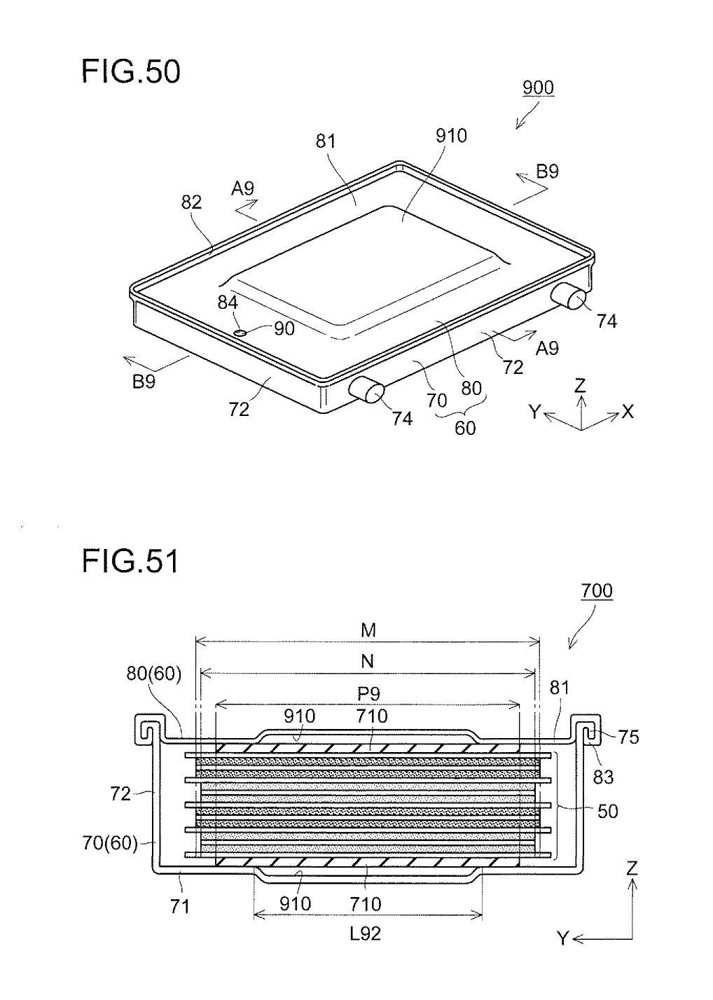

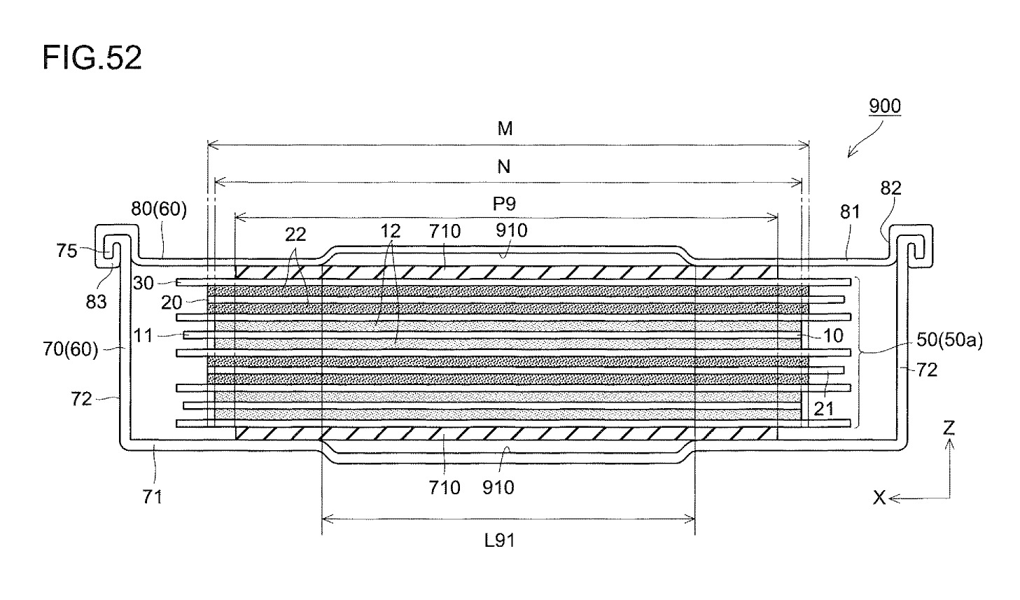

FIG. 49 is an exploded perspective view of a lithium-ion secondary battery according to a ninth embodiment (Embodiment 9) of the invention. FIG. 50 is an overall perspective view of the lithium-ion secondary battery according to Embodiment 9 of the invention. FIGS. 51 and 52 are sectional views of the lithium-ion secondary battery according to Embodiment 9 of the invention. FIG. 51 shows a section cut along line A9-A9 in FIG. 50, and FIG. 52 shows a section along line B9-B9 in FIG. 50. Next, with reference to FIGS. 7, 9, and 49 to 52, the lithium-ion secondary battery 900 according to Embodiment 9 of the invention will be described. Among the different diagrams, the same components are identified by the same reference signs, and no overlapping description will be repeated unless necessary.

In the lithium-ion secondary battery 900 according to Embodiment 9, as shown in FIGS. 49 and 50, on the basis of the structure of Embodiment 7 described previously, groove portions 910 are further formed in the panel portion 81 of the lid plate 80 and the bottom face portion 71 of the package can 70, for increased torsional rigidity and the like.

The groove portions 910 formed in the lid plate 80 and the package can 70 are so formed as to be concave toward the inside of the battery. Thus, on the outside of the lid plate 80 and the package can 70, the formation of the groove portions 910 results in part of the panel portion 81 and part of the bottom face portion 71 protruding outward.

Moreover, as shown in FIGS. 51 and 52, in Embodiment 9, as in Embodiment 7 described previously, via the pressing members 710, the electrode assembly 50 is pressed in the stack direction (Z direction). Thereby the pressing members 710 apply a pressing force within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Thus, also in Embodiment 9, the region P9 in which the pressing force is applied via the pressing members 710 is located inside the formation region M of the negative electrode active material layer 22 and inside the formation region N of the positive electrode active material layer 12.

In Embodiment 9, the groove portions 910 are formed to have an X-direction length L91 smaller than that of the pressing members 710 and a Y-direction length L92 likewise smaller than that of the pressing members 710.

In other respects, the structure of Embodiment 9 is similar to that of Embodiment 7 described previously.

In other respects, the benefits of Embodiment 9 are similar to those of Embodiment 7 described previously.

### Embodiment 10

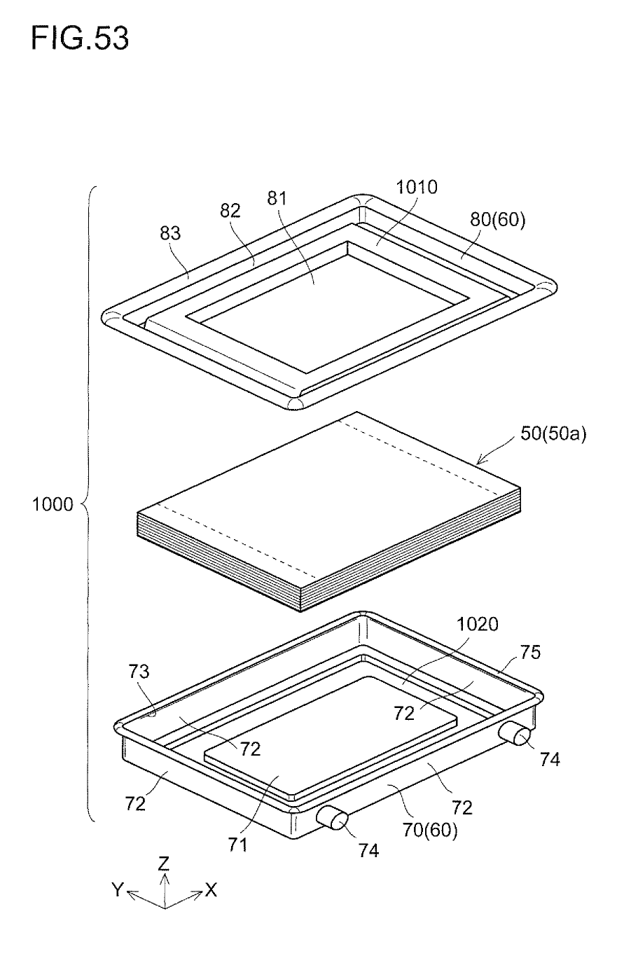

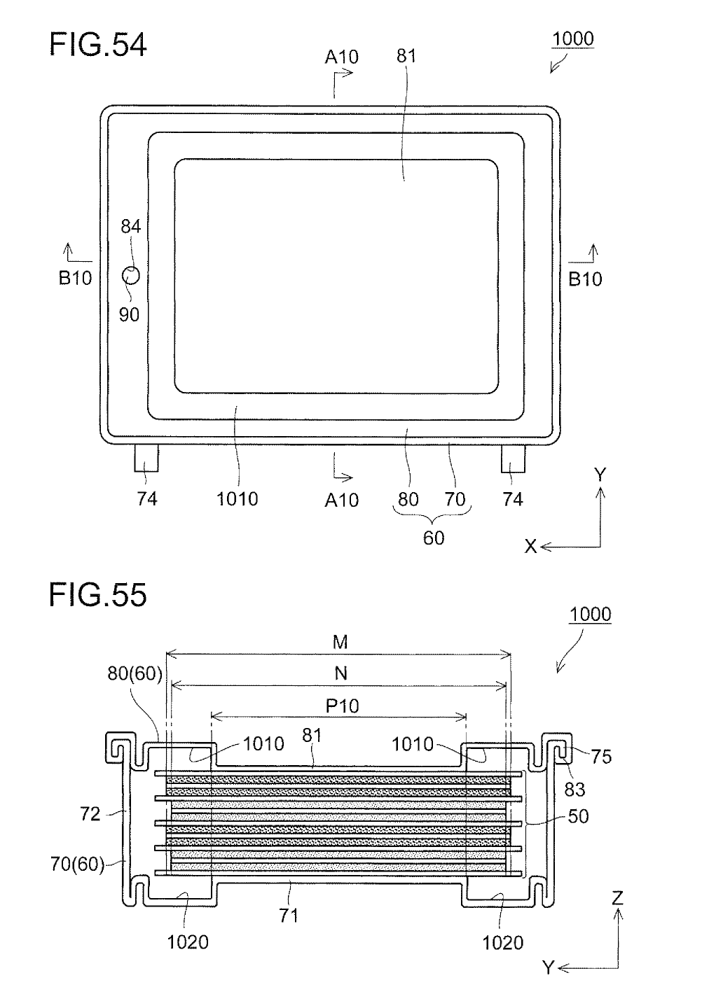

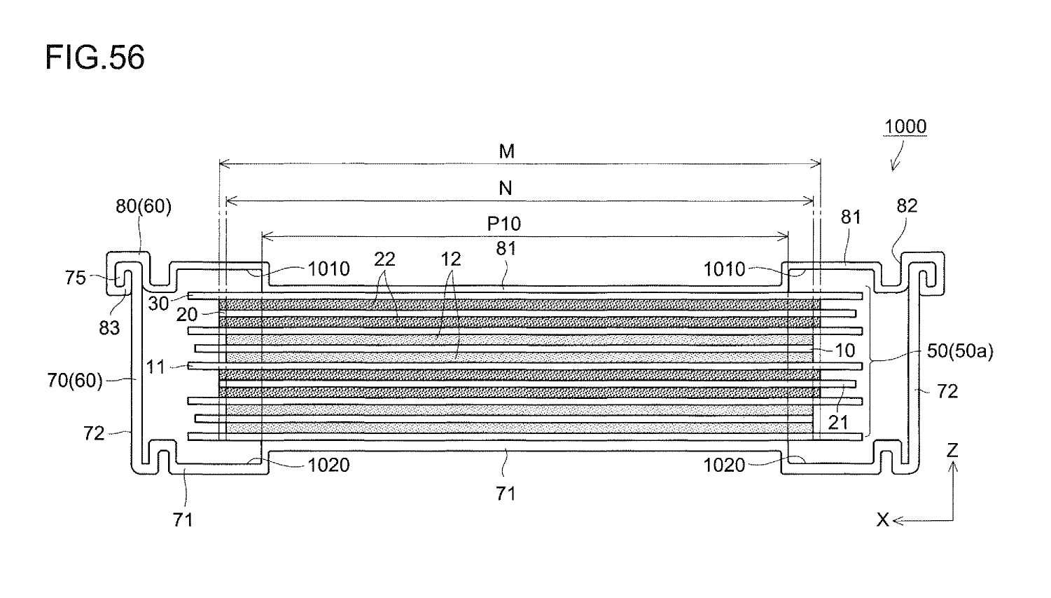

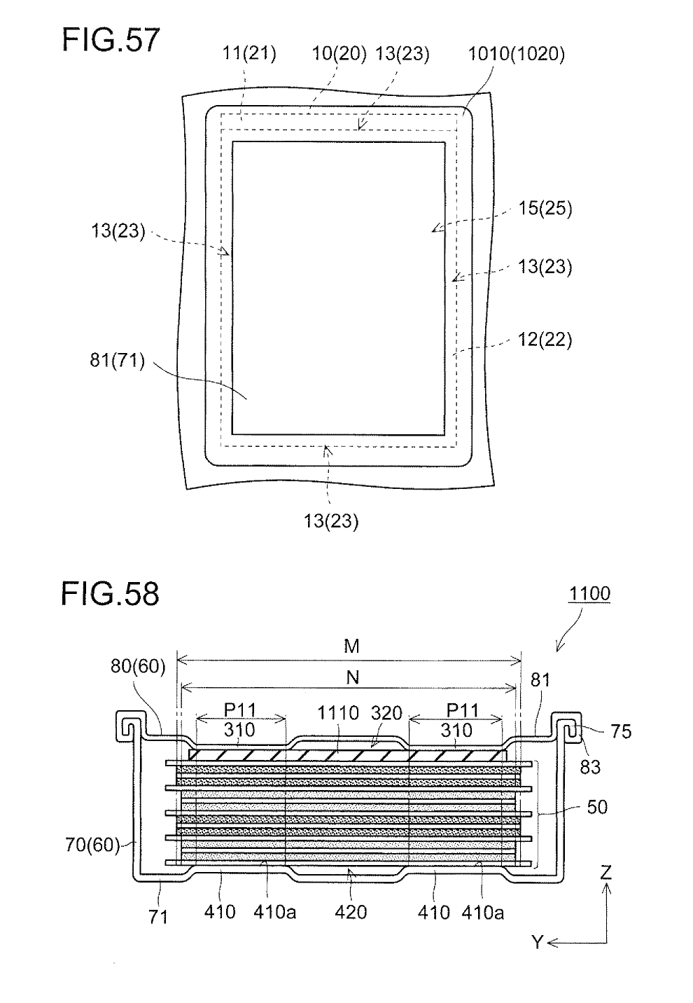

FIG. 53 is an exploded perspective view of a lithium-ion secondary battery according to a tenth embodiment (Embodiment 10) of the invention. FIG. 54 is a plan view of the lithium-ion secondary battery according to Embodiment 10 of the invention. FIG. 55 is a sectional view of the lithium-ion secondary battery according to Embodiment 10 of the invention, showing a section cut along line B10-B10 in FIG. 54. FIGS. 56 to 57 are diagrams in illustration of the lithium-ion secondary battery according to Embodiment 10 of the invention. Next, with reference to FIGS. 7, 9, and 53 to 57, the lithium-ion secondary battery 1000 according to Embodiment 10 of the invention will be described. Among the different diagrams, the same components are identified by the same reference signs, and no overlapping description will be repeated unless necessary.

In the lithium-ion secondary battery 1000 according to Embodiment 10, as shown in FIGS. 53 and 54, in the lid plate 80 and the package can 70, receding portions 1010 and 1020, respectively, are formed for preventing a pressing force from being applied to the four edge portions 13 (see FIG. 7) of the positive electrode active material layer 12 (see FIG. 7) and the four edge portions 23 (see FIG. 9) of the positive electrode active material layer 22 (see FIG. 9). The receding portion 1010 in the lid plate 80 is an example of a “first receding portion” according to the invention, and the receding portion 1020 in the package can 70 is an example of a “second receding portion” according to the invention.

The receding portion 1010 formed in the lid plate 80 is so formed that the lid plate 80 is concave toward the inside of the battery, and the receding portion 1020 formed in the package can 70 is so formed that the bottom face portion 71 of the package can 70 is concave toward the inside of the battery. Thus, on the outside of the lid plate 80, the formation of the receding portion 1010 results in part of the panel portion 81 protruding outward. Likewise, on the outside of the bottom face portion 71 of the package can 70, the formation of the receding portion 1020 results in part of the bottom face portion 71 protruding outward.

Moreover, as shown in FIGS. 53 and 57, the receding portions 1010 and 1020 are formed in the shape of frames as seen in a plan view so as to cover the four edge portions 13 (see FIG. 7) of the positive electrode active material layer 12 (see FIG. 7) and the four edge portions 23 (see FIG. 9) of the positive electrode active material layer 22 (see FIG. 9).

Furthermore, in the lithium-ion secondary battery 1000 according to Embodiment 10, as shown in FIGS. 55 and 56, the panel portion 81 of the lid plate 80 and the bottom face portion 71 of the package can 70 press the electrode assembly 50 in the stack direction (Z direction). Here, the receding portions 1010 and 1020 prevent a pressing force from being applied to the four edge portions 13 (see FIG. 7) of the positive electrode active material layer 12 (see FIG. 7) and the four edge portions 23 (see FIG. 9) of the positive electrode active material layer 22 (see FIG. 9). Thus, a pressing force is applied within the region 15 (see FIG. 7) of the positive electrode active material layer 12 and the region 25 (see FIG. 9) of the negative electrode active material layer 22 excluding the four edge portions 13 (see FIG. 7) of the positive electrode active material layer 12 (see FIG. 7) and the four edge portions 23 (see FIG. 9) of the negative electrode active material layer 22 (see FIG. 9). Accordingly, also in Embodiment 10, the region P10 in which the lid plate 80 and the package can 70 apply the pressing force is located inside the formation region M of the negative electrode active material layer 22 and inside the formation region N of the positive electrode active material layer 12.

In other respects, the structure of Embodiment 10 is similar to those of Embodiments 1 and 2 described previously.

In other respects, the benefits of Embodiment 10 are similar to those of Embodiments 1 and 2 described previously.

### Embodiment 11

FIG. 58 is a sectional view of a lithium-ion secondary battery according to an eleventh embodiment (Embodiment 11) of the invention. FIG. 58 shows a section corresponding to FIG. 55 of Embodiment 5 described previously. Next, with reference to FIGS. 42 and 55, the lithium-ion secondary battery 1100 according to Embodiment 11 of the invention will be described. Among the different diagrams, the same components are identified by the same reference signs, and no overlapping description will be repeated unless necessary.

In the lithium-ion secondary battery 1100 according to Embodiment 11, as shown in FIG. 58, on the basis of the structure of Embodiment 5 described previously, a resin member 1110 similar to the pressing members 710 (see FIG. 42) in Embodiment 7 described previously is additionally interposed between the lid plate 80 and the electrode assembly 50. In other respects, the structure of Embodiment 11 is similar to that of Embodiment 5 described previously.

In Embodiment 11, by interposing the resin member 1110 between the lid plate 80 and the electrode assembly 50 as described above, it is possible to effectively prevent electrical short-circuiting between the lid plate 80 and the electrode assembly 50.

In other respects, the benefits of Embodiment 11 are similar to those of Embodiment 5 described previously. Also in Embodiment 11, as in Embodiments 7 and 8 described previously, the resin member 1110 may be formed of a resin material that swells when soaked with a non-aqueous electrolyte liquid.

### Embodiment 12

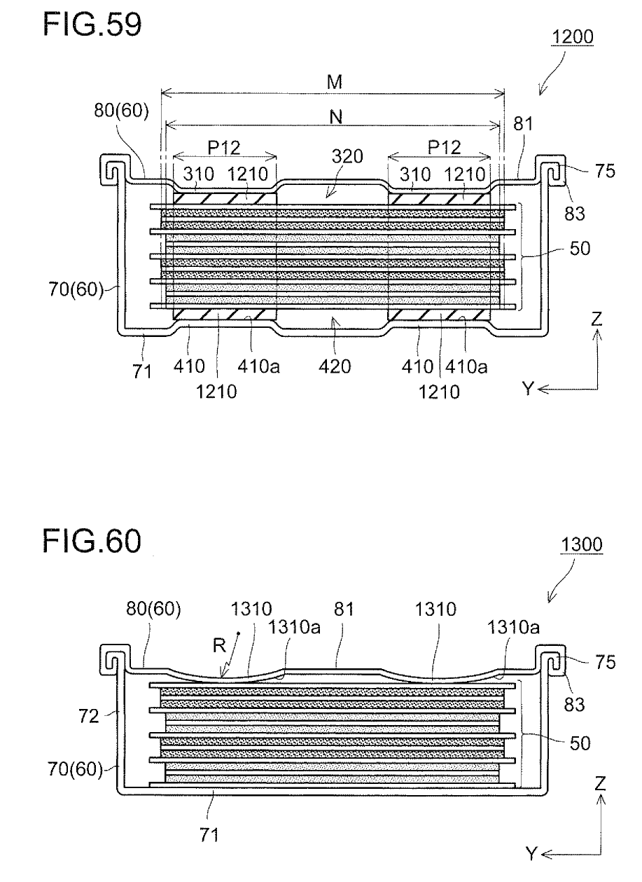

FIG. 59 is a sectional view of a lithium-ion secondary battery according to a twelfth embodiment (Embodiment 12) of the invention. FIG. 59 shows a section corresponding to FIG. 55 of Embodiment 5 described previously. Next, with reference to FIGS. 7, 9, and 59, the lithium-ion secondary battery 1200 according to Embodiment 12 of the invention will be described. Among the different diagrams, the same components are identified by the same reference signs, and no overlapping description will be repeated unless necessary.

In the lithium-ion secondary battery 1200 according to Embodiment 12, as shown in FIG. 59, on the basis of the structure of Embodiment 5 described previously, strip-shaped resin members 1210 are additionally interposed between the lid plate 80 (protruding portions 310) and the electrode assembly 50 and between the bottom face portion 71 (protruding portions 410) of the package can 70 and the electrode assembly 50. The resin members 1210 are formed of an insulating resin material similar to that used in Embodiment 11 described previously. Via these resin members 1210, a pressing force is applied to the electrode assembly 50.

The resin members 1210 are arranged so as to be located within the region 15 (see FIG. 7) of the positive electrode active material layer 12 and the region 25 (see FIG. 9) of the negative electrode active material layer 22. Thus, the region P12 in which the pressing force is applied via the resin members 1210 is located inside the formation region M of the negative electrode active material layer 22 and inside the formation region N of the positive electrode active material layer 12.

In other respects, the structure of Embodiment 12 is similar to that of Embodiment 5 described previously.

In other respects, the benefits of Embodiment 12 are similar to those of Embodiment 5 described previously. Also in Embodiment 12, as in Embodiments 7 and 8 described previously, the resin members 1210 may be fanned of a resin material that swells when soaked with a non-aqueous electrolyte liquid.

### Embodiment 13

FIG. 60 is a sectional view of a lithium-ion secondary battery according to a thirteenth embodiment (Embodiment 13) of the invention. Next, with reference to FIG. 60, the lithium-ion secondary battery 1300 according to Embodiment 13 of the invention will be described. Among the different diagrams, the same components are identified by the same reference signs, and no overlapping description will be repeated unless necessary.

In the lithium-ion secondary battery 1300 according to Embodiment 13, as shown in FIG. 60, protruding portions 1310 similar to those in Embodiment 3 described previously are formed on the panel portion 81 of the lid plate 80. A difference is that, in Embodiment 13, the protruding portions 1310 has curved pressing surfaces 1310a. That is, in Embodiment 13, the electrode assembly 50 is pressed with curved surfaces.

If the pressing surfaces 1310a of the protruding portions 1310 have too small a radius of curvature R, they may cause internal short-circuiting or degrade life characteristics. To avoid that, it is preferable that the protruding portions 1310 be given a radius of curvature R of about 100 to about 500.

Even with the structure described above where a pressing force is applied to the electrode assembly 50 with a curved pressing surface 1310a, it is possible to obtain the effects of improving life characteristics and preventing internal short-circuiting as in Embodiments 1 to 12. The protruding portions 1310 are an example of a “first protruding portion” according to the invention.

The invention will now be described by way of practical examples. It should be understood that these practical examples are in no way meant to limit the scope of the invention.

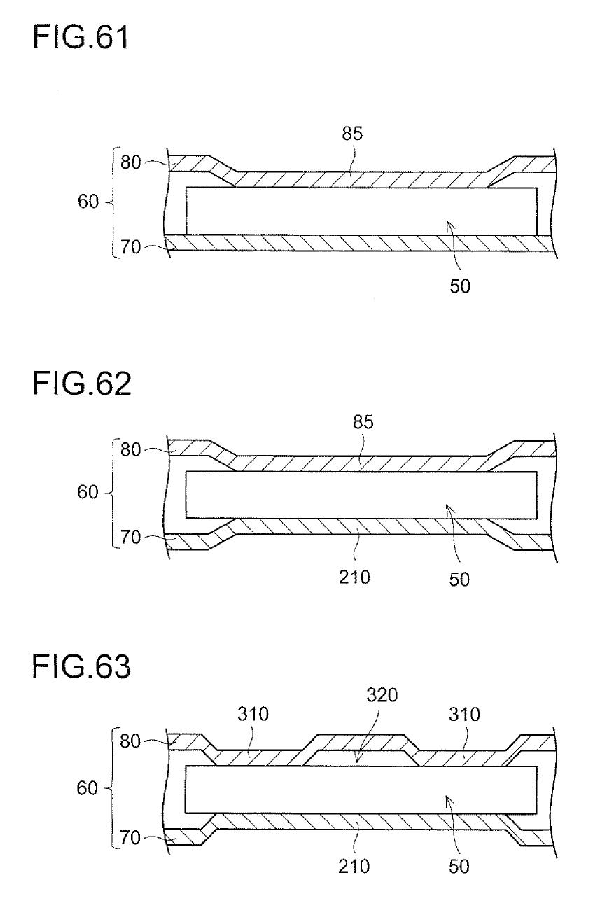

Fabricated were lithium-ion secondary batteries of Practical Examples 1 to 13, which correspond to Embodiments 1 to 13, respectively, described above, and lithium-ion secondary batteries of Comparative Examples 1 to 3. FIGS. 61 to 73 are partial sectional views showing the lithium-ion secondary batteries of Practical Examples 1 to 13, respectively, in simplified form. FIGS. 74 to 76 are partial sectional views showing the lithium-ion secondary batteries of Comparative Examples 1 to 3, respectively, in simplified form.

### PRACTICAL EXAMPLE 1

In Practical Example 1, as shown in FIG. 61, a protruding portion 85 for pressing the electrode assembly 50 was formed on the lid plate 80 such that the area over which a pressing force was applied was 99% of the application area of the positive electrode active material layer.

### PRACTICAL EXAMPLE 2

In Practical Example 2, as shown in FIG. 62, protruding portions 85 and 210 for pressing the electrode assembly 50 were formed on the lid plate 80 and the package can 70 such that the area over which a pressing force was applied was 98% of the application area of the positive electrode active material layer.

### PRACTICAL EXAMPLE 3

In Practical Example 3, as shown in FIG. 63, two protruding portions 310 were formed on the lid plate 80 such that the area over which a pressing force was applied was 66% of the application area of the positive electrode active material layer.

### PRACTICAL EXAMPLE 4

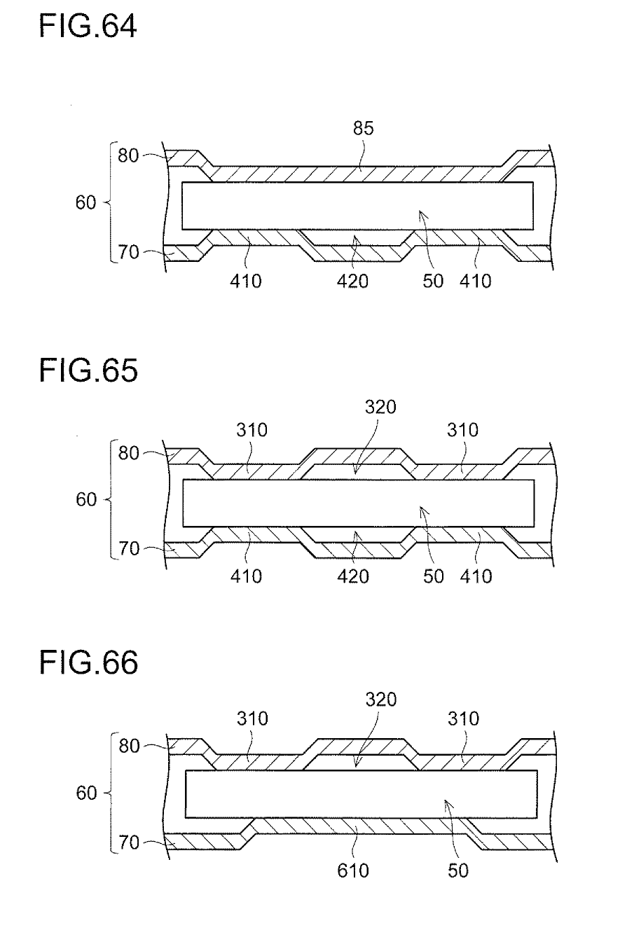

In Practical Example 4, as shown in FIG. 64, two protruding portions 410 were formed on the bottom face portion of the package can 70 such that the area over which a pressing force was applied was 66% of the application area of the positive electrode active material layer.

### PRACTICAL EXAMPLE 5

In Practical Example 5, as shown in FIG. 65, two protruding portions 310 were formed on the lid plate 80 and two protruding portions 410 were formed also on the bottom face portion of the package can 70 such that the area over which a pressing force was applied was 66% of the application area of the positive electrode active material layer.

### PRACTICAL EXAMPLE 6

In Practical Example 6, as shown in FIG. 66, protruding portions were formed so that parts of protruding portions 310 on the lid plate 80 face parts of a protruding portion 610 on the package can 70, such that the area over which a pressing force was applied was 20% of the application area of the positive electrode active material layer.

### PRACTICAL EXAMPLE 7

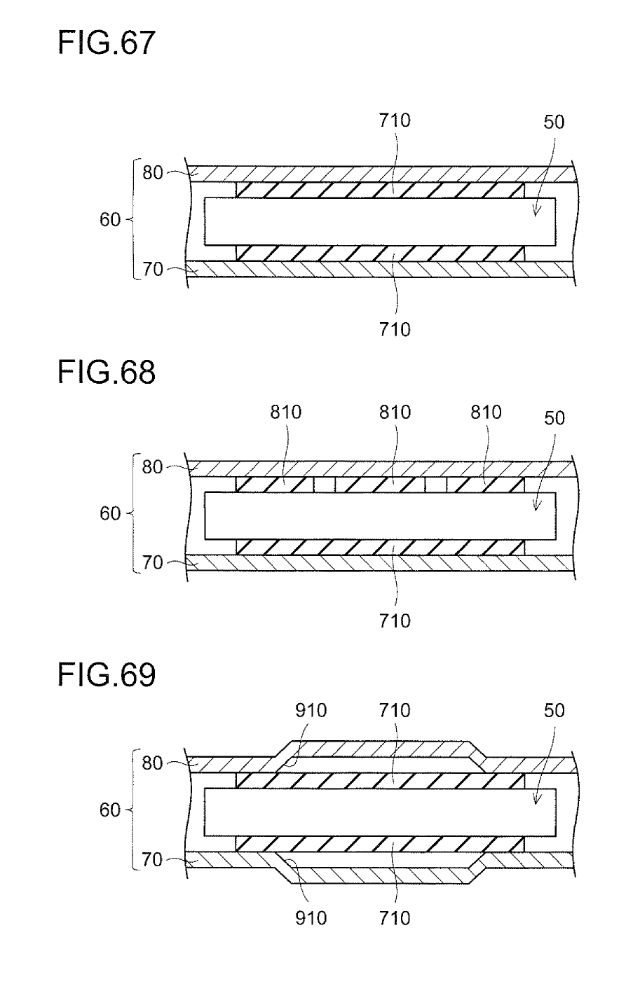

In Practical Example 7, as shown in FIG. 67, no protruding portion was formed on either the lid plate 80 or the package can 70; instead, pressing members 710 were arranged between the electrode assembly 50 and the lid plate 80 and between the electrode assembly 50 and the package can 70 such that the area over which a pressing force was applied was 98% of the application area of the positive electrode active material layer.

### PRACTICAL EXAMPLE 8

In Practical Example 8, as shown in FIG. 68, three pressing members 810 in separate segments are arranged between the electrode assembly 50 and the lid plate 80 such that the area over which a pressing force was applied was 75% of the application area of the positive electrode active material layer.

### PRACTICAL EXAMPLE 9

In Practical Example 9, as shown in FIG. 69, pressing members 710 were arranged between the electrode assembly 50 and the lid plate 80 and between the electrode assembly 50 and the package can 70 such that the area over which a pressing force was applied was 90% of the application area of the positive electrode active material layer. In addition, in Practical Example 9, groove portions 910 were formed in the lid plate 80 and the package can 70 respectively.

### PRACTICAL EXAMPLE 10

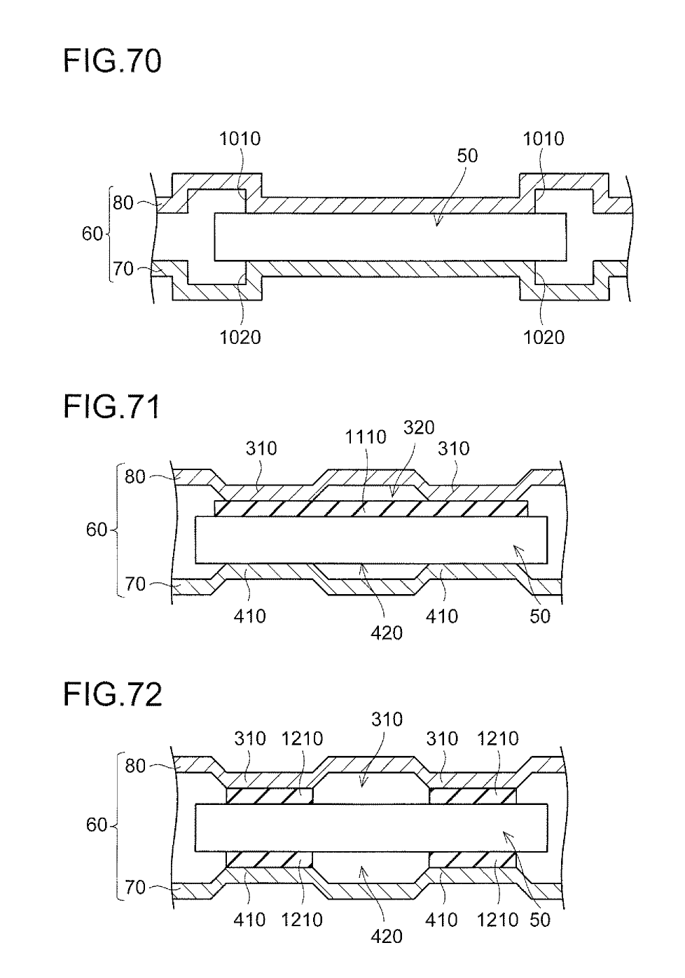

In Practical Example 10, as shown in. FIG. 70, receding portions 1010 and 1020 were formed in the lid plate 80 and the package can 70 such that the area over which a pressing force was applied was 80% of the application area of the positive electrode active material layer.

### PRACTICAL EXAMPLE 11

In Practical Example 11, as shown in FIG. 71, on the basis of the structure of Practical. Example 5 presented above, a resin member 1110 was further arranged between the electrode assembly 50 and the lid plate 80. A difference from Practical Example 5 presented above was that, in Practical Example 11, the area over which a pressing force was applied was 40% of the application area of the positive electrode active material layer.

### PRACTICAL EXAMPLE 12

In Practical Example 12, as shown in FIG. 72, on the basis of the structure of Practical Example 5 presented above, resin members 1210 were further arranged, respectively, between the electrode assembly 50 and the protruding portions 310 on the lid plate 80 and between the electrode assembly 50 and the protruding portions 410 on the package can 70. A difference from Practical Examples 5 and 11 presented above was that, in Practical Example 12, the area over which a pressing force was applied was 20% of the application area of the positive electrode active material layer.

### PRACTICAL EXAMPLE 13

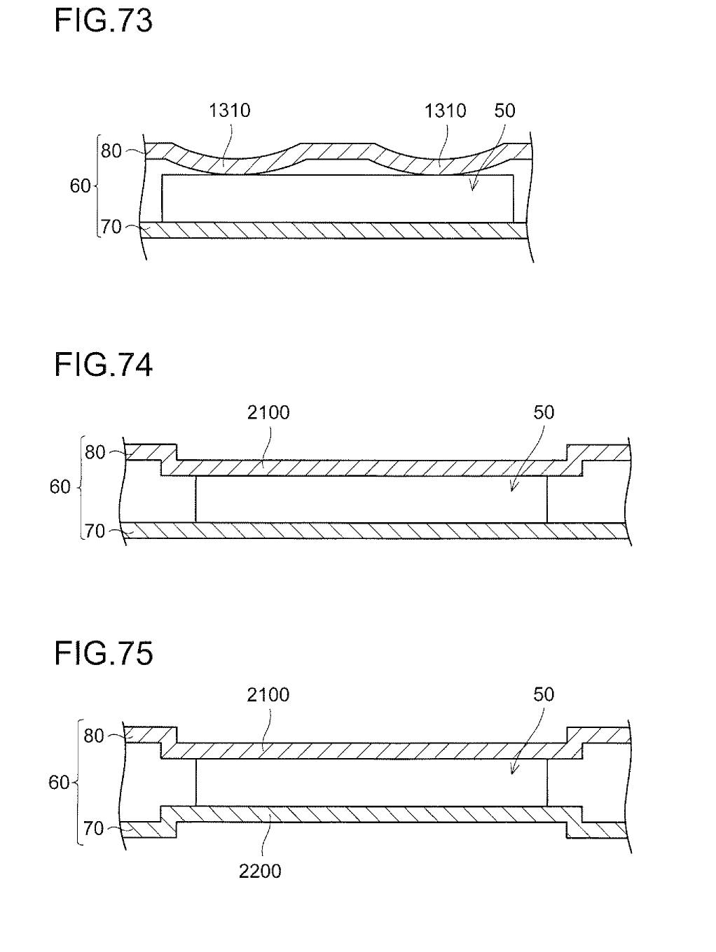

In Practical Example 13, as shown in FIG. 73, protruding portions 1310 having curved pressing surfaces were formed on the lid plate 80 such that the area over which a pressing force was applied was 10% of the application area of the positive electrode active material layer. The protruding portions 1310 had a radius of curvature of about 200.

### COMPARATIVE EXAMPLE 1

In Comparative Example 1, so that a pressing force might be applied also to the edge portions of the positive and negative electrode active material layers, the entire surfaces of the positive and negative electrodes were pressed. Specifically, in Comparative Example 1, as shown in FIG. 74, a protruding portion 2100 having a pressing surface wide enough to press the entire surfaces of the positive and negative electrodes was formed on the lid plate 80 such that the area over which a pressing force was applied was 100% of the application area of the positive electrode active material layer.

### COMPARATIVE EXAMPLE 2

In Comparative Example 2, as shown in FIG. 75, in addition to the protruding portion 2100 on the lid plate 80, a protruding portion 2200 having a pressing surface wide enough to press the entire surfaces of the positive and negative electrodes was formed also on the package can 70. Thus, also in Comparative Example 2, the area over which a pressing force was applied was 100% of the application area of the positive electrode active material layer.

### COMPARATIVE EXAMPLE 3

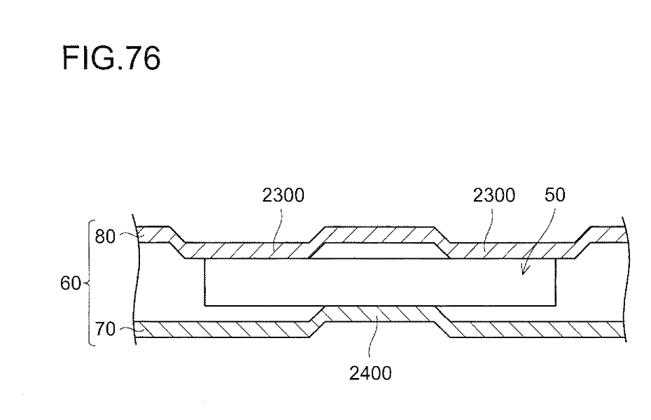

In Comparative Example 3, as shown in FIG. 76 protruding portions 2300 on the lid plate 80 and a protruding portion 2400 on the package can 70 were fainted so as not to correspond to (face) each other. In Comparative Example 3, the protruding portion 2300 on the lid plate 80 pressed the edge portions (end portions) of the positive and negative electrode active material layers.

### PROCESSES COMMON TO PRACTICAL EXAMPLES 1 to 13 AND COMPARATIVE EXAMPLES 1 TO 3

Fabrication of the Positive Electrodes

First, 90 parts by weight of LiFePO₄ as an active material, 50 parts by weight of acetylene black as a conductive agent, and 5 parts by weight of polyvinylidene fluoride as a binding agent were blended, and then an adequate amount of N-methyl-2-pyrrolidone was added to and dispersed in the blend; in this way, a positive electrode composite agent slurry was prepared. Next, the positive electrode composite agent slurry was applied evenly to both sides of a charge collector (positive electrode charge collector) of aluminum with a thickness of 20 μm, and was then dried; thereafter, the product was compressed on a roll press so as to have a thickness of 200 μm. Lastly, the product was cut to the desired size; in this way, a positive electrode (positive electrode plate) for Practical Examples 1 to 13 and Comparative Examples 1 to 3 was fabricated. The size of the region over which the positive electrode active material layer was applied was 146 mm longitudinally by 196 mm laterally, and the size of the positive electrode (positive electrode charge collector) was 146 mm longitudinally by 208 mm laterally.

Fabrication of the Negative Electrodes

First, 90 parts by weight of natural graphite (natural graphite occurring in China) and 10 parts by weight of polyvinylidene fluoride were blended, and then an adequate amount of N-methyl-2-pyrrolidone was added to and dispersed in the blend; in this way, a negative electrode composite agent slurry was prepared. Next, the negative electrode composite agent slurry was applied evenly to both sides of a charge collector (negative electrode charge collector) of copper with a thickness of 16 μm, and was then dried; thereafter, the product was compressed on a roll press so as to have a thickness of 200 μm. Lastly, the product was cut to the desired size; in this way, a negative electrode (negative electrode plate) for Practical Examples 1 to 13 and Comparative Examples 1 to 3 was fabricated. The size of the region over which the negative electrode active material layer was applied was 150 mm longitudinally by 200 mm laterally, and the size of the negative electrode (negative electrode charge collector) was 150 mm longitudinally by 210 mm laterally.

Preparation of the Non-aqueous Electrolyte Liquid

1 mol/L of LiPF₆ was dissolved in a mixture liquid of ethylene carbonate (EC) and diethyl carbonate (DEC) mixed in a ratio of 30:70 by volume; in this way, a non-aqueous electrolyte liquid was prepared.

Assembly of the Secondary Battery

Positive electrode plates and negative electrode plates were stacked with separators interposed between them in the order a positive electrode, a separator, a negative electrode, a separator, and so forth, and in this way, an electrode assembly (stacked member) was formed. Here, so that negative electrode plates might be located outside positive electrode plates, 24 positive electrode plates and 25 negative electrode plates were used. Moreover, 50 separators were used so that separators might be located at the outermost sides of the electrode assembly (stacked member).

The separators were formed of microporous film of polyethylene with a thickness of 20 μm. The size of the separators was 154 mm longitudinally by 206 mm laterally so as to be larger than the size over which the active material layers were applied to the positive and negative electrode plates.

For the package container, a package can and a lid plate were formed by processing a nickel-plated steel plate with a thickness of about 1.0 mm. The package can had the following inside dimensions: 164 mm longitudinally by 228 mm laterally by 20 mm in depth.

Then, the electrode assembly (stacked member) was housed in the package can, the lid plate was placed on top, and the battery was sealed therewith by a double seam. Fitting the lid plate caused a pressing force to be applied to the electrode assembly in the stack direction. Here, the pressing force was applied to the electrode assembly with the lid plate in such a way that the proportion of the amount of pressing-in with respect to the thickness of the electrode assembly in the stack direction was 10%. Specifically, the lid plate was fixed at a position about 1 mm pressed in (sunk) from the state where the electrode assembly and the lid plate is in direct or indirect contact with each other.

Next, through a filling hole with a diameter of 2 mm previously provided in the lid plate, a predetermined amount of non-aqueous electrolyte liquid was injected under reduced pressure. After the injection, a metal ball with substantially the same diameter as the filling hole was placed in the filling hole, and the filling hole was stopped by electric resistance welding. In this way, 30 samples each of Practical Examples 1 to 13 and Comparative Examples 1 to 3 were fabricated.

It should be noted that the region in which a pressing force was applied to the electrode assembly (positive and negative electrodes) varied among Practical Examples 1 to 13 and Comparative Examples 1 to 3. It should also be noted that, in all of Practical Examples 1 to 13, a pressing force was applied within the region of the positive and negative electrode active material layers excluding the edges parts thereof.

The samples of the lithium-ion secondary batteries of Practical Examples 1 to 13 and Comparative Examples 1 to 3 fabricated as described above were inspected for screening of defective from functioning batteries. If a battery yielded 0 volts at the stage of fabrication (assembly), internal short-circuiting was considered to have occurred. Accordingly, such batteries were screened out as defective. Batteries that were found to be functioning were subjected to characteristics evaluation.

Specifically, with the batteries that remained after the screening of defective ones, the battery capacity (initial-charge battery capacity) was measured by subjecting them to constant-current, constant-voltage charging up to 3.5 V for 5 hours followed by constant-current discharging down to 2 V. Thereafter, the batteries were subjected to cycle tests under the just-mentioned charging and discharging conditions in a temperature environment of 45° C. After 200 cycles, the discharge capacity was measured, and the battery capacity at this time was divided by the discharge capacity on cycle 1 (initial-charge battery capacity) to determine the proportion (capacity retention rate) as the basis for evaluation. The results are shown in Table 1 below. In Table 1, given in the column of the capacity retention rate after 200 cycles are example-by-example average values with the batteries subjected to the cycle tests.

TABLE 1

| | Number of | Proportion | Capacity Retention |
|---|---|---|---|
| | Defective | of Pressed | Rate After |
| | Batteries | Area (%) | 200 Cycles (%) |
| Practical Example 1 | 1 | 98 | 95 |
| Practical Example 2 | 0 | 98 | 96 |
| Practical Example 3 | 0 | 66 | 90 |
| Practical Example 4 | 0 | 66 | 92 |
| Practical Example 5 | 0 | 66 | 91 |
| Practical Example 6 | 1 | 20 | 90 |
| Practical Example 7 | 1 | 98 | 94 |
| Practical Example 8 | 2 | 75 | 93 |
| Practical Example 9 | 1 | 90 | 93 |
| Practical Example 10 | 0 | 80 | 96 |
| Practical Example 11 | 1 | 40 | 91 |
| Practical Example 12 | 1 | 20 | 90 |
| Practical Example 13 | 1 | 10 | 88 |
| Comparative Example 1 | 4 | 100 | 80 |
| Comparative Example 2 | 4 | 100 | 78 |
| Comparative Example 3 | 5 | — | 73 |

Table 1 reveals the following. Practical Examples 1 to 13, where the pressing force was applied to the region of the positive and negative electrode active material layers excluding the edge portions thereof, produced less defective batteries than Comparative Examples 1 to 3. Specifically, Practical Examples 1 to 13 largely produced 0 or 1 defective battery, Practical Example 8 producing the most, but still as few as 2, defective batteries. By contrast, Comparative Examples 1 to 3, where the pressing force was applied to the edge portions of the positive and negative electrode active material layers as well, produced 4 or 5, that is, far more defective batteries than the practical examples. The reason is considered to be as follows. As a result of the pressing force being applied to the edge portions of the positive and negative electrode active material layers, it was more likely that burrs and the like caused internal short-circuiting. In Comparative Example 3, when the electrode assembly (stacked member) was pressed, it tended to become wavy, increasing the incidence of internal short-circuiting; this is considered to have resulted in more, specifically 5, defective batteries than with Practical Examples 1 to 13 and Comparative Examples 1 and 2.

Table 1 further reveals the following. Practical Examples 1 to 13 achieved higher capacity retention rates on cycle 200 than Comparative Examples 1 to 3. Specifically, Practical Examples 1 to 12 all achieved capacity retention rates as high as 90% or more on cycle 200; Practical Example 13 achieved a capacity retention rate, though slightly lower than those with Practical Examples 1 to 12, still as high as 88%. The reason that Practical Examples 1 to 13 achieved high capacity retention rates is considered to have been that applying a pressing force to the positive and negative electrode active material layers held them closely together and prevented their displacement. By contrast, Comparative Examples 1 and 2 gave capacity retention rates of 80% and 78% respectively, which were 8% to 10% lower even than that with Practical Example 13. A probable reason for this is considered to have been that, in Comparative Examples 1 and 2, where the pressing force was applied to the edge portions of the positive and negative electrode active material layers as well unlike in Practical. Examples 1 to 13, as the active material layers expanded and contracted during charging and discharging of the battery, internal short-circuiting (micro-short-circuiting) occurred in the edge portions (end portions) of the electrodes. Comparative Example 3 gave an extremely low capacity retention rate of 73%. The reason is considered to have been that, in Comparative Example 3, an insufficient pressing force applied to the electrode assembly (stacked member) resulted in insufficient effects of improving the holding-together of and preventing displacement of the positive and negative electrode active material layers. Internal short-circuiting (micro-short-circuiting) may also have occurred in the edge portions (end portions) of the electrodes; internal short-circuiting is thus considered to have been involved in diminished capacity retention rates.

As described above, by applying a pressing force to the positive and negative electrodes and, when applying the pressing force, preventing it from being applied to the edge portions (end portions) of the positive and negative electrodes, it is possible to improve yields and life characteristics. It has been confirmed that, in that case, it is preferable that the proportion of the area in which the pressing force is applied with respect to the application area of the positive electrode active material layer be 10% or more but 99% or less, and further preferably 20% or more but 98% or less.

### Embodiment 14

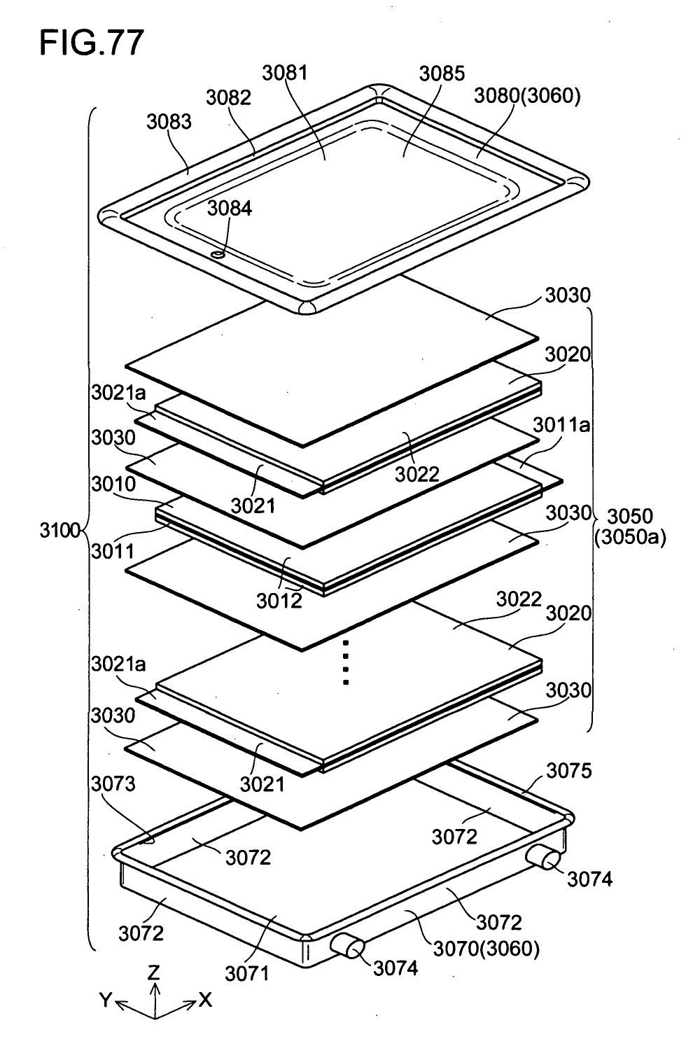

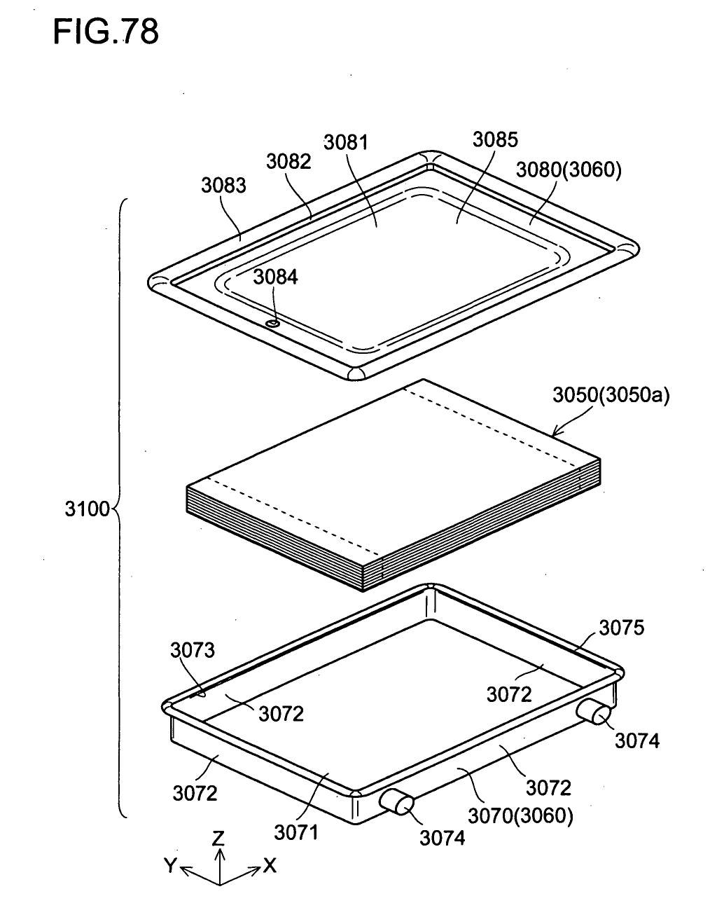

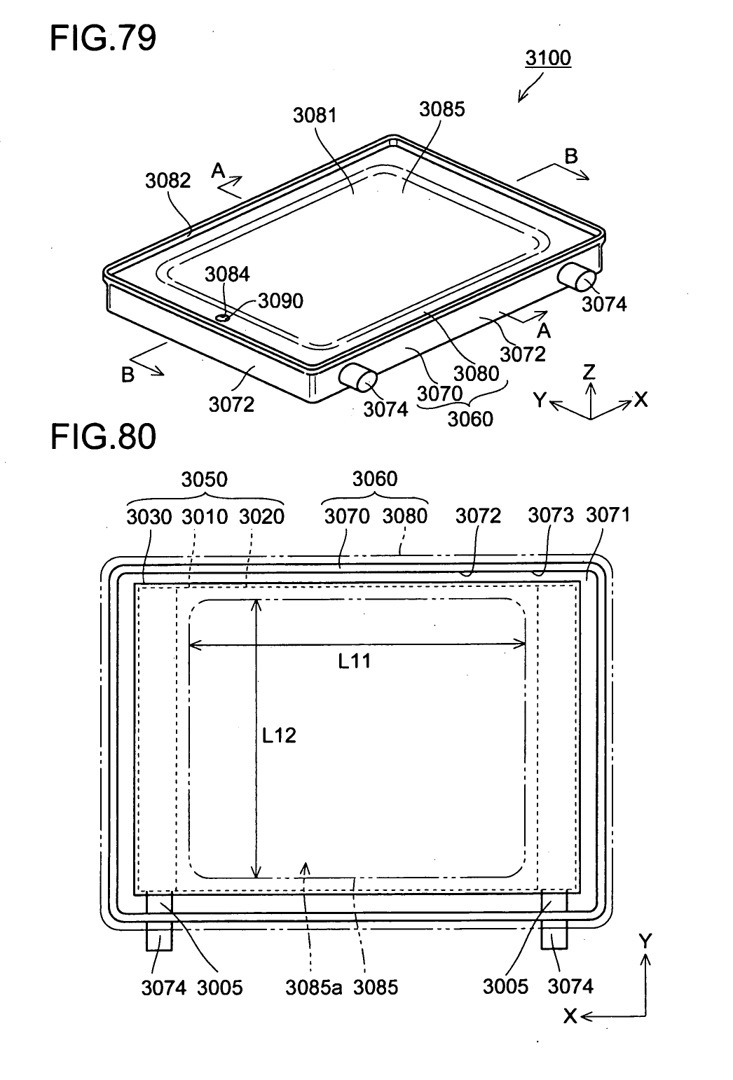

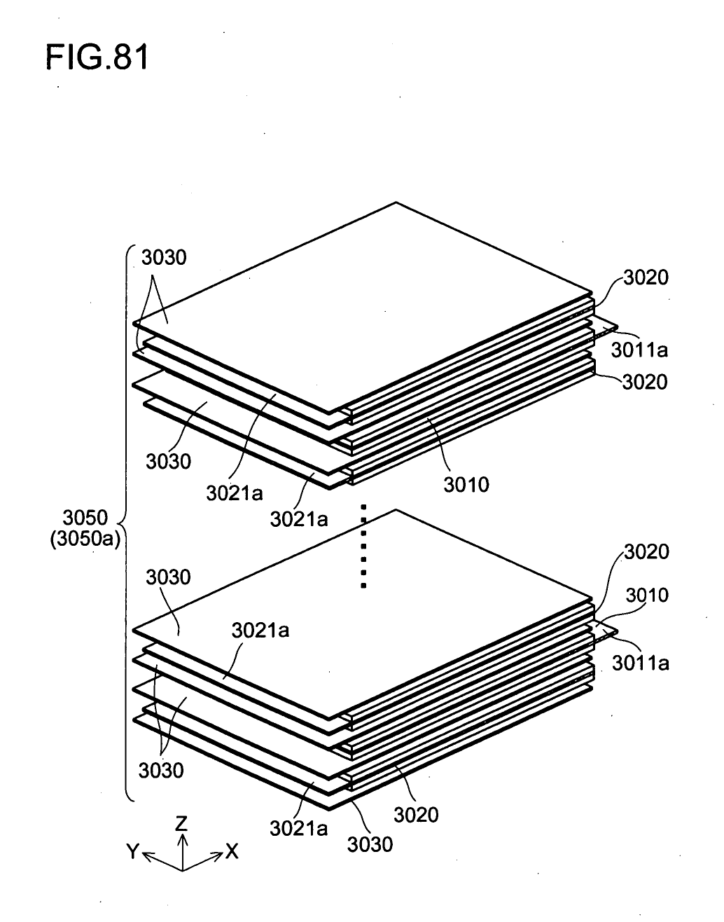

FIGS. 77 and 78 are exploded perspective views of a lithium-ion secondary battery according to a fourteenth embodiment (Embodiment 14) of the invention. FIG. 79 is an overall perspective view of the lithium-ion secondary battery according to Embodiment 14 of the invention. FIG. 80 is a plan view of the lithium-ion secondary battery according to Embodiment 14 of the invention. FIGS. 81 to 91 are diagrams in illustration of the lithium-ion secondary battery according to Embodiment 14 of the invention. It should be noted that FIG. 80 shows the lithium-ion secondary battery without the lid plate 3080 which it ordinarily has, in order to show the inside of the battery. First, with reference to FIGS. 77 to 91, the lithium-ion secondary battery 3100 according to Embodiment 14 will be described.

As shown in FIGS. 77 to 80, the lithium-ion secondary battery 3100 according Embodiment 14 has a flat, rectangular shape (see FIG. 79), and includes an electrode assembly (electrode stack) 3050 (see FIGS. 77 and 78), which in turn includes a positive (cathode) electrode 3010 (see FIG. 77) and a negative (anode) electrode 3020 (see FIG. 77), and a metal package container 3060, in which the electrode assembly 3050 is sealed along with a non-aqueous electrolyte liquid.

As shown in FIGS. 77 and 81, the electrode assembly 3050 further includes a separator 3030 for preventing short-circuiting between the positive and negative electrodes 3010 and 3020. The positive and negative electrodes 3010 and 3020 are arranged so as to face each other across the separator 3030. In practice, the electrode assembly 3050 usually includes a plurality of positive electrodes 3010, a plurality of negative electrodes 3020, and a plurality of separators 3030. The positive electrodes 3010, the separators 3030, and the negative electrodes 3020 are stacked sequentially to form a stacked structure (stacked member 3050a). The positive and negative electrodes 3010 and 3020 are stacked alternately, one of each on one of the other. The electrode assembly 3050 is so composed that, between every two adjacent negative electrodes 3020, one positive electrode 3010 is located. Moreover, the electrode assembly 3050 has separators 3030 arranged on the outermost sides thereof.

Specifically, the electrode assembly 3050 is composed of, for example, twenty-four (24) positive electrodes 3010, twenty-five (25) negative electrodes 3020, and fifty (50) separators 3030, with the positive and negative electrodes 3010 and 3020 stacked alternately with the separators 3030 interposed between them.

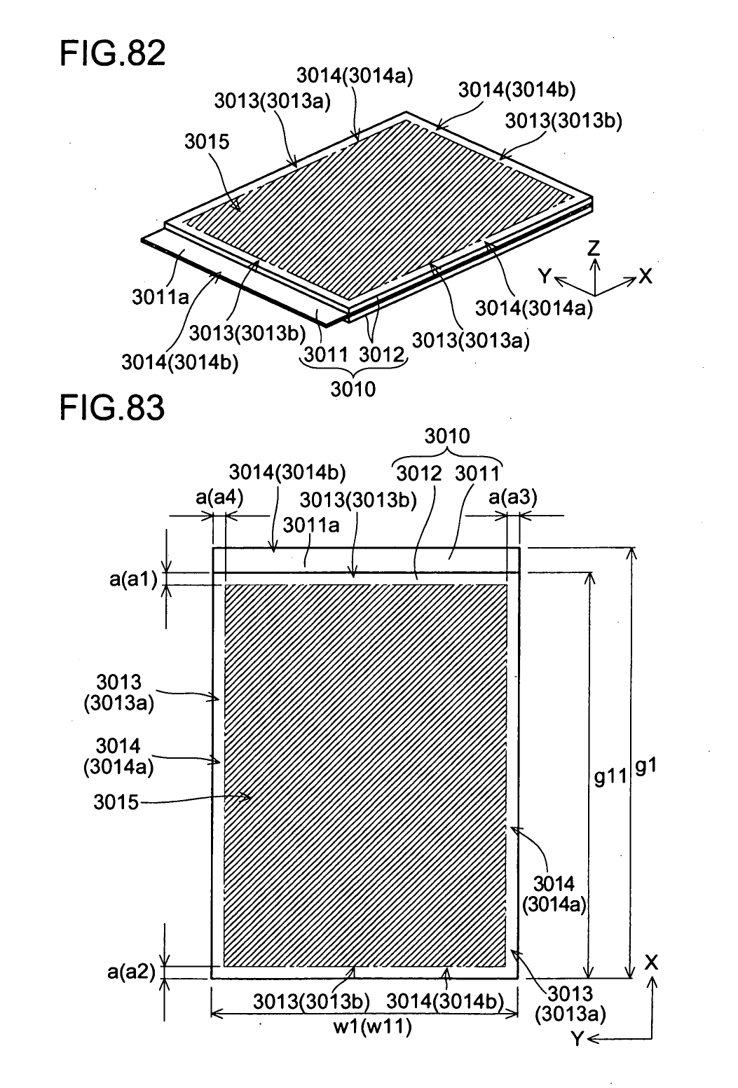

As shown in FIGS. 82 and 83, each positive electrode 3010 in the electrode assembly 3050 is composed of a positive electrode charge collector 3011 having a positive electrode active material layer 3012 laid on each face.

The positive electrode charge collector 3011 serves to collect electric charge from the positive electrode active material layer 3012. The positive electrode charge collector 3011 is formed of, for example, a foil of metal such as aluminum, titanium, stainless steel, nickel, or iron, or a foil of an alloy of any of these metals, and has a thickness of about 1 μm to about 500 μm (for example, about 20 μm). Preferably, the positive electrode charge collector 3011 is formed of a foil of aluminum or a foil of an alloy of aluminum, and is given a thickness of 20 μm or less.

The positive electrode charge collector 3011 may be formed of other than the materials mentioned above, metal such as aluminum or copper having its surface treated with carbon, nickel, titanium, silver, or the like for increased electrical conductivity and resistance to oxidation. These materials may have their surface oxidation-treated. Also usable are a copper-aluminum clad material, a stainless steel-aluminum clad material, or a plated material that is a combination of any of these metals. A charge collector may also be used that has foils of two or more metals bonded together. The positive electrode charge collector 3011 may be other than foil-shaped; it may instead be film-shaped, sheet-shaped, or net-shaped; punched, or expanded; shaped like a lath member, a porous member, or a foamed member; or shaped like a member formed of clusters of fibers.

The positive electrode active material layer 3012 is so formed as to contain a positive electrode active material that can occlude and release lithium ions. Examples of positive electrode active materials include oxides containing lithium; specifically, they include LiCoO₂, LiFeO₂, LiMnO₂, LiMn₂O₄, and any compound obtained by substituting part of the transition metal in any of these oxides with another metal element. Among these, preferable as the positive electrode active material are those which allow 80% or more of the lithium contained in the positive electrode to be used in the cell reaction under normal use. This makes it possible to enhance the safety of the secondary battery against accidents such as overcharging. Examples of such positive electrode active materials include compounds having a spinel structure, such as LiMn₂O₄; and compounds having an olivine structure represented by the formula LiMPO₄ (where M represents one or more elements selected from the group consisting of Co, Ni, Mn, and Fe). Among these, positive electrode active materials containing at least one of Mn and Fe are preferable from the viewpoint of cost. From the viewpoint of safety and charge voltage, it is preferable to use LiFePO₄. In LiFePO₄, all oxygen (O) atoms are bonded to phosphorus atoms by strong covalent bond, and thus oxygen is unlikely to be released on a rise in temperature; this makes LiFePO₄ excellent in safety.

Preferably, the positive electrode active material layer 3012 is given a thickness of about 20 μm to about 2 mm, and further preferably from about 50 μm to about 1 mm.

The positive electrode active material layer 3012 has at least to contain a positive electrode active material and there is no other particular restriction on its composition. For example, the positive electrode active material layer 3012 may further include, in addition to a positive electrode active material, any other material such as a conductive agent (electrical conductivity enhancer), a thickening agent (viscosity modifier), and a binding agent (binder).

Any conductive agent may be used so long as it is an electron conducting material that does not adversely affect the performance of the positive electrode 3010 in the battery. Examples include carbon materials such as carbon black, acetylene black, Ketjen black, graphite (natural and artificial), and carbon fiber; and conductive metal oxides. Among these, preferable as a conductive agent from the viewpoints of electron conduction and ease of application are carbon black and acetylene black.

Examples of thickening agents include polyethylene glycols, celluloses, polyacrylamides, poly-N-vinylamides, and poly-N-vinylpyrrolidones. Among these, preferable as a thickening agent are polyethylene glycols, and celluloses such as carboxymethyl cellulose (CMC), CMC being particularly preferable.

A binding agent serves to bind active material particles and conductive agent particles, and examples include fluorine polymers such as polyvinylidene fluoride (PVdF), polyvinyl pyridine, and polytetrafluoroethylene; polyolefin polymers such as polyethylene and polypropylene; and styrene-butadiene rubber.

Examples of solvents in which a positive electrode active material, a conductive agent, a binding agent, etc. are dispersed include organic solvents such as N-methyl-2-pyrrolidone, dimethylformamide, dimethylacetamide, methylethyl ketone, cyclohexanone, methyl acetate, methyl acrylate, diethyltriamine, N,N-dimethylaminopropylamine, ethylene oxide, and tetrahydrofuran.

The positive electrode 3010 is formed, for example, in the following manner. A positive electrode active material, a conductive agent, a thickening agent, and a binding agent are blended, and an appropriate solvent is added to the blend to prepare a positive electrode composite agent in the form of paste; the paste is applied to the surface of the positive electrode charge collector 3011 and is dried; as necessary, the product is compressed for increased electrode density.

As shown in FIG. 83, the positive electrode 3010 has a rectangular shape as seen in a plan view, and has four edge portions 3014 (two edge portions 3014a in the X direction and two edge portions 3014b in the Y direction). In Embodiment 14, the positive electrode 3010 has a Y-direction width w1 of, for example, about 146 mm, and has an X-direction length g1 of, for example, about 208 mm. The region over which the positive electrode active material layer 3012 is applied. (the application region, or the formation region) has a Y-direction width w11 of, for example, about 146 mm, which is equal to the width w1 of the positive electrode 3010, and has an X-direction length g11 of, for example, about 196 mm. Thus, the positive electrode active material layer 3012 formed in the application region has a rectangular shape as seen in a plan view, and has four edge portions 3013 (two edge portions 3013a along the X direction and two edge portions 3013b along the Y direction).

The positive electrode 3010 has, at one end in the X direction, a charge collector-exposed portion 3011a where the positive electrode active material layer 3012 is not formed and the surface of the positive electrode charge collector 3011 is exposed. To the charge collector-exposed portion 3011a is electrically connected a charge collection lead 3005 (see FIGS. 80 and 89), which will be described later, for extraction of electric current. The four edge portions 3013 of the positive electrode active material layer 3012 align with the edge portions 3014 of the positive electrode 3010 except one of the two edge portions 3013b along the Y direction (the edge portion 3013b at which the charge collector-exposed portion 3011a is located).

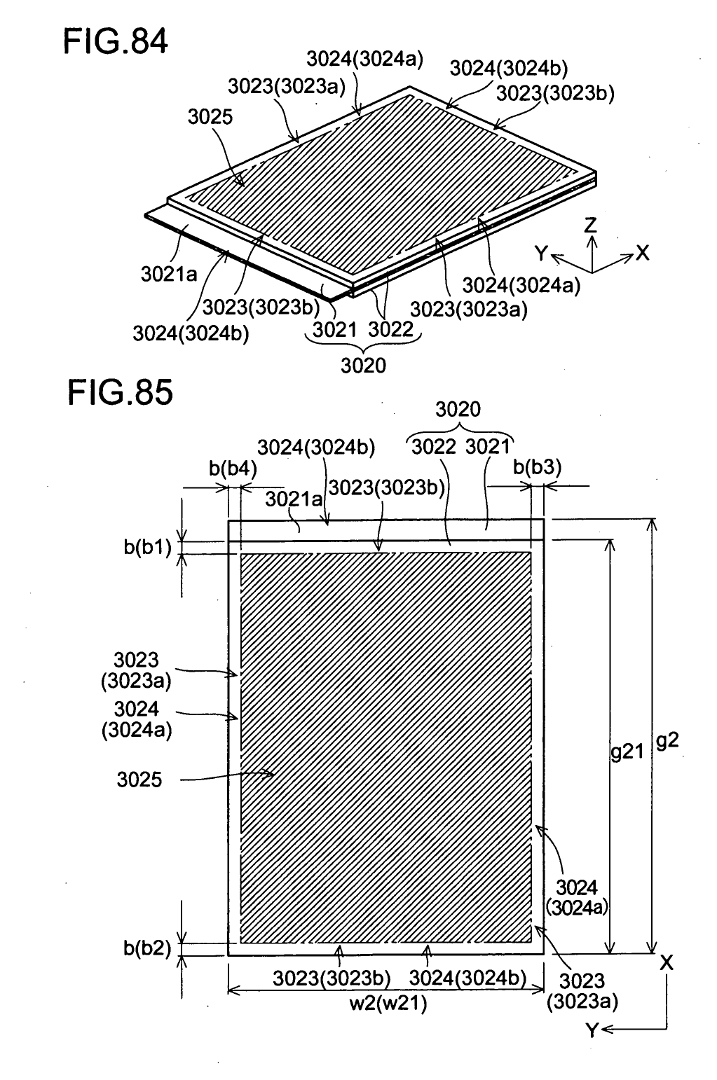

As shown in FIGS. 84 and 85, each negative electrode 3020 in the electrode assembly 3050 is composed of a negative electrode charge collector 3021 having a negative electrode active material layer 3022 laid on each face.

The negative electrode charge collector 3021 serves to collect electric charge from the negative electrode active material layer 3022. The negative electrode charge collector 3021 is formed of, for example, a foil of metal such as copper, nickel, stainless steel, iron, or a plated nickel layer, or a foil of an alloy of any of these metals, and has a thickness of about 1 μm to about 100 μm (for example, about 16 μm). Preferably, the negative electrode charge collector 3021 is formed of a foil of copper or stainless steel, and is given a thickness of 4 μm or more but 20 μm or less.

The negative electrode charge collector 3021 may be other than foil-shaped; it may instead be film-shaped, sheet-shaped, or net-shaped; punched, or expanded; shaped like a lath member, a porous member, or a foamed member; or shaped like a member formed of clusters of fiber.

The negative electrode active material layer 3022 is so formed as to contain a negative electrode active material that can occlude and release lithium ions. Examples of negative electrode active materials include substances containing lithium and substances that can occlude and release lithium. To build a high energy density battery, it is preferable to use a material of which the potentials at which lithium is occluded and released are close to the potentials at which metal lithium deposits and dissolves. Typical examples of such materials include natural and artificial graphite in the form of particles (that is, in the form of scales, lumps, fibers, whiskers, spheres, crushed particles, and the like). Also usable as a negative electrode active material is artificial graphite obtained by graphitizing mesocarbon microbeads, mesophase pitch powder, isotropic pitch powder, or the like. It is also possible to use graphite particles whose surface is coated with amorphous carbon. Also usable are lithium transition metal oxides, lithium transition metal nitrides, transition metal oxides, silicon oxides, and the like. Examples of lithium transition metal oxides include lithium titanates as exemplified by Li₄Ti₅O₁₂, whose use reduces degradation of the negative electrode 3020 and thus helps prolong the life of the battery.

Preferably, the negative electrode active material layer 3022 is given a thickness of about 20 μm to about 2 mm, and further preferably from about 50 μm to about 1 mm.

The negative electrode active material layer 3022 has at least to contain a negative electrode active material and there is no other particular restriction on its composition. For example, the negative electrode active material layer 3022 may further include, in addition to a negative electrode active material, any other material such as a conductive agent (electrical conductivity enhancer), a thickening agent (viscosity modifier), and a binding agent (binder). Usable as these other materials are the same as those for (usable in) the positive electrode active material layer 3012.

The negative electrode 3020 is formed, for example, in the following manner. A negative electrode active material, a conductive agent, a thickening agent, and a binding agent are blended, and an appropriate solvent is added to the blend to prepare a negative electrode composite agent in the form of paste; the paste is applied to the surface of the negative electrode charge collector 3021 and is dried; as necessary, the product is compressed for increased electrode density.

As shown in FIG. 85, the negative electrode 3020 has a rectangular shape as seen in a plan view, and has four edge portions 3024 (two edge portions 3024a in the X direction and two edge portions 3024b in the Y direction). Moreover, the negative electrode 3020 is formed to have a greater planar area than the positive electrode 3010 (see FIGS. 83 and 84). In. Embodiment 14, the negative electrode 3020 has a Y-direction width w2 of, for example, about 150 mm, which is greater than the width w1 (see FIG. 83) of the positive electrode 3010, and has an X-direction length g2 of, for example, about 210 mm, which is greater than the length g1 (see FIG. 83) of the positive electrode 3010. The region over which the negative electrode active material layer 3022 is applied (the application region, or the formation region) has a Y-direction width w21 of, for example, about 150 mm, which is equal to the width w2 of the negative electrode 3020, and has an X-direction length g21 of, for example, about 200 mm. Thus, the negative electrode active material layer 3022 formed in the application region has a rectangular shape as seen in a plan view, and has four edge portions 3023 (two edge portions 3023a along the X direction and two edge portions 3023b along the Y direction).

Like the positive electrode 3010, the negative electrode 3020 has, at one end in the X direction, a charge collector-exposed portion 3021a where the negative electrode active material layer 3022 is not formed and the surface of the negative electrode charge collector 3021 is exposed. To the charge collector-exposed portion 3021 a is electrically connected a charge collection lead 3005 (see FIGS. 80 and 89) for extraction of electric current. The four edge portions 3023 of the negative electrode active material layer 3022 align with the edge portions 3024 of the negative electrode 3020 except one of the two edge portions 3023b along the Y direction (the edge portion 23b at which the charge collector-exposed portion 3021a is located).

Here, in Embodiment 14, a resin material that swells when soaked (becomes imbued) with a non-aqueous electrolyte liquid (also referred to as a swelling resin) is dispersed in the active material layers of the electrodes. Thus, the lithium-ion secondary battery 3100 of Embodiment 14 is so structured that, after the injection of non-aqueous electrolyte liquid, the active material layers having the swelling resin dispersed in them swell.

The swelling resin may be dispersed in both the positive and negative electrode active material layers 3012 and 3022, or in the positive electrode active material layer 3012 alone, or in the negative electrode active material layer 3022 alone. The swelling resin may be dispersed in part of those electrode active material layers.

Preferably, the swelling resin dispersed in the active material layers contains one or more substances selected from the group consisting of nitrile butadiene rubber (NBR), styrene butadiene rubber (SBR), carboxymethyl cellulose (CMC), polyvinylidene fluoride (PVdF), polyvinyl alcohol (PVA), polyethylene oxide (PEO), propylene oxide, polystyrene, and polymethyl methacrylate.

The separators 3030 in the electrode assembly 3050 are expected to provide sufficient mechanical strength and hold as much electrolyte liquid as possible. From this viewpoint, examples of preferable materials include microporous film and nonwoven fabric of materials such as polyethylene, polypropylene, and ethylene-propylene copolymer with a thickness of 10 μm to 50 μm and with a porosity (void percentage) of 30% to 70%.

Other examples of the material for the separators 3030 include microporous film and the like formed of high polymers such as polyvinylidene fluoride, polyvinylidene chloride, polyacrylonitrile, polyacrylamide, polytetrafluoroethylene, polysulfone, polyethersulfone, polycarbonate, polyamide, polyimide, polyether (polyethylene oxide, polypropylene oxide, cellulose (carboxymethyl cellulose, hydroxypropyl cellulose), poly(meth)acrylic acid, and poly(meth)acrylic acid esters. A multilayer film may be used that has two or more such microporous films stacked together.

Preferably, each separator 3030 is given a thickness of 5 μm to 100 μm, and further preferably 10 μm to 30 μm. Preferably, the separator 3030 is given a porosity of 30% to 90%, and further preferably 40% to 80%. With the thickness of the separator 3030 less than 5 μm, it has insufficient mechanical strength, causing internal short-circuiting of the battery. On the other hand, with the thickness of the separator 3030 more than 100 μm, the distance between the positive and negative electrodes is so great that the battery has a high internal resistance. With a porosity less than 30%, the amount of non-aqueous electrolyte liquid contained is so small that the battery has a high internal resistance. On the other hand, with a porosity more than 90%, the positive and negative electrodes 3010 and 3020 make physical contact with each other, causing internal short-circuiting of the battery. Depending on their thickness and porosity, the separators 3030 may be used in stacks of several sheets of them, with consideration given to mechanical strength, the content of non-aqueous electrolyte liquid, the internal resistance of the battery, the likelihood of internal short-circuiting of the battery, and other factors.

The separator 3030 is so shaped as to be larger than the application region (formation region) of the positive electrode active material layer 3012 and larger than the application region (formation region) of the negative electrode active material layer 3022. Specifically, the separator 3030 is formed to have a rectangular shape with a longitudinal (vertical) dimension (length in the direction corresponding to the X direction) of about 154 mm and a lateral (horizontal) dimension (length in the direction corresponding to the Y direction) of about 206 mm.

As shown in FIGS. 77 and 81, the positive and negative electrodes 3010 and 3020 are arranged so that the charge collector-exposed portion 3011a of the positive electrodes 3010 and the charge collector-exposed portion 3021a of the negative electrodes 3020 are located at opposite sides, and are stacked with the separators 3030 interposed between the positive and negative electrodes.

There is no particular restriction on the non-aqueous electrolyte liquid sealed inside the package container 3060 along with the electrode assembly 3050. Examples of usable solvents include esters such as ethylene carbonate (EC), propylene carbonate, butylene carbonate, diethyl carbonate (DEC), dimethyl carbonate, methyl ethyl carbonate, and gamma-butyrolactone; ethers such as tetrahydrofuran, 2-methyltetrahydrofuran, dioxane, dioxolane, diethylether, dimethoxymethane, diethoxyethane, and methoxyethoxy ethane; and polar solvents such as dimethyl sulfoxide, sulfolane, methyl sulfolane, acetonitrile, methyl formate, and methyl acetate. Any of these solvents may be used singly or as a mixed solvent of two or more of them.

The non-aqueous electrolyte liquid may contain an electrolyte supporting salt. Examples of electrolyte supporting salts include lithium salts such as LiClO₄, LiBF₄ (lithium tetrafluoroborate), LiPF₆ (lithium hexafluorophosphate), LiCF₃SO₃ (lithium trifluoromethanesulfonate), LiF (lithium fluoride), LiCl (lithium chloride), LiBr (lithium bromide), LiI (lithium iodide), and LiAlCl₄ (lithium tetrachloroaluminate). Any of these may be used singly or as a mixture of two or more of them.

There is no particular restriction on the concentration of an electrolyte supporting salt, a preferable concentration being from 0.5 mol/L (mol per liter) to 2.5 mol/L, and further preferably from 1.0 mol/L to 2.2 mol/L. With the concentration of an electrolyte supporting salt less than 0.5 mol/L, the concentration of charge carriers in the non-aqueous electrolyte liquid may be so low that the non-aqueous electrolyte liquid has a high resistance. With the concentration of an electrolyte supporting salt more than 2.5 mol/L, the degree of dissociation of the salt itself may be so low that the concentration of carriers in the non-aqueous electrolyte liquid remains low.

The package container 3060, in which the electrode assembly 3050 is sealed, is a large, flat, rectangular container and, as shown in FIGS. 77 to 79, is composed of a package can 3070 in which the electrode assembly 3050 etc. are housed and a lid plate 3080 which seals the opening of the package can 3070. The package can 3070 having the electrode assembly 3050 housed in it is sealed with the lid plate 3080 by a double seam. The package can 3070 is an example of a “housing container” according to the invention, and the lid plate 3080 is an example of a “lid member” according to the invention.

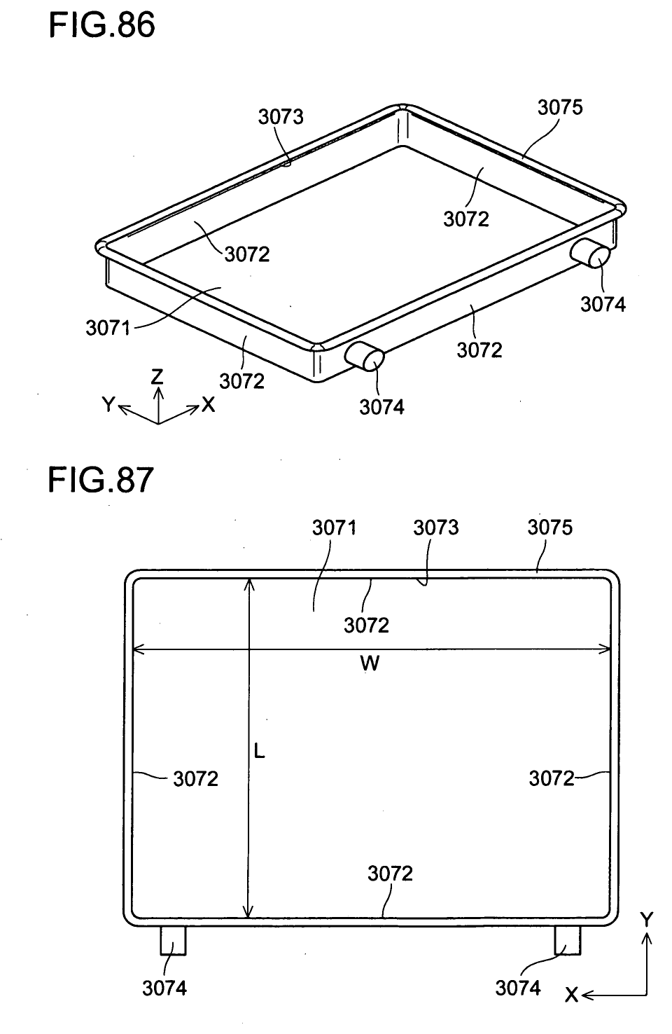

The package can 3070 is formed, for example, by subjecting a metal plate to deep drawing, and has a bottom face portion 3071 and a side wall portion 3072. Moreover, as shown in FIGS. 86 and 87, the package can 3070 has, at one end (on the side opposite from the bottom face portion 3071), an opening 3073 through which to house the electrode assembly 3050 (see FIG. 89). The package can 3070 is formed as a box-shaped can, its face with the greatest area being the bottom face portion 3071.

The package can 3070 has inside dimensions such that the electrode assembly 3050 can be housed in it with the electrode surfaces facing the bottom face portion 3071. Specifically, the package can 3070 is formed to have, for example, a longitudinal dimension (length L in the Y direction in FIG. 87) of about 164 mm and a lateral dimension (length W in the X direction in FIG. 87) of about 228 mm. Moreover, as shown in FIG. 89, the package can 3070 is given a depth D of, for example, about 20 mm.

Moreover, as shown in FIGS. 86 and 87, in the package can 3070, on a side wall portion 3072 at one side in the Y direction, there are formed electrode terminals 3074. Furthermore, around the rim of the opening 3073 of the package can 3070, there is provided a container flange portion 3075 for double-seam sealing.

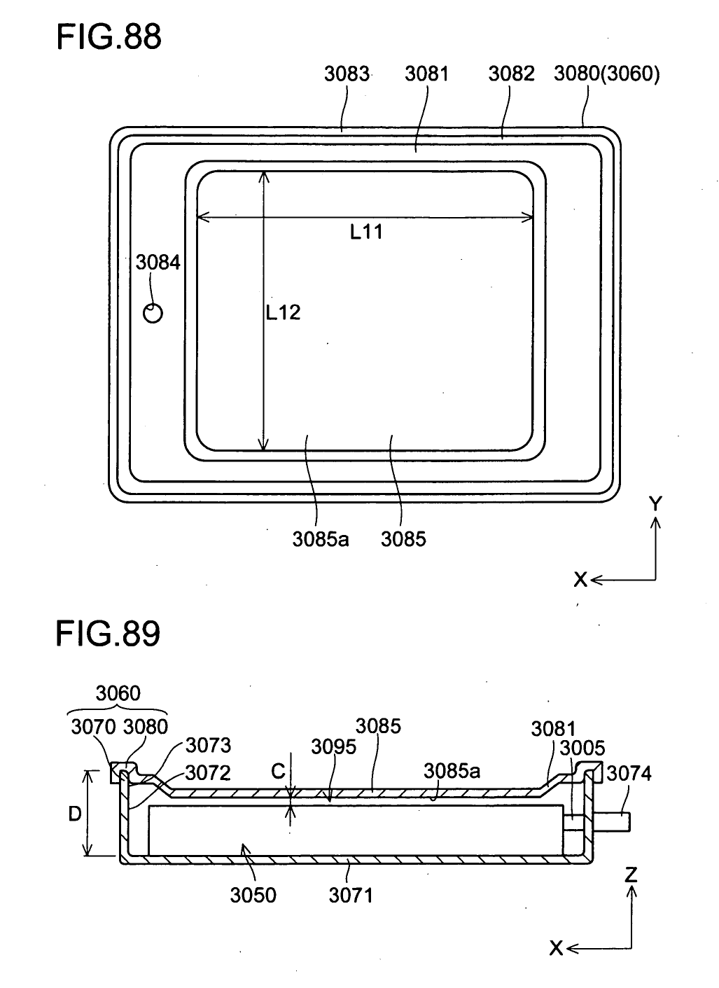

The lid plate 3080 is formed, for example, by pressing of a metal plate. As shown in FIG. 88, the lid plate 3080 has a panel portion 3081, which is substantially flat-plate-shaped and stops the opening 3073 of the package can 3070, a chuck wall portion 3082, which connects to the circumferential edge of the panel portion 3081 and extends upward therefrom, and a flange portion 3083, which connects to the circumferential edge of the chuck wall portion 3082. Moreover, as shown in FIGS. 77 and 78, at one side in the X direction, there is formed a filling hole 3084 through which to inject non-aqueous electrolyte liquid. The filling hole 3084 is formed with a diameter of, for example, 2 mm.

The package can 3070 and the lid plate 3080 are formed of, for example, a metal plate of iron, stainless steel, aluminum, or the like, or a steel plate of nickel-plated iron, or a steel plate of aluminum-plated iron, or the like. Iron is inexpensive, and is preferable from the viewpoint of cost; however, to secure reliability for a long period of time, it is further preferable to use a metal plate of stainless steel, aluminum, or the like, or a steel plate of nickel-plated iron, or a steel plate of aluminum-plated iron, or the like. Other than these materials, also usable is a high-polymer-laminated material (laminated plate), that is, a metal plate having its surface laminated with a high-polymer material. In that case, it is preferable that at least the surface facing the inside of the battery be coated. The metal plate is given a thickness of, for example, about 0.4 mm to about 1.2 mm (for example, about 1.0 mm).

As shown in FIGS. 80, 90, and 91, the electrode assembly 3050 is housed inside the package can 3070 with the positive electrodes 3010 (see FIG. 77) and the negative electrodes 3020 (see FIG. 77) facing the bottom face portion 3071 of the package can 3070. With the electrode assembly 3050 so housed, the charge collector-exposed portion 3011a (see FIG. 83) of the positive electrodes 3010 and the charge collector-exposed portion 3021a (see FIG. 85) of the negative electrode 3020 are electrically connected, via charge collection leads 3005 respectively, to the electrode terminals 3074 on the package can 3070. The charge collection leads 3005 may be formed of the same material as, or a different material from, the charge collectors. The positive and negative electrodes 3010 and 3020 may be connected to charge collection electrodes (charge collecting members) respectively, so that, via these charge collection electrodes, the electrode assembly 3050 is electrically connected to the electrode terminals 3074.

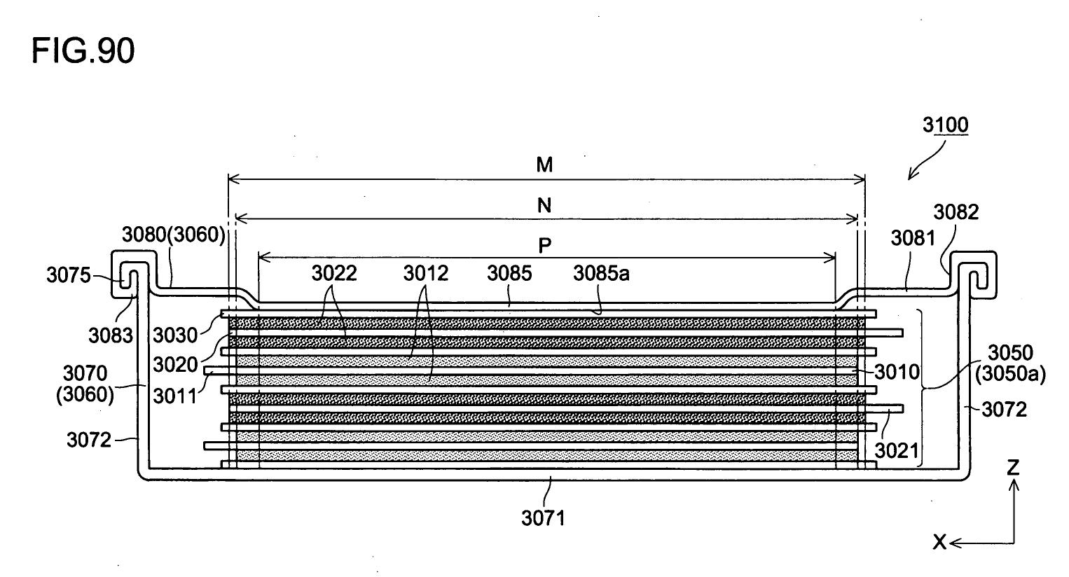

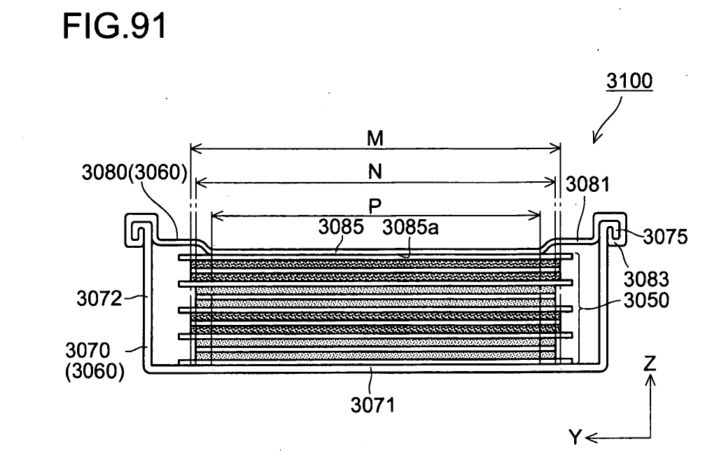

As shown in FIGS. 90 and 91, the opening 3073 of the package can 3070 is sealed with the lid plate 3080 by a double seam. Specifically, the edge portion of the flange portion 3083 of the lid plate 3080 is crimped in such a way as to enfold the container flange portion 3075 of the package can 3070, and thereby the lid plate 3080 is fitted to the package can 3070.

The chuck wall portion 3082 allows the panel portion 3081 of the lid plate 3080 to be located a predetermined distance below the rim of the opening 3073 of the package can 3070 (toward the bottom face portion 3071).

Moreover, in Embodiment 14, as shown in FIG. 89, before the injection of non-aqueous electrolyte liquid, the lid plate 3080 and the electrode assembly 3050 are not in contact with each other, but a gap 3095 is left between them. Preferably, the gap 3095 is given an interval C less than 5 mm. That is, in the lithium-ion secondary battery 3100 according to Embodiment 14, it is preferable that the interval C be set so as to fulfill the formula 0 mm<C<5 mm. Moreover, before the injection of non-aqueous electrolyte liquid, to prevent displacement of the electrode assembly 3050 housed in the package container 3060, it is preferable that the electrode assembly 3050 be fixed inside the package container 3060. For that purpose, the electrode assembly 3050 may be fixed by use of charge collection electrodes (charge collecting members) that are connected to the electrodes.

After the opening 3073 of the package can 3070 is sealed with the lid plate 3080, non-aqueous electrolyte liquid is injected through the filling hole 3084, for example, under reduced pressure. Then, for example, a metal ball 3090 (see FIG. 79) with approximately the same diameter as the filling hole 3084 is placed in the filling hole 3084, and the filling hole 3084 is sealed by electric resistance welding, laser welding, or the like.

In the lithium-ion secondary battery 3100 according to Embodiment 14, to prevent risks such as rupture (ignition) of the battery that may result from a rise in the internal pressure of the battery due to overcharging or high temperature, there is provided a safety valve (not shown) for liberating the internal pressure of the battery. And, to prevent the package container 3060 from breaking open before activation of the safety valve, the lid plate 3080 is fitted with such sealing strength that the pressure resistance at the sealed part is higher than the activation pressure of the safety valve.

Here, in Embodiment 14, after the opening 3073 of the package can 3070 is sealed with the lid plate 3080, injecting non-aqueous electrolyte liquid causes the active material layers having the swelling resin dispersed in them to swell, and as the active material layers swell, as shown in FIGS. 90 and 91, a pressing surface is applied to the electrode assembly 3050 (positive and negative electrodes 3010 and 3020). That is, Embodiment 14 is so structured that, after the injection of non-aqueous electrolyte liquid, the package can 3070 and the lid plate 3080 apply a pressing force to the electrode assembly 3050 in the stack direction (the direction of the depth of the package can 3070, which is the Z direction).

As shown in FIGS. 83 and 85, the region in which the pressing force is applied to the positive and negative electrodes 3010 and 3020 is within an inward region 3015 of the positive electrode active material layer 3012 a distance “a” (“a1” to “a4”) away from (inward of) the edges thereof, or within an inward region 3025 of the negative electrode active material layer 3022 a distance “b” (“b1” to “b4”) away from (inward of) the edges thereof Preferably, the distance “a” from the edges of the positive electrode active material layer 3012 in the positive electrode 3010 and the distance “b” from the edges of the negative electrode active material layer 3022 in the negative electrode 3020 are each 1 mm or more, and further preferably 5 mm or more. In Embodiment 14, since the positive electrode 3010 has a smaller planar area than the negative electrode 3020, preferably, the region in which the pressing force is applied to the positive and negative electrodes 3010 and 3020 is within an inward region 3015 of the positive electrode active material layer 3012 a distance “a” of 5 mm or more away from the edges thereof. With this structure, also in the negative electrode 3020, the pressing force is applied within an inward region 3025 of the negative electrode active material layer 3022 a distance “b” of 5 mm or more away from the edges thereof.

Moreover, in Embodiment 14, as shown in FIGS. 90 and 91, so that the pressing force may be applied to the region of the positive and negative electrode active material layers 3012 and 3022 excluding the edge portions (end portions) 3014 and 3024 of the positive and negative electrodes 3010 and 3020, the lid plate 3080 has a protruding portion 3085 formed on it.

Specifically, in the lithium-ion secondary battery 3100 according to Embodiment 14, the lid plate 3080 is so structured as to face the electrodes (positive and negative electrodes 3010 and 3020), and in the panel portion 3081 of the lid plate 3080, the protruding portion 3085 is formed so as to protrude toward the electrode assembly 3050 (positive and negative electrodes 3010 and 3020) (in the Z direction). The protruding portion 3085 is formed integrally with the lid plate 3080 by pressing, and has a substantially flat pressing surface 3085a. The pressing surface 3085a of the lid plate 3080 presses the electrode assembly 3050 in the stack direction (Z direction), and thereby a pressing force is applied within the region 3015 of the positive electrode active material layer 3012 and the region 3025 of the negative electrode active material layer 3022 excluding the four edge portions 3013 of the positive electrode active material layer 3012 and the four edge portions 3023 of the negative electrode active material layer 3022. Thus, in Embodiment 14, as shown in FIGS. 90 and 91, the region P in which the protruding portion 3085 applies a pressing force is located inside (inward of) the formation region M of the negative electrode active material layer 3022 and inside (inward of) the formation region N of the positive electrode active material layer 3012.

As shown in FIG. 89, the pressing surface 3085a of the protruding portion 3085 has a substantially rectangular shape as seen in a plan view, and is formed to have a planar area smaller than that of the positive electrode active material layer 3012 (see FIG. 83). The pressing surface 3085a has an X-direction length L11 of, for example, about 194 mm, which is smaller than the X-direction length g1 (see FIG. 83) of the positive electrode active material layer 3012. The pressing surface 3085a has a Y-direction length L12 of, for example, about 144 mm, which is smaller than the Y-direction length w1 (see FIG. 83) of the positive electrode active material layer 3012.

Moreover, in Embodiment 14, the protruding portion 3085 applies a pressing force to almost all over the inward region 3015 of the positive electrode active material layer 3012 a distance “a” away from the edges thereof or the inward region 3025 of the negative electrode active material layer 3022 a distance “b” away from the edges thereof. Preferably, the area of the region in which the pressing force is applied to the positive and negative electrodes 3010 and 3020 is 10% or more but 99% or less of the planar area of the positive electrode active material layer 3012, and further preferably 20% or more but 98% or less.

The amount of swelling resin dispersed (contained) in the active material layers is so set that, when non-aqueous electrolyte liquid is injected and the active material layers swell, the gap 3095 between the lid plate 3080 and the electrode assembly 3050 is filled so that these are brought into contact with each other and furthermore the lid plate 3080 and the package can 3070 restricts the swelling of the active material layers so that a pressing force is applied to the electrode assembly 3050 (positive and negative electrodes 3010 and 3020) in the stack direction. Moreover, the pressing force applied to the electrode assembly 3050 is controlled by controlling the rate of restriction (compression) effected by the lid plate 3080 and the package can 3070 (the proportion of the amount by which the lid plate 3080 and the package can 3070 restrict the swelling of the active material layers with respect to the thickness of the electrode assembly 3050 (the total thickness of the positive electrodes 3010, the negative electrodes 3020, and the separators 3030) as would be observed if the active material layers were let to swell freely), and the rate of swelling of the active material layers (the amount of swelling resin contained (dispersed)), and the interval C of the gap 3095 are adjusted so that the desired pressing force is obtained. It is preferable that the rate of swelling of the active material layers (the amount of swelling resin dispersed) and the interval C of the gap 3095 be adjusted so that the rate of restriction (compression) effected on the electrode assembly 3050 is about 3% to about 30% (for example, about 10%).

As described above, in the lithium-ion secondary battery 3100 according to Embodiment 14, a swelling resin is dispersed in the positive electrode active material layer 3012, or in the negative electrode active material layer 3022, or in both so that, when non-aqueous electrolyte liquid is injected into the package container 3060, the active material layers having the swelling resin dispersed in them swell. Thus, the active material layers that have swollen by injection of the non-aqueous electrolyte liquid apply a pressing force to the electrode assembly 3050 (positive and negative electrodes 3010 and 3020) housed inside the package container 3060 in the stack direction. This permits the electrode assembly 3050 (positive and negative electrodes 3010 and 3020) to be fixed inside the package container 3060, and thus helps prevent displacement of the electrode assembly 3050 (positive and negative electrodes 3010 and 3020). Consequently, it is possible to prevent internal short-circuiting resulting from displacement of the electrode assembly 3050 (positive and negative electrodes 3010 and 3020) that may occur, for example, as the active material layers expand and contract during charging and discharging of the battery.

Moreover, Embodiment 14 is so structured that, when a pressing force is applied to the positive and negative electrodes 3010 and 3020, the pressing force is applied to the region of the positive and negative electrode active material layers 3012 and 3022 excluding the edge portions (end portions) 3014 and 3024 of the positive and negative electrodes 3010 and 3020. This makes it possible to prevent the pressing force from being applied to the edge portions 3014 and 3024 of the positive and negative electrodes 3010 and 3020.

Here, the positive and negative electrodes 3010 and 3020 are both formed by use of a long, strip-shaped charge collector sheet: first the positive or negative electrode active material layer 3012 or 3022 is applied to the charge collector sheet by a predetermined method, and the sheet is then cut into the lengths of individual electrodes. The application of the active material layer to the charge collector sheet is achieved, for example, by a method involving so-called intermittent application (hereinafter referred to as an “intermittent application method”): first the active material layer is applied only for a length enough to form a single electrode; then a charge collector-exposed portion 3011a or 3021a where the active material layer is not applied is secured; then the active material layer is applied for the next electrode; and this sequence of operations is repeated. Another useable method is, for example, one involving continuous application (hereinafter referred to as a “continuous application method”): the active material layer is applied with the charge collector-exposed portions 3011a and 3021a located at one end of the direction perpendicular to the length direction.

In a case where a continuous application method as described above is adopted, when the long charge collector sheet is cut, the active material layer and the charge collector supporting it are cut simultaneously. As a result, burrs develop at the cut faces of the charge collector, and the impact during cutting makes the cut faces and parts around them of the active material layer unstable. This makes part of the active material layer prone to scale off at an edge.

On the other hand, in a case where an intermittent application method is adopted, cutting is performed in the charge collector-exposed portions 3011a and 3021a, and this makes the scaling-off of the active material layer less likely. With an intermittent application method, however, depending on the viscosity of the composite agent paste, bulges may form at the application-starting and -ending ends of the active material layer. That is, projections may form in the end portions (edge portions) of the active material layer. A step may also form at the boundary between the non-application portion (charge collector-exposed portion) of the charge collector and the active material layer.

Thus, in Embodiment 14, owing to the structure described above in which no pressing force is applied to the edge portions (end portions) 3014 and 3024 of the positive and negative electrodes 3010 and 3020 (no pressing force is applied to the cut faces of the electrodes), even when burrs form at the cut faces of the positive and negative electrodes 3010 and 3020 in the process of forming (cutting) these, it is possible to prevent the burrs from causing short-circuiting between the positive and negative electrodes 3010 and 3020. Moreover, even when the impact during cutting makes the cut faces and parts around them of the active material layer unstable and makes part of the active material layer prone to scale off, it is possible to prevent a pressing force from being applied to those parts, and thus to prevent scaling-off and the like of the active material. This makes it possible to prevent internal short-circuiting resulting from a scaled-off part of the active material penetrating the separator 3030. Consequently, it is possible to prevent internal short-circuiting during the assembly and the like of the battery, and thus to obtain a large-capacity lithium-ion secondary battery 3100 at high yields.

Moreover, in Embodiment 14, it is possible, with the swelling resin that has swollen by injection of non-aqueous electrolyte liquid into the package container 3060, to apply a pressing force to the electrode assembly 3050. By this pressing force, the positive and negative electrodes 3010 and 3020 are held closely together with the separators 3030 interposed between them. This makes it possible to improve life characteristics such as cycle characteristics. Moreover, by applying the pressing force to the positive and negative electrodes 3010 and 3020, it is possible to prevent displacement of the electrodes, and this too helps improve cycle characteristics. Thus, with the structure described above, it is possible to improve life characteristics and reliability.

Moreover, in Embodiment 14, owing to the package can 3070 and the lid plate 3080 applying a pressing force within, respectively, the region 3015 of the positive electrode active material layer 3012 and the region 3025 of the negative electrode active material layer 3022 excluding the four edge portions 3013 of the positive electrode active material layer 3012 and the four edge portions 3023 of the negative electrode active material layer 3022, even when projections form at the application-starting and -ending ends of the active material layer, it is possible to prevent the pressing force from being applied to those projections. In addition, even when a step forms at the boundary between the charge collector-exposed portion and the active material layer, it is possible to prevent the pressing force from being applied to the step. Thus, it is possible to prevent the inconvenience of the separator 3030 being damaged as a result of a pressing force being applied to a region where a projection, step, or the like has formed. This makes it possible to prevent contact between the positive and negative electrode active material layers 3012 and 3013 resulting from damage to the separator 3030, and this too helps prevent internal short-circuiting.

Furthermore, in Embodiment 14, owing to the structure described above, it is possible to prevent a pressing force from being applied to the edge portions 3014 and 3024 of the positive and negative electrodes 3010 and 3020, and thus it is possible to prevent internal short-circuiting from occurring in the edge portions (end portions) of the electrodes as the active material layers expand and contract during charging and discharging of the battery. This too helps improve cycle characteristics. In addition, it is possible to improve reliability.

As described above, with the lithium-ion secondary battery 3100 according to Embodiment 14, it is possible to improve life characteristics and reliability, and in addition to improve yields. Thus, it is possible to provide large-capacity, long-life lithium-ion secondary batteries 3100 at low prices.

Moreover, in Embodiment 14, by forming the protruding portion 3085 protruding toward the positive and negative electrodes 3010 and 3020 on the lid plate 3080 stopping the opening 3073 of the package can 3070, it is possible, with the protruding portion 3085, to easily apply a pressing force to the region of the positive and negative electrode active material layers 3012 and 3022 excluding the edge portions (end portions) 3014 and 3024 of the positive and negative electrodes 3010 and 3020.

Moreover, in Embodiment 14, by forming the protruding portion 3085 integrally with the lid plate 3080, it is possible to easily form the protruding portion 3085 on the lid plate 3080. In addition, even when the protruding portion 3085 is formed on the lid plate 3080, this can be done without increasing the number of components.

Moreover, in Embodiment 14, by forming the protruding portion 3085 such that it has a substantially flat pressing surface 3085a, when a pressing force is applied with the protruding portion 3085 (pressing surface 3085a) on the lid plate 3080, it is possible to prevent the pressing force from concentrating at one point on the active material layer. It is thus possible to prevent the inconvenience of a crack developing in the active material layer as a result of the pressing force concentrating at one point. This makes it possible to prevent degradation of cycle characteristics resulting from a crack developing in the active material layer. If the protruding portion has a sharp tip (for example, if it has a pointed tip), internal short-circuiting is likely to occur; by contrast, by giving the protruding portion 3085 a substantially flat pressing surface 3085a as described above, it is possible to prevent internal short-circuiting.

The lithium-ion secondary battery 3100 according to Embodiment 14 structured as described above can be used suitably as a stationary electric power storage battery which is expected to have a long life. It can also be used suitably as a vehicle-mounted storage battery for hybrid electric vehicles (HEVs), electric vehicles (EVs), and the like. The lithium-ion secondary battery 3100 according to Embodiment 14 is suitable as a storage battery with a per-cell capacity of 10 Ah or more, and is particularly suitable as a large-capacity storage battery with a per-cell capacity of 50 Ah or more.

### EMBODIMENT 15

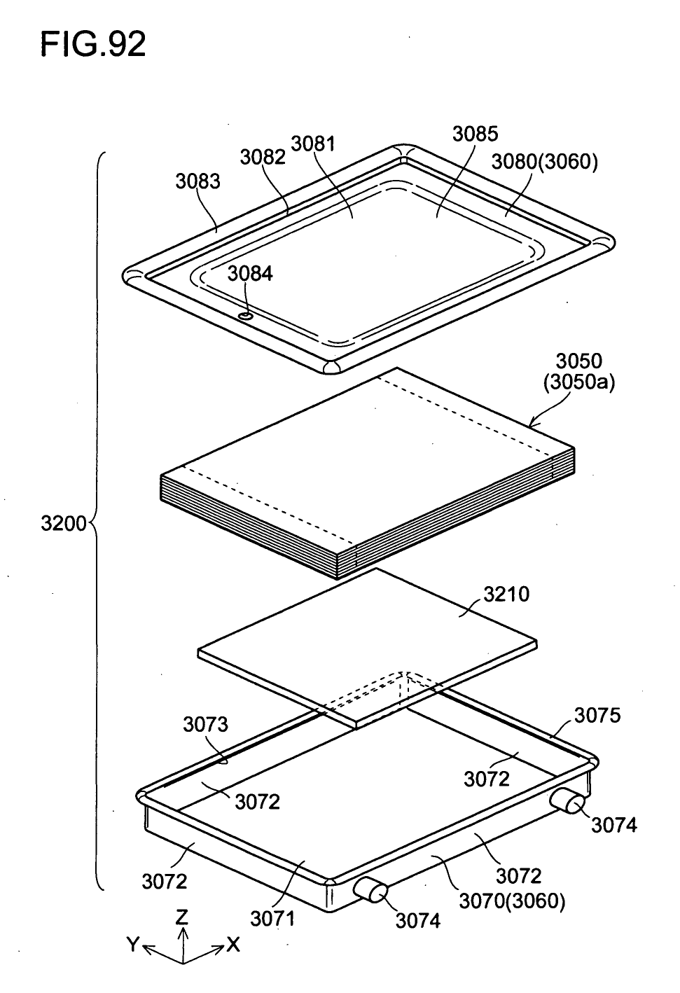

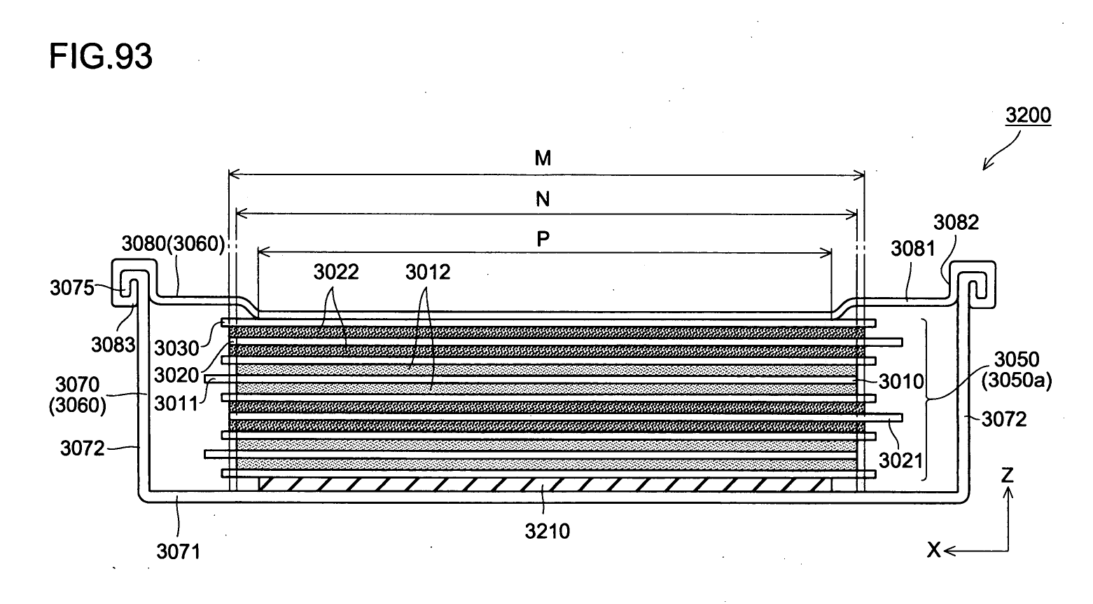

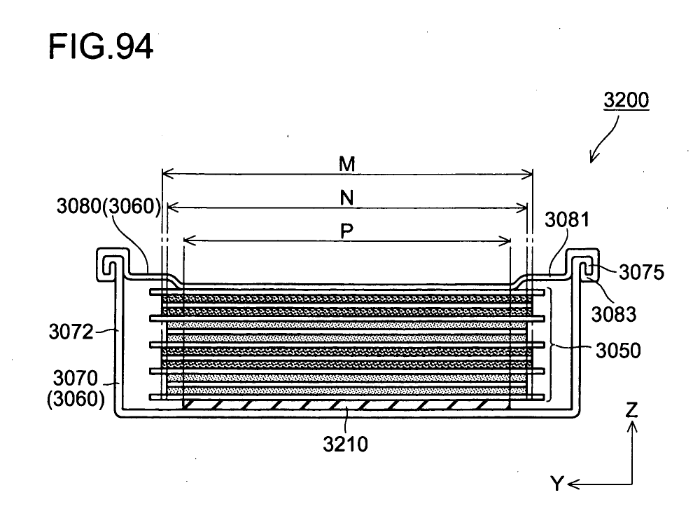

FIG. 92 is an exploded perspective view of a lithium-ion secondary battery according to a fifteenth embodiment (Embodiment 15) of the invention. FIGS. 93 and 94 are sectional views schematically showing the lithium-ion secondary battery according to Embodiment 15 of the invention. Next, with reference to FIGS. 82 to 85, 89, and 92 to 94, the lithium-ion secondary battery 3200 according to Embodiment 15 of the invention will be described. Among the different diagrams, the same components are identified by the same reference signs, and no overlapping description will be repeated unless necessary.

In the lithium-ion secondary battery 3200 according to Embodiment 15, as shown in FIG. 92, a plate-shaped or sheet-shaped resin member 3210 is arranged between the electrode assembly 3050 and the bottom face portion 3071 of the package can 3070. The resin member 3210 is formed of a resin material that swells when soaked with a non-aqueous electrolyte liquid (also referred to as a swelling resin). The resin member 3210 is an example of a “plate-shaped member” according to the invention. Like the swelling resin mentioned in connection with Embodiment 14 described previously, preferably, the swelling resin of which the resin member 3210 is formed contains one or more substances selected from the group consisting of nitrile butadiene rubber (NBR), styrene butadiene rubber (SBR), carboxymethyl cellulose (CMC), polyvinylidene fluoride (PVdF), polyvinyl alcohol (PVA), polyethylene oxide (PEO), propylene oxide, polystyrene, and polymethyl methacrylate.

Moreover, in Embodiment 15, unlike in Embodiment 14 described previously, no swelling resin is dispersed in the active material layers of the electrodes. That is, in Embodiment 15, instead of the swelling of active material layers causing a pressing force to be applied to the electrode assembly 3050, as shown in FIGS. 93 and 94, the swelling of the resin member 3210 arranged between the electrode assembly 3050 and the bottom face portion 3071 of the package can 3070 causes a pressing force to be applied to the electrode assembly 3050 in the stack direction (in the direction of the depth of the package can 3070, which is the Z direction).

Moreover, in Embodiment 15, as shown in FIG. 89, before the injection of non-aqueous electrolyte liquid, the lid plate 3080 and the electrode assembly 3050 are not in contact with each other, but a gap 3095 is left between them. It is preferable that the interval C be set so as to fulfill the formula 0 mm<C<5 mm in Embodiment 14 described previously.

Moreover, as shown in FIGS. 92 to 94, a protruding portion 3085 similar to that in Embodiment 14 described previously is formed on the panel portion 3081 of the lid plate 3080.

The resin member 3210 arranged between the electrode assembly 3050 and the package can 3070 has a substantially rectangular shape as seen in a plan view, and is formed to be smaller in size than the positive electrode active material layer 3012. That is, in Embodiment 15, the resin member 3210 is formed in such a size as to fit within an inward region 3015 of the positive electrode active material layer 3012 a distance “a” away from (inward of) the edges thereof shown in FIG. 83 and within an inward region 3025 of the negative electrode active material layer 3022 a distance “b” away from (inward of) the edges thereof shown in FIG. 85. Specifically, the resin member 3210 is formed, for example, in a shape substantially identical with that of the pressing surface 3085a (see FIG. 89) of the protruding portion 3085 formed on the lid plate 3080.

In the lithium-ion secondary battery 3200 of Embodiment 15 structured as described above, via the resin member 3210, the electrode assembly 3050 is pressed in the stack direction (Z direction), so that the resin member 3210 and the protruding portion 3085 on the lid plate 3080 apply a pressing force within the region 3015 (see FIGS. 82 and 83) of the positive electrode active material layer 3012 and the region 3025 (see FIGS. 84 and 85) of the negative electrode active material layer 3022 excluding the four edge portions 3013 (see FIGS. 82 and 83) of the positive electrode active material layer 3012 (see FIGS. 82 and 83) and the four edge portions 3023 (see FIGS. 84 and 85) of the negative electrode active material layer 3022 (see FIGS. 84 and 85). Thus, in Embodiment 15, the region P in which a pressing force is applied by the swelling of the resin member 3210 is located inside the formation region M of the negative electrode active material layer 3022 and inside the formation region N of the positive electrode active material layer 3012.

In Embodiment 15, the thickness of the resin member 3210 and the interval C (see FIG. 89) of the gap 3095 are adjusted so that the desired pressing force is applied to the electrode assembly 3050 (positive and negative electrodes 3010 and 3020). The thickness of the resin member 3210 is determined with consideration given to the increase in thickness resulting from swelling so that the desired pressing force is applied to the electrode assembly 3050 (positive and negative electrodes 3010 and 3020).

In other respects, the structure of Embodiment 15 is similar to that of Embodiment 14 described previously.

In Embodiment 15, as described above, the resin member 3210 formed of a swelling resin is arranged between the lid plate 3080 and the electrode assembly 3050 so that injecting non-aqueous electrolyte liquid into the package container 3060 causes the resin member 3210 formed of the swelling resin to swell. In this way, it is possible to easily apply a pressing force to the electrode assembly 3050 (positive and negative electrodes 3010 and 3020) housed inside the package container 3060.

Moreover, in Embodiment 15, by fainting the resin member 3210 in such a size as to fit within the region 3015 of the positive electrode active material layer 3012 excluding the edge portions 3013 thereof and within the region 3025 of the positive electrode active material layer 3022 excluding the edge portions 3023 thereof, it is possible to easily apply a pressing force to the region of the positive and negative electrodes 3010 and 3020 excluding the edge portions 3013 and 3023 thereof, and thus to effectively prevent internal short-circuiting. In this way, it is possible to improve cycle characteristics and in addition improve reliability and yields.

Moreover, in Embodiment 15, by arranging the resin member 3210 formed of a resin material between the package can 3070 and the electrode assembly 3050, it is possible to prevent short-circuiting between the package can 3070 and the electrode assembly 3050.

The resin member 3210 may be previously fixed to the bottom face portion 3071 of the package can 3070. By previously fixing the resin member 3210 to the bottom face portion 3071 of the package can 3070 in this way, it is possible to prevent displacement of the resin member 3210, and thus it is possible to more easily apply, via the resin member 3210, a pressing force within the region 3015 (see FIG. 83) of the positive electrode active material layer 3012 and within the region 3025 (see FIG. 85) of the negative electrode active material layer 3022.

In other respects, the benefits of Embodiment 15 are similar to those of Embodiment 14 described previously.

### EMBODIMENT 16

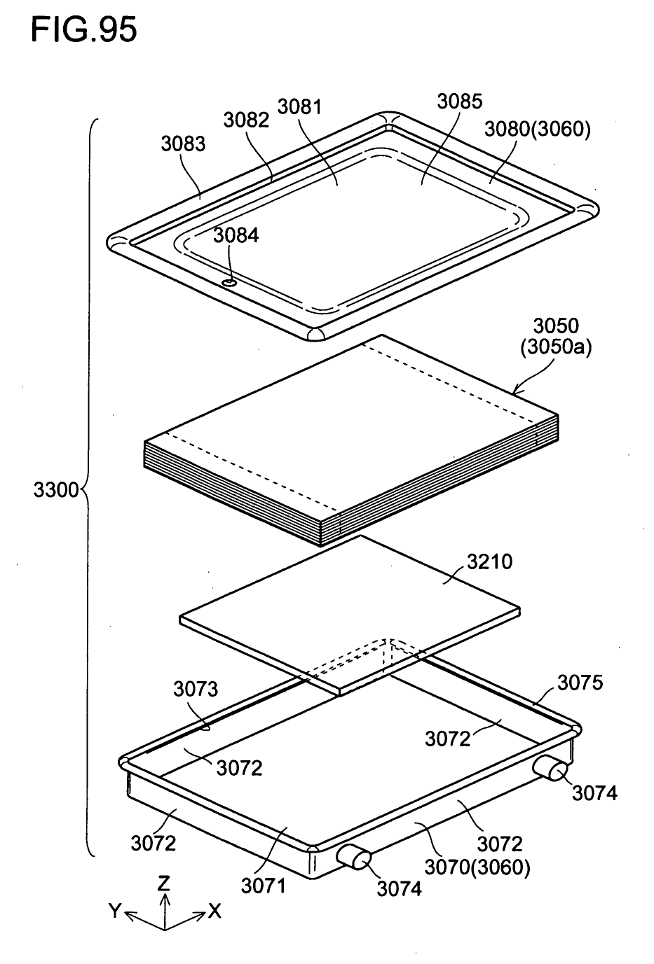

FIG. 95 is an exploded perspective view of a lithium-ion secondary battery according to a sixteenth embodiment (Embodiment 16) of the invention. Next, with reference to FIGS. 89 and 95, the lithium-ion secondary battery 3300 according to Embodiment 16 of the invention will be described. In FIG. 95, such components as find their counterparts in other drawings are identified by the same reference signs, and no overlapping description will be repeated unless necessary.

The lithium-ion secondary battery 3300 according to Embodiment 16 has a structure which is a combination of the structures of Embodiments 14 and 15 described previously. Specifically, as shown in FIG. 95, a plate-shaped or sheet-shaped resin member 3210 is arranged between the electrode assembly 3050 (stacked member 3050a) and the bottom face portion 3071 of the package can 3070. In addition, a swelling resin that swells when soaked with a non-aqueous electrolyte liquid is dispersed in the active material layers of the electrodes. Thus, in Embodiment 16, the swelling of the active material layers and the swelling of the resin member 3210 cause a pressing force to be applied to the electrode assembly 3050 in the stack direction (in the direction of the depth of the package can 3070).

In Embodiment 16, the amount of swelling resin dispersed in the active material layers, the thickness of the resin member 3210, and the interval C (see FIG. 89) of the gap 3095 are adjusted so that the desired pressing force is applied to the electrode assembly 3050 (positive and negative electrodes 3010 and 3020).

In other respects, the structure of Embodiment 16 is similar to those of Embodiments 14 and 15 described previously. In other respects, the benefits of Embodiment 16 are similar to those of Embodiments 14 and 15 described previously.

### EMBODIMENT 17

A lithium-ion secondary battery according to a seventeenth embodiment (Embodiment 17), unlike those of Embodiments 14 to 16 described previously, is so structured that the swelling of separators causes a pressing force to be applied to the electrode assembly in the stack direction. That is, in Embodiment 17, the separators are formed of a swelling resin that swells when soaked with a non-aqueous electrolyte liquid. Usable as the swelling resin here are similar to those usable in Embodiments 14 to 16.

The separators may be formed of swelling resins of varying compositions so that part of the separators have a rate of swelling different from that of other separators. Only part of the separators may be formed of a swelling resin to give those separators the function of applying a pressing force to the electrode assembly. Part of the separators may be given a thickness different from that of other separators so that swelling causes them to thicken by a different amount.

Specifically, for example, the separators arranged at the outermost sides of the electrode assembly may be given a greater rate of swelling than the other separators; or the separators arranged at the outermost sides of the electrode assembly may be given a greater thickness than the other separators. For another example, stacks of a plurality of separators may be arranged at the outermost sides of the electrode assembly.

In other respects, the structure of Embodiment 17 is similar to those of Embodiments 14 to 16 described previously. Any of the structures of Embodiments 14 to 16 may be combined with the structure of Embodiment 17.

As described above, in Embodiment 17, by forming separators out of a swelling resin and making the separators formed of the swelling resin swell, it is possible to easily apply a pressing force to the electrode assembly housed inside the package container.

As mentioned above, by changing the thickness, rate of swelling, etc. of part of the separators, it is possible to make the adjustment of the pressing force applied to the electrode assembly easy.

In other respects, the benefits of Embodiment 17 are similar to those of Embodiments 14 to 16 described previously.

The invention will now be described by way of practical examples. It should be understood that these practical examples are in no way meant to limit the scope of the invention.

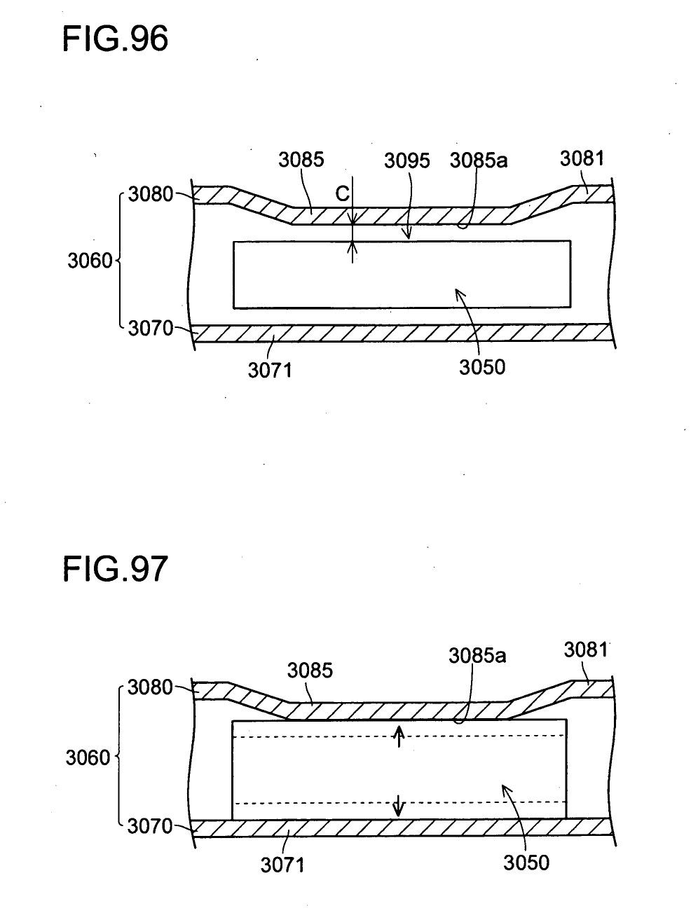

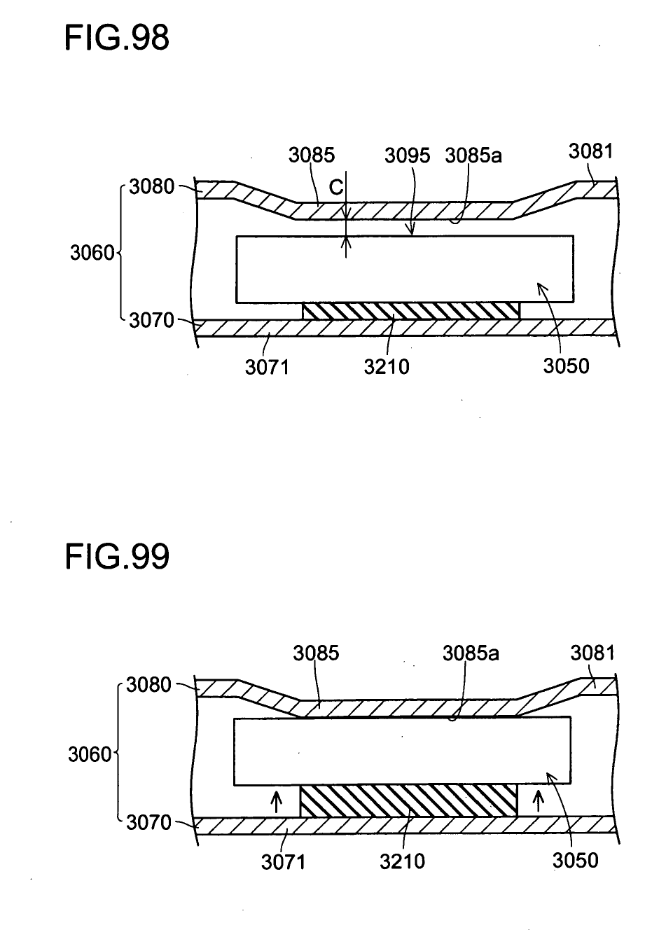

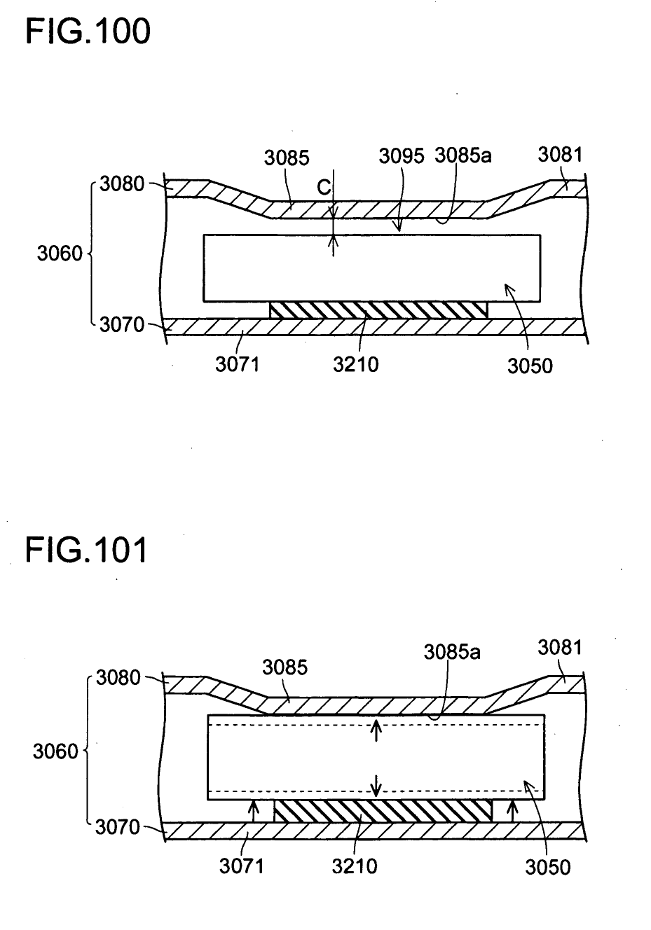

Fabricated were lithium-ion secondary batteries of Practical Examples 14 to 16, which correspond to Embodiments 14 to 16, respectively, described above, and a lithium-ion secondary battery of Comparative Example 4. FIGS. 96 and 97 are partial sectional views showing the lithium-ion secondary batteries of Practical Example 14 in simplified form. FIGS. 98 and 99 are partial sectional views showing the lithium-ion secondary batteries of Practical Example 15 in simplified form. FIGS. 100 and 101 are partial sectional views showing the lithium-ion secondary batteries of Practical Example 16 in simplified form. FIGS. 96, 98, and 100 show the state before injection of non-aqueous electrolyte liquid, and FIGS. 97, 99, and 101 show the state after injection of non-aqueous electrolyte liquid

### PRACTICAL EXAMPLE 14

In Practical Example 14, as shown in FIGS. 96 and 97, a swelling resin was dispersed in the active material layers of the electrodes so that, after injection of non-aqueous electrolyte liquid, the active material layers of the electrode swelled and, as a result of this swelling of the active material layers being restricted by the lid plate 3080 and the package can 3070, a pressing force was applied to the electrode assembly 3050. That is, in Practical Example 14, a swelling resin was additionally dispersed in the active material layers of the electrodes, the fabrication of which will be described later. Moreover, in Practical Example 14, a protruding portion 3085 was formed on the lid plate 3080 so that the pressing force was applied to the region of the positive and negative electrode active material layers excluding the four edge portions thereof. Specifically, the pressing force was applied to an inward region of the positive electrode active material layer a distance of 2 mm away from (inward of) the edges thereof. Used as the swelling resin dispersed in the active material layers was polyethylene oxide. Moreover, the swelling resin was dispersed in the negative electrode active material layer such that the electrode assembly 3050, if let to swell freely, would swell to thicken by about 3 mm. The interval. C of the gap 3095 between the electrode assembly 3050 and the lid plate 3080 was set to be about 2 mm.

### PRACTICAL EXAMPLE 15

In Practical Example 15, as shown in FIGS. 98 and 99, a resin member 3210 formed of a swelling resin was arranged between the electrode assembly 3050 and the package can 3070 so that the swelling of the resin member 3210 caused a pressing force to be applied to the electrode assembly 3050. The resin member 3210 was formed of nitrile butadiene rubber. The resin member 3210 was formed in such a size as to correspond to an inward region of the positive electrode active material layer a distance of 3 mm away from the edges thereof. A protruding portion 3085 similar to that in Practical Example 14 was formed on the lid plate 3080. The resin member 3210 was given a thickness of about 1 mm, and the interval C of the gap 3095 between the electrode assembly 3050 and the lid plate 3080 was set to be about 1.5 mm.

### PRACTICAL EXAMPLE 16

In Practical Example 16, as shown in FIGS. 100 and 101, a swelling resin was dispersed in the active material layers of the electrodes, and in addition a resin member 3210 formed of a swelling resin was arranged between the electrode assembly 3050 and the package can 3070. The swelling of the active material layers and of the resin member 3210 caused a pressing force to be applied to the electrode assembly 3050. Used as the swelling resin dispersed in the active material layers was, as in Practical Example 14, polyethylene oxide. That is, in Practical Example 16, the swelling resin was additionally dispersed in the active material layers of the electrodes, the fabrication of which will be described later. The resin member 3210 was formed of, as in Practical Example 15, nitrile butadiene rubber. A protruding portion 3085 similar to that in Practical Example 14 was formed on the lid plate 3080. The swelling resin was dispersed in the negative electrode active material layer such that the electrode assembly 3050 would swell to thicken by about 2 mm. The resin member 3210 was given a thickness of about 0.5 mm, and the interval C of the gap 3095 between the electrode assembly 3050 and the lid plate 3080 was set to be about 1.5 mm.

### COMPARATIVE EXAMPLE 4

As Comparative Example 4, a lithium-ion secondary battery was fabricated in a similar manner in all aspects except that the lid plate and the package can applied no pressing force to the electrode assembly.

### PROCESSES COMMON TO PRACTICAL EXAMPLES 14 TO 16 AND COMPARATIVE EXAMPLE 4

Fabrication of the Positive Electrodes

First, 90 parts by weight of LiFePO₄ as an active material, 50 parts by weight of acetylene black as a conductive agent, and 5 parts by weight of polyvinyl idene fluoride as a binding agent were blended, and then an adequate amount of N-methyl-2-pyrrolidone was added to and dispersed in the blend; in this way, a positive electrode composite agent slurry was prepared. Next, the positive electrode composite agent slurry was applied evenly to a charge collector (positive electrode charge collector) of foamed aluminum with a thickness of 1 mm, and was then dried; thereafter, the product was compressed on a roll press so as to have a thickness of 500 μm. Lastly, the product was cut to the desired size; in this way, a positive electrode (positive electrode plate) for Practical Examples 14 to 16 and Comparative Example 4 was fabricated. The size of the region over which the positive electrode active material layer was applied was 146 mm longitudinally by 196 mm laterally, and the size of the positive electrode (positive electrode charge collector) was 146 mm longitudinally by 208 mm laterally.

Fabrication of the Negative Electrodes

First, 90 parts by weight of natural graphite (natural graphite occurring in China) and 10 parts by weight of polyvinylidene fluoride were blended, and then an adequate amount of N-methyl-2-pyrrolidone was added to and dispersed in the blend; in this way, a negative electrode composite agent slurry was prepared. Next, the negative electrode composite agent slurry was applied evenly to a charge collector (negative electrode charge collector) of foamed nickel with a thickness of 1 mm, and was then dried; thereafter, the product was compressed on a roll press so as to have a thickness of 500 μm. Lastly, the product was cut to the desired size; in this way, a negative electrode (negative electrode plate) for Practical Examples 14 to 16 and Comparative Example 4 was fabricated. The size of the region over which the negative electrode active material layer was applied was 150 mm longitudinally by 200 mm laterally, and the size of the negative electrode (negative electrode charge collector) was 150 mm longitudinally by 210 mm laterally.

Preparation of the Non-aqueous Electrolyte Liquid

1 mol/L of LiPF₆ was dissolved in a mixture liquid of ethylene carbonate (EC) and diethyl carbonate (DEC) mixed in a ratio of 30:70 by volume; in this way, a non-aqueous electrolyte liquid was prepared.

Assembly of the Secondary Battery

Positive electrode plates and negative electrode plates were stacked with separators interposed between them in the order a positive electrode, a separator, a negative electrode, a separator, and so forth, and in this way, an electrode assembly (stacked member) was formed. Here, so that negative electrode plates might be located outside positive electrode plates, 24 positive electrode plates and 25 negative electrode plates were used. Moreover, 50 separators were used so that separators might be located at the outermost sides of the electrode assembly (stacked member).

The separators were formed of microporous film of polyethylene with a thickness of 20 μm. The size of the separators was 154 mm longitudinally by 206 mm laterally so as to be larger than the size over which the active material layers were applied to the positive and negative electrode plates.

For the package container, a package can and a lid plate were formed by processing a nickel-plated steel plate with a thickness of about 1.0 mm. The package can had the following inside dimensions: 164 mm longitudinally by 228 mm laterally by 20 mm in depth. Then, the electrode assembly (stacked member) was housed in the package can, the lid plate was placed on top, and the battery was sealed therewith by a double seam.

Next, through a filling hole with a diameter of 2 mm previously provided in the lid plate, a predetermined amount of non-aqueous electrolyte liquid was injected under reduced pressure. After the injection, a metal ball with substantially the same diameter as the filling hole was placed in the filling hole, and the filling hole was stopped by electric resistance welding. In this way, 30 samples each of Practical Examples 14 to 16 and Comparative Example 4 were fabricated. It should be noted that whereas in Practical Examples 14 to 16, injecting the non-aqueous electrolyte liquid caused the swelling resin to swell so that a pressing force was applied to the electrode assembly, in Comparative Example 4 no pressing force was applied to the electrode assembly.

The samples of the lithium-ion secondary batteries of Practical Examples 14 to 16 and Comparative Example 4 fabricated as described above were inspected for screening of defective from functioning batteries. If a battery yielded 0 volts at the stage of fabrication (assembly), internal short-circuiting was considered to have occurred. Accordingly, such batteries were screened out as defective. Batteries that were found to be functioning were subjected to characteristics evaluation.

Specifically, with the batteries that remained after the screening of defective ones, the battery capacity (initial-charge battery capacity) was measured by subjecting them to constant-current, constant-voltage charging up to 3.5 V for 5 hours followed by constant-current discharging down to 2 V. Thereafter, the batteries were subjected to cycle tests under the just-mentioned charging and discharging conditions in a temperature environment of 45° C. After 200 cycles, the discharge capacity was measured, and the battery capacity at this time was divided by the discharge capacity on cycle 1 (initial-charge battery capacity) to determine the proportion (capacity retention rate) as the basis for evaluation.

The batteries that were subjected to the cycle tests were then subjected to vibration tests to calculate the capacity retention rate after the vibration tests. Specifically, the batteries for which the discharge capacity after 200 cycles was measured were charged again up to the fully charged state. The batteries in the fully charged state were mounted on a vibrating machine, where the batteries were subjected to vibration in one direction (the lengthwise direction, which is the X direction) under a frequency condition of 10 Hz to 55 Hz for 8 hours. Then, the discharge capacity of the batteries was measured and was divided by the charge capacity to calculate the proportion as the capacity retention rate (%).

The results are shown in Table 2 below. In Table 2, given in the column of the capacity retention rate after 200 cycles are example-by-example average values with the batteries subjected to the cycle tests; given in the column of the capacity retention rate after vibration tests are example-by-example average values with the batteries subjected to the vibration tests.

TABLE 2

| | | Capacity | Capacity |
|---|---|---|---|
| | Number of | Retention | Retention Rate |
| | Defective | Rate After 200 | After Vibration |
| | Batteries | Cycles (%) | Tests (%) |
| Practical Example 14 | 1 | 93 | 98 |
| Practical Example 15 | 0 | 92 | 96 |
| Practical Example 16 | 0 | 91 | 95 |
| Comparative Example 4 | 5 | 84 | 86 |

Table 2 reveals the following. Practical Examples 14 to 16, where the swelling of the swelling resin applied a pressing force to the positive and negative electrodes (positive and negative electrode active material layers), produced less defective batteries than Comparative Example 4, where no pressing force was applied. Specifically, whereas Practical Example 14 produced one defective battery and Practical Examples 15 and 16 produced no defective battery, Comparative Example 4 produced 5, that is, far more defective batteries.

The reason is considered to have been as follows. In Practical Examples 14 to 16, when the pressing force was applied to the electrode assembly (positive and negative electrodes), it was applied to region of the positive and negative electrode active material layers excluding the edge portions thereof, and this prevented internal short-circuiting resulting from burrs and the like. It is considered that, in Comparative Example 4, as a result of no pressing force being applied to the electrode assembly, no pressing force was applied to the edge portions of the positive and negative electrode active material layers, and as a result of no pressing force being applied to the electrode assembly, displacement of the electrode assembly (positive and negative electrodes) was more likely. If displacement of the electrodes occurred during assembly of the battery, internal short-circuiting resulting from displacement of the electrodes was more likely to occur. This is considered to have been the reason that Comparative Example 4 produced more defective batteries than Practical Examples 14 to 16.

Table 2 also reveals the following. Practical Examples 14 to 16 achieved higher capacity retention rates after 200 cycles than Comparative Example 4. Specifically, Practical Example 14 achieved a capacity retention rate of 93% after 200 cycles, Practical Example 15 achieved a capacity retention rate of 92% after 200 cycles, and Practical Example 16 achieved a capacity retention rate of 91% after 200 cycles; thus, these practical examples all achieved capacity retention rates as high as 90% or more. The reason that Practical Examples 14 to 16 achieved these high capacity retention rates is considered to have been that, as a result of a pressing force being applied to the positive and negative electrode active material layers, the positive and negative electrodes (positive and negative electrode active material layers) were held closely together and in addition displacement of the electrodes was prevented. By contrast, Comparative Example 4 gave a far lower capacity retention rate of 84%. A probable reason for this is considered to have been that, as the active material layers expanded and contracted during charging and discharging of the battery, displacement of positive and negative electrodes occurred and internal short-circuiting (micro-short-circuiting) occurred in, for example, the edge portions (end portions) of the electrodes. That is, it is considered that, in Comparative Example 4, where, unlike in the practical examples, no pressing force was applied to the electrode assembly (positive and negative electrodes), displacement of the positive and negative electrodes was more likely and this resulted in a low capacity retention rate after 200 cycles.

Table 2 further reveals the following. Practical Examples 14 to 16 also achieved higher capacity retention rates after vibration tests than. Comparative Example 4. Specifically, Practical Example 14 achieved a capacity retention rate of 98% after vibration tests, Practical Example 15 achieved a capacity retention rate of 96% after vibration tests, and Practical Example 16 achieved a capacity retention rate of 95% after vibration tests; thus, these practical examples all achieved capacity retention rates as high as 95% or more, and showed almost no lowering in capacity. By contrast, Comparative Example 4 gave a capacity retention rate of 86% after vibration tests, showing a remarkable lowering in capacity retention rate due to vibration. The reasons are considered to have been as follows. In Practical Examples 14 to 16, the application of the pressing force to the electrode assembly kept the positive and negative electrodes fixed inside the package can, and this made displacement of the electrodes less likely under vibration. By contrast, in Comparative Example 4, since no pressing force was applied to the electrode assembly, displacement of the electrodes occurred under vibration, and this resulted in a low capacity retention rate.

Thus, the following has been confirmed. By making a swelling resin swell by injection of non-aqueous electrolyte liquid and thereby applying a pressing force to the electrode assembly (positive and negative electrodes), it is possible to improve life characteristics and reliability. Moreover, when applying the pressing force, by applying it to region of the positive and negative electrode active material layers (positive and negative electrodes) excluding the edge portions thereof, it is possible to prevent internal short-circuiting during assembly of the battery and thereby improve yields.

It should be understood that all the embodiments and examples presented herein are in every respect illustrative and not restrictive. The scope of the present invention is defined not by the embodiments and examples described above but by the appended claims, and the invention encompasses any variations and modifications in the sense and scope equivalent to those of the claims.

For example, although Embodiments 1 to 17 described above deal with examples where the invention is applied to a lithium-ion secondary battery (non-aqueous electrolyte secondary battery) as an example of a secondary battery, this is not meant to limit the invention; the invention may be applied to a non-aqueous electrolyte secondary battery other than a lithium-ion secondary battery, and may also be applied to a secondary battery other than a non-aqueous electrolyte secondary battery. The invention is applicable even to secondary batteries that are yet to be developed.

Although Embodiments 1 to 17 described above deal with examples where a pressing force is applied to an inward region of the positive electrode active material layer and an inward region of the negative electrode active material layer excluding the four edge portions of the positive electrode active material layer and the four edge portions of the negative electrode active material layer, this is not meant to limit the invention; the region in which a pressing force is applied to the electrode assembly has only to be a region of the active material layers excluding at least part of the edge portions of the positive electrode or a region of the active material layers excluding at least part of the edge portions of the negative electrode. For example, the pressing force may be applied to an inward region of the positive electrode active material layer and an inward region of the negative electrode active material layer excluding three edge portions of the positive electrode active material layer and three edge portions of the negative electrode active material layer. In that case, for example, the pressing force may be applied to one of the two edge portions of the positive electrode active material layer along the Y direction (the edge portion where the charge collector-exposed portion is located). Likewise, for example, the pressing force may be applied to one of the two edge portions of the negative electrode active material layer along the Y direction (the edge portion where the charge collector-exposed portion is located). For other examples, the pressing force may be applied to part of edges parts of the positive and negative electrodes, or may be applied to at least one of the four edge portions thereof. The pressing force applied can be adjusted appropriately so that the desired pressing force is obtained.

Although. Embodiments 1 to 17 described above deal with examples where an active material layer is formed on both sides of a charge collector, this is not meant to limit the invention; an active material layer may be formed on only one side of a charge collector. The electrode assembly may partly include electrodes (positive, negative) having an active material layer formed on only one side of a charge collector. In Embodiments 1 to 13, a swelling resin that swells when soaked with a non-aqueous electrolyte liquid may be dispersed in the active material layer of electrodes. Usable as the swelling resin is, for example, one containing one or more substances selected from the group consisting of nitrile butadiene rubber (NBR), styrene butadiene rubber (SBR), carboxymethyl cellulose (CMC), polyvinylidene fluoride (PVdF), polyvinyl alcohol (PVA), polyethylene oxide (PEO), propylene oxide, polystyrene, and polymethyl methacrylate.

Although Embodiments 1 to 17 described above deal with examples where a non-aqueous electrolyte liquid is used as the electrolyte of the secondary battery, this is not meant to limit the invention; any other type of electrolyte than a non-aqueous electrolyte liquid may instead be used, for example, a gel electrolyte, high-polymer solid electrolyte, inorganic solid electrolyte, molten salt, or the like.

Although Embodiments 1 to 17 described above deal with examples where the opening of the package can is sealed with the lid plate by a double seam, this is not meant to limit the invention; the opening of the package can may be sealed by any other method than double-seam sealing. For example, the opening of the package can may be sealed by welding the lid plate to the package can.

Although Embodiments 1 to 17 described above deal with examples where the negative electrode (negative electrode active material layer) is made larger than the positive electrode (positive electrode active material layer), this is not meant to limit the invention; the positive and negative electrodes (positive and negative electrode active material layers) may be made the same size, or the positive electrode (positive electrode active material layer) may be made larger than the negative electrode (negative electrode active material layer). In that case, it is preferable that the region in which the pressing force is applied to the electrodes (electrode assembly) be a region 1 mm or more away from the edges of whichever of the positive and negative electrodes is smaller. In a case where the negative electrode is smaller than the positive electrode, the area over which the pressing force is applied may be 10% or more but 99% or less of the application area of the negative electrode active material layer.

Although Embodiments 1 to 17 described above deal with examples where the positive and negative electrodes are arranged so that the charge collector-exposed portion of the positive electrodes and the charge collector-exposed portion of the negative electrodes are located at opposite sides, this is not meant to limit the invention; the positive and negative electrodes may be arranged so that the charge collector-exposed portion of the positive electrodes and the charge collector-exposed portion of the negative electrodes are located at the same side.

Although Embodiments 1 to 17 described above deal with examples where a charge collector-exposed portion is formed at one end of charge collectors, this is not meant to limit the invention; a charge collector-exposed portion may be formed, for example, at each end of charge collectors.

Although Embodiments 1 to 13 described above deal with examples where the invention is applied to a lithium-ion secondary battery of a stacked type, this is not meant to limit the invention; the invention may be applied to a lithium-ion secondary battery of a wound type.

Although Embodiments 1 to 13 described above deal with examples where the package can and the lid plate apply a pressing force to the electrode assembly (positive and negative electrodes), this is not meant to limit the invention; any other member than the package can and the lid plate may apply a pressing force to the electrode assembly. For example, the electrode assembly may be held between plate-shaped members so that a pressing force is applied to it, and the electrode assembly thus having the pressing force applied to it may then be housed inside the package can. Needless to say, in that case, the region in which the pressing force is applied to the electrode assembly is a region of the active material layers excluding the edge portions (end portions) of the electrodes.

In Embodiments 1 to 13 described above, the shape, size, etc. of the protruding portion, the pressing member, etc. may be changed (set) in many ways so long as they can press a region of the active material layers excluding at least part of the edge portions of the positive and negative electrodes. Moreover, the amount of protrusion of the protruding portion, the thickness of the pressing member, etc. may be adjusted appropriately so that the desired pressing force is applied to the electrodes (positive and negative electrodes). Furthermore, the size, shape, etc. of the package can may be changed (set) in many ways.

The features of Embodiments 1 to 13 described above may be combined appropriately.

Although Embodiments 1 to 6 and 11 to 13 described above deal with examples where a protruding portion is formed on the lid plate and/or the package can integrally therewith, this is not meant to limit the invention; the protruding portion may be formed as a separate member.

Although Embodiments 3, 5, 6, and 11 to 13 described above deal with examples where two protruding portions are formed on the lid plate, this is not meant to limit the invention; three or more protruding portions may be formed on the lid plate.

Although Embodiments 4, 5, 11, and 12 described above deal with examples where two protruding portions are formed on the bottom face portion of the package can, this is not meant to limit the invention; three or more protruding portions may be formed on the lid plate.

In Embodiments 7 to 9, 11, and 12 described above, the pressing member and the insulating member may be previously bonded (fixed) to the lid plate or the package can. The pressing member and the insulating member may be formed directly on the lid plate or the package can by, for example, printing.

Although Embodiments 7 to 9 described above deal with examples where pressing members are arranged, respectively, between the lid plate and the electrode assembly and between the package can and the electrode assembly, this is not meant to limit the invention; a pressing member may be arranged either between the lid plate and the electrode assembly and between the package can and the electrode assembly.

In Embodiments 7 to 9 described above, the pressing member may be formed of an electrically conductive material such as metal. In that case, it is preferable that the pressing member have its surface insulation-coated.

Although Embodiment 8 described above deals with an example where three pressing members are arranged between the lid plate and the electrode assembly, this is not meant to limit the invention; the number of pressing members may be two, or four or more. A plurality of pressing members may be arranged between the package can and the electrode assembly. Here, it is possible to arrange a plurality of pressing members either between the lid plate an the electrode assembly or between the package can and the electrode assembly, or to arrange a plurality of pressing members both between the lid plate an the electrode assembly and between the package can and the electrode assembly.

Although Embodiment 9 described above deals with an example where the groove portions in the lid plate and the package can are given X- and Y-direction lengths smaller than those of the pressing members, this is not meant to limit the invention; the groove portions may be given either an X- or Y-direction length greater than that of the pressing members.

Although Embodiment 10 described above deals with an example where receding portions are formed in both the lid plate and the package can, this is not meant to limit the invention; a receding portion may be formed in either the lid plate or the package can alone.

Although Embodiment 11 described above deals with an example where an insulating member is arranged only between the lid plate and the electrode assembly, this is not meant to limit the invention; insulating members may be arranged both between the lid plate and the electrode assembly and between the package can and the electrode assembly, or an insulating member may be arranged only between the package can and the electrode assembly.

Although Embodiment 12 described above deals with an example where insulating members are arranged both between the protruding portion on the lid plate and the electrode assembly and between the protruding portion on the package can and the electrode assembly, this is not meant to limit the invention; an insulating member may be arranged either between the protruding portion on the lid plate and the electrode assembly or between the protruding portion on the package can and the electrode assembly.

Although Embodiment 13 described above deals with an example where a protruding portion having a curved pressing surface is formed only on the lid plate, this is not meant to limit the invention; such protruding portions may be formed on both the lid plate and the package can, or such a protruding portion may be formed only on the package can. It is also possible to form a protruding portion having a curved pressing surface on one of the lid plate and the package can and a protruding portion having a substantially flat pressing surface on the other.

Although Embodiments 14 to 17 described above deal with examples where a protruding portion is formed on the lid plate, this is not meant to limit the invention; instead of a protruding portion being formed on the lid plate, a protruding portion may be formed on the bottom face portion of the package can. Protruding portions may be formed both on the lid plate and on the bottom face portion of the package can.

In Embodiments 14 to 17 described above, the shape, size, amount of protrusion, etc. of the protruding portion may be changed (set) in many ways. Moreover, the size, shape, etc. of the package can may be changed (set) in many ways.

The features of Embodiments 14 to 17 described above may be combined appropriately.

Although Embodiments 14 to 17 described above deal with examples where injection of non-aqueous electrolyte liquid causes the swelling resin to swell so as to apply a pressing force to the electrode assembly (stacked member), this is not meant to limit the invention; instead, a swelling resin previously soaked with electrolyte liquid (electrolyte) may be used to apply a pressing force to the electrode assembly (stacked member).

Although Embodiments 14 to 17 described above deal with examples where a protruding portion is formed on the lid plate integrally therewith, this is not meant to limit the invention; the protruding portion may be formed as a separate member. Likewise, in a case where a protruding portion is formed on the bottom face portion of the package can, the protruding portion may be formed as a separate member. A protruding portion may be formed on the bottom face portion of the package can integrally therewith.

Although Embodiments 14 to 17 described above deal with examples where one protruding portion is formed on the lid plate, this is not meant to limit the invention; two or more protruding portions may be formed on the lid plate. Likewise, in a case where a protruding portion is formed on the bottom face portion of the package can, two or more protruding portions may be formed.

Although Embodiments 15 and 16 described above deal with examples where a resin member formed of a swelling resin is arranged between the electrode assembly and the bottom face portion of the package can, this is not meant to limit the invention; a resin member may be arranged between the electrode assembly and the lid plate, or resin members may be arranged both between the electrode assembly and the bottom face portion of the package can and between the electrode assembly and the lid plate.

In Embodiments 15 and 16 described above, no protruding portion may be formed on the lid plate.

In Embodiments 15 and 16 described above, a plurality of resin members formed of a swelling resin may be arranged in a stack between the electrode assembly and the bottom face portion of the package can. A plurality of resin members may be arranged in a parallel array (side by side) between the electrode assembly and the bottom face portion of the package can. Similar structures may be adopted also in a case where a resin member is arranged between the electrode assembly and the lid plate.

The invention encompasses, in its technical scope, any embodiments achieved by appropriately combining technical features from different embodiments and examples presented above.

What is claimed is:

1. A secondary battery comprising:
a positive electrode which includes a positive electrode active material layer;
a negative electrode which includes a negative electrode active material layer and which is arranged to face the positive electrode;
a housing container in which the positive and negative electrodes are housed; and
a lid member which seals an opening of the housing container, wherein
the positive and negative electrodes have edge portions respectively, and are housed in the housing container with a pressing force applied to a region of the positive and negative electrode active material layers excluding at least part of the edge portions.

2. The secondary battery according to claim 1, further comprising a swelling resin that swells when soaked with an electrolyte liquid.

3. The secondary battery according to claim 1, wherein a swelling resin that swells when soaked with an electrolyte liquid is dispersed.

4. The secondary battery according to claim 1, further comprising a swelling resin that swells when soaked with an electrolyte liquid, wherein the swelling resin is formed in a shape of a plate.

5. The secondary battery according to claim 1, wherein the positive and negative electrodes have the pressing force applied to a region thereof excluding edge portions of the positive and negative electrode active material layers respectively.

6. The secondary battery according to claim 1, wherein the positive and negative electrodes have the pressing force applied to a region of the positive and negative electrode active material layers by the housing container and the lid member.

7. The secondary battery according to claim 1, further comprising a separator which is arranged between the positive and negative electrodes, wherein a stacked member is formed by sequentially stacking the positive electrode, the separator, and the negative electrode, and
the stacked member has the pressing force applied thereto in a stack direction by the housing container and the lid member.

8. The secondary battery according to claim 7, wherein
the stacked member has a plurality of positive electrodes as the positive electrode and a plurality of negative electrodes as the negative electrode, and
the positive and negative electrodes are stacked alternately.

9. The secondary battery according to claim 1, wherein the region of the positive and negative electrodes to which the pressing force is applied is a region 1 mm or more inward of edges of the positive electrode active material layer or 1 mm or more inward of edges of the negative electrode active material layer.

10. The secondary battery according to claim 1, wherein
the positive electrode active material layer has a smaller planar area than the negative electrode active material layer, and
the region of the positive and negative electrodes to which the pressing force is applied is a region 1 mm or more inward of edges of the positive electrode active material layer.

11. The secondary battery according to claim 1, wherein the pressing force is applied to a region of the positive and negative electrode active material layers 5 mm or more inward of edges thereof.

12. The secondary battery according to claim 1, wherein an area of the region of the positive and negative electrodes to which the pressing force is applied is 10% or more but 99% or less of a planar area of the positive electrode active material layer.

13. The secondary battery according to claim 1, wherein an area of the region of the positive and negative electrodes to which the pressing force is applied is 20% or more but 98% or less of a planar area of the positive electrode active material layer.

14. The secondary battery according to claim 1, wherein the housing container and the lid member are each formed of a metal material.

15. The secondary battery according to claim 1, wherein
the positive and negative electrodes are arranged to face the lid member,
the lid member has a first protruding portion which protrudes toward the positive and negative electrodes, and
the first protruding portion applies the pressing force to the positive and negative electrodes.

16. The secondary battery according to claim 15, wherein, as the first protruding portion, a plurality of first protruding portions are formed on the lid member.

17. The secondary battery according to claim 15, wherein the first protruding portion is formed integrally with the lid member.

18. The secondary battery according to claim 15, wherein the first protruding portion has a substantially flat pressing surface which applies the pressing force to the positive and negative electrodes.

19. The secondary battery according to claim 1, wherein
the housing container has a bottom face portion which faces the positive and negative electrodes,
the bottom face portion of the housing container has a second protruding portion which protrudes toward the positive and negative electrodes, and
the second protruding portion applies the pressing force to the positive and negative electrodes.

20. The secondary battery according to claim 19, wherein, as the second protruding portion, a plurality of second protruding portions are formed on the bottom face portion of the housing container.

21. The secondary battery according to claim 19, wherein the second protruding portion is formed integrally with the bottom face portion of the housing container.

22. The secondary battery according to claim 19, wherein the second protruding portion has a substantially flat pressing surface which applies the pressing force to the positive and negative electrodes.

23. The secondary battery according to claim 19, wherein
the positive and negative electrodes are arranged to face the lid member,
the lid member has a first protruding portion which protrudes toward the positive and negative electrodes, and
the second protruding portion is formed in a position corresponding to the first protruding portion.

24. The secondary battery according to claim 1, wherein
the positive and negative electrodes are arranged to face the lid member,
the housing container has a bottom face portion which faces the positive and negative electrodes, and
a pressing member which applies the pressing force to the positive and negative electrodes is arranged either or both between the positive and negative electrodes and the lid member or/and between the positive and negative electrodes and the bottom face portion of the housing container.

25. The secondary battery according to claim 24, wherein the pressing member is formed of an insulating material.

26. The secondary battery according to claim 24, wherein the pressing member is formed of a high-polymer material.

27. The secondary battery according to claim 24, wherein, as the pressing member, pressing members are arranged respectively between the positive and negative electrodes and the lid member and between the positive and negative electrodes and the bottom face portion of the housing container.

28. The secondary battery according to claim 1, wherein
the positive and negative electrodes are arranged to face the lid member, and
on a side of the lid member facing an inside of the battery, a first receding portion is formed to cover edge portions of the positive and negative electrode active material layers respectively as seen in a plan view.

29. The secondary battery according to claim 1, wherein
the housing container has a bottom face portion which faces the positive and negative electrodes, and
on a side of the bottom face portion of the housing container facing an inside of the battery, a second receding portion is formed to cover edge portions of the positive and negative electrode active material layers respectively as seen in a plan view.

30. The secondary battery according to claim 1, wherein at least one of the housing container and the lid member has a surface thereof facing an inside of the battery coated with a high-polymer-laminated material.

31. The secondary battery according to claim 1, wherein
the housing container is formed in a shape of a box, a face thereof with a greatest area being the bottom face portion, and
the positive and negative electrodes are housed in the housing container so as to face the bottom face portion.

32. A secondary battery comprising:
a positive electrode which includes a positive electrode active material layer;
a negative electrode which includes a negative electrode active material layer and which is arranged to face the positive electrode;
a stacked member which has the positive and negative electrodes stacked alternately;
a package container including
a housing container in which the stacked member is housed, and
a lid member which seals an opening of the housing container; and
a swelling resin that swells when soaked with an electrolyte liquid, the swelling resin being arranged in the package container, wherein
the stacked member has a pressing force applied thereto in a stack direction by the swelling resin swelling when an electrolyte liquid is injected into the package container.

33. The secondary battery according to claim 32, wherein the positive and negative electrodes have edge portions respectively, and have the pressing force applied to a region of the positive and negative electrode active material layers excluding at least part of the edge portions.

34. The secondary battery according to claim 32, wherein the positive and negative electrodes have the pressing force applied to a region thereof excluding edge portions of the positive and negative electrode active material layers respectively.

35. The secondary battery according to claim 32, wherein at least one of the positive and negative electrode active material layers has the swelling resin dispersed therein.

36. The secondary battery according to claim 32, wherein a plate-shaped member formed of the swelling resin is arranged either or both between the lid member and the stacked member or/and between the housing container and the stacked member.

37. The secondary battery according to claim 36, wherein the plate-shaped member is formed in a size corresponding to a region of the positive and negative electrode active material layers excluding the edge portions thereof.

38. The secondary battery according to claim 32, further comprising a separator which is arranged between the positive and negative electrodes, wherein the separator is formed of the swelling resin.

39. The secondary battery according to claim 38, wherein
the stacked member has a plurality of positive electrodes as the positive electrode, a plurality of separators as the separator, and a plurality of negative electrodes as the negative electrode,
the stacked member is formed by sequentially stacking the positive electrodes, the separators, and the negative electrodes, and
at least part of the separators have a different thickness than other separators.

40. The secondary battery according to claim 32, wherein the positive and negative electrodes in the stacked member have the pressing force applied thereto in a stack direction by the lid member and the housing container.

41. The secondary battery according to claim 32, wherein the swelling resin contains at least one substance selected from the group consisting of nitrile butadiene rubber, styrene butadiene rubber, carboxymethyl cellulose, polyvinylidene fluoride, polyvinyl alcohol, polyethylene oxide, propylene oxide, polystyrene, and polymethyl methacrylate.

42. The secondary battery according to claim 32, wherein
before injection of the electrolyte liquid, a gap is left between the lid member and the stacked member or between the housing container and the stacked member, and
the gap has an interval C in a range of 0 mm<C<5 mm.

43. The secondary battery according to claim 32, wherein the region of the positive and negative electrodes to which the pressing force is applied is a region 1 mm or more inward of edges of the positive electrode active material layer or 1 mm or more inward of edges of the negative electrode active material layer.

44. The secondary battery according to claim 32, wherein
the positive electrode active material layer has a smaller planar area than the negative electrode active material layer, and
the region of the positive and negative electrodes to which the pressing force is applied is a region 1 mm or more inward of edges of the positive electrode active material layer.

45. The secondary battery according to claim 32, wherein the pressing force is applied to a region of the positive and negative electrode active material layers 5 mm or more inward of edges thereof.

46. The secondary battery according to claim 32, wherein the housing container and the lid member are each formed of a metal material.

47. The secondary battery according to claim 32, wherein
the positive and negative electrodes are arranged to face the lid member,
the housing container has a bottom face portion which faces the positive and negative electrodes, and
a protruding portion which protrudes toward the positive and negative electrodes is formed on at least one of the lid member and the bottom face portion of the housing container.

48. The secondary battery according to claim 47, wherein the protruding portion has a substantially flat pressing surface corresponding to a region of the positive and negative electrode active material layers excluding the edge portions thereof.

49. The secondary battery according to claim 47, wherein the protruding portion is formed on the at least one of the lid member and the bottom face portion of the housing container integrally therewith.

50. The secondary battery according to claim 32, wherein at least one of the lid member and the housing container has a surface thereof facing an inside of the battery coated with a high-polymer-laminated material.

51. The secondary battery according to claim 32, wherein
the housing container is formed in a shape of a box, a face thereof with a greatest area being the bottom face portion, and
the positive and negative electrodes are housed in the package container so as to face the bottom face portion.
